(19) United States
(12) Patent Application Publication
(10) Pub. No.: US 2026/0317476 A1
(43) Pub. Date: Oct. 15, 2026

(54) METHOD FOR THE PREPARATION OF A MATERIAL FOR A MEMBRANE, MATERIAL, MEMBRANE AND USE OF A MEMBRANE

(71) Applicant: Forschungszentrum Jülich GmbH, Jülich (DE)

(72) Inventors: Jochen KERRES, Bubenreuth (DE); Julian STONAWSKI, Nürnberg (DE); Linus HAGER, Lauf an der Pegnitz (DE); Philipp MARTSCHIN, Wörth am Main (DE)

(21) Appl. No.: 18/998,589

(22) PCT Filed: Aug. 4, 2023
(86) PCT No.: PCT/EP2023/071723

§ 371 Date: Jan. 27, 2025

(30) Foreign Application Priority Data
Aug. 31, 2022 (DE) 102022121979.8

(51) Int. Cl. C08G 61/12; B01J 39/19; B01J 41/13; B01J 43/00; C08G 85/00

(52) U.S. Cl. CPC C08G 61/121; B01J 39/19; B01J 41/13; B01J 43/00; C08G 61/122; C08G 85/006

(57) ABSTRACT

The present invention relates to a method for producing a material for a membrane, the method comprising the following steps:
providing at least one starting material, at least one starting material containing at least one monomer or consisting thereof;
synthesizing a polymer from the starting material(s) by way of polyhdroxyalkylation (PHA); and modifying the synthesized polymer in a subsequent reaction.

The invention further relates to a material, a membrane and the use of a membrane.

The present invention relates to a method for producing a substance for a membrane. Furthermore, the present invention relates to a substance produced by such a method and to a membrane comprising or consisting of such a substance. Furthermore, the present invention relates to the use of such a membrane.

Alternative ways of generating electricity are increasingly being developed as part of the energy transition. Fuel cells are an important part of this. These convert the chemical reaction energy of a supplied fuel and an oxidizing agent into electrical energy. The storage of electrical energy is also playing an increasingly important role. In particular, the aim here is to further develop battery technology in such a way that batteries have a high energy density on the one hand and high long-term stability on the other.

Membranes, especially ion exchange membranes, are used in particular in electrochemical methods, for example in electrolysis methods, or in electrochemical systems, for example in a fuel cell or in a battery. High demands are placed on such membranes. On the one hand, they must be sufficiently chemically stable against the media surrounding them in relation to their field of application. In addition, such membranes are often exposed to mechanical stresses. Electrochemical applications also require a certain degree of conductivity combined with a low degree of swelling, i.e. low volume expansion.

Polymers are usually used as materials for such membranes. These are synthesized from monomers. Polycondensation methods form one group of methods for polymer synthesis. The polyhydroxyalkylation (PHA) method belongs to this group of methods.

Polymers produced by polyhydroxyalkylation are described, for example, in L. I. Olvera, M. T. Guzmán-Gutiérrez, M. G. Zolothukhin, S. Fomine, J. Cárdenas, F. A. Ruiz-Trevino, D. Villers T. A. Ezquerra, E. Prokhorov, “Novel High Molecular Weight Aromatic Fluorinated Polymers from One-Pot, Metal-Free Step Polymerizations”, Macromolecules 46 (2013) 7245-7256, and in M. T. Guzmán-Gutierrez, D. R. Nieto, S. Fomine, S. L. Morales, M. G. Zolothukhin, M. C. G. Hernandez, H. Kricheldorf, E. S. Wilks, “Dramatic Enhancement of Superacid-Catalyzed Polyhydroxyalkylation Reactions”, Macromolecules 44 (2011) 194-202 and in M. T. Guzmán-Gutiérrez, M-H. Rios-Dominguez, F. A. Ruiz-Treviño, M. G. Zolothukhin, J. Balmaseda, D. Fritsch, E. Prokhorov, “Structure-properties relationship for the gas transport properties of new fluoro-containing aromatic polymers”, Journal of Membrane Science 385-386 (2011) 277-284.

Even though polyhydroxyalkylation can be used to synthesize polymers that are basically suitable for use in membranes, there is a permanent need to improve the property profile, specifically the chemical stability, conductivity and mechanical stability.

It is therefore the task of the present invention to provide a method by which substances for a membrane with a favorable property profile can be produced. Furthermore, corresponding substances are to be provided which are characterized by a favorable property profile.

According to a first aspect of the present invention, this task is solved by a method for producing a material for a membrane, which comprises the following steps:
providing at least one starting material, wherein at least one starting material contains or consists of at least one monomer;
synthesizing a polymer from the starting material(s) by means of polyhydroxyalkylation (PHA);
modification of the synthesized polymer in a subsequent reaction.

According to a second aspect of the present invention, the problem is solved by a method for producing a material for a membrane, which comprises the following steps:
providing a starting material, wherein at least one starting material contains or consists of at least one monomer;
modification of at least one starting material in a preliminary reaction;
synthesizing a polymer from the starting material(s) by means of polyhydroxyalkylation (PHA).

Furthermore, the problem underlying the invention is solved by a substance which is produced by such a method.

The invention is thus based on the fundamental idea of modifying the polymer in addition to synthesizing it by means of polyhydroxyalkylation. This allows the properties of the resulting polymer to be further optimized. It is possible to modify the polymer after synthesizing it by polyhydroxyalkylation by reacting it in a subsequent reaction. Alternatively or additionally, the starting material can also be modified in a preliminary reaction before the polymer synthesis step. In this case, the modified starting material is then involved in the polymer synthesis. In other words, a specific functionalization of a starting material or the synthesized polymer can take place before and/or after the polymer synthesis in order to optimize the properties of the polymer. The polymer synthesized by polyhydroxyalkylation is also referred to as a PHA polymer.

Accordingly, the substance according to the invention preferably contains or consists of a polymer or a polymer mixture. A polymer is understood to be a chemical compound which consists of or comprises chain molecules or branched molecules. The chain molecules or the branched molecules consist of the same units or, for example in the case of copolymers, of different units.

Preferably, the starting material contains at least one type of diaryl monomer.

According to a preferred embodiment, at least one starting material comprises or consists of one or more of the following ketones and/or aldehydes: 4-methylpiperazin-2-one, 1-(1-methylpiperidin-4-yl)ethan-1-one, 1,4-dimethylpiperazin-2-one, piperazin-2-one, 1,3-dimethyltetrahydropyrimidin-2 (1H)-one, 1-(1-methyl-1H-benzo[d]imidazol-2-yl)ethan-1-one, 2,2,2-trifluoro-1-(1-methyl-1H-benzo[d]imidazol-2-yl)ethan-1-one, 1-(5,6-dimethyl-1H-benzo[d]imidazol-2-yl)ethan-1-one, 1-(5-methylpyridin-3-yl)ethan-1-one, 1-(5-methylpyridin-2-yl)ethan-1-one, 2,2,2-trifluoro-1-(4-mercaptophenyl)ethan-1-one, acetylferrocene, (2,2,2-trifluoroacetyl) ferrocene, 1-(4-(5-bromopentyl)phenyl)ethan-1-one, 1-(4-ethylpiperazin-2-yl)ethan-1-one, 1-(1-methyl-1H-pyrazol-4-yl)ethan-1-one, pyrrolidine-3-carbaldehyde, 1-(1H-Pyrazol-3-yl)ethan-1-on, 1-(1H-Benzo[d]imidazol-6-yl)ethan-1-one, 1-(7-Methyl-1H-benzo[d]imidazol-2-yl)ethan-1-one, 1-(1H-benzo[d]imidazol-2-yl)ethan-1-one, 1-(4-methylpyridin-3-yl)ethan-1-one, 1-(4-mercaptophenyl)ethan-1-one, (4-acetylphenyl)phosphonic acid, 1-(3-methylpyridin-2-yl)ethan-1-one, 1-(1-methyl-1H-pyrazol-3-yl)ethan-1-one, 1-(1,2,4-trimethyl-1H-imidazol-5-yl)ethan-1-on, 1-(1H-benzo[d]imidazol-7-yl)ethan-1-on, 1-(1H-benzo[d]imidazol-2-yl) propan-1-on, 1-(1H-Benzo[d]imidazol-2-yl) propan-2-on, 1-(1,4,5-trimethyl-1H-imidazol-2-yl)ethan-1-on, 2,2,2-trifluor-1-(1-methyl-1H-imidazol-2-yl)ethan-1-on, 1-(1-methyl-1H-imidazol-2-yl)ethan-1-one, 1-(1H-imidazol-5-yl)ethan-1-one, 1-(1H-imidazo-2-yl)ethan-1-one, 1-(2-methylpyridin-4-yl)ethan-1-one, 4-acetylbenzenesulfonic acid, 1-(4-methylpyridin-2-yl)ethan-1-one, 1-(pyridin-4-yl)ethan-1-one, 1-(pyridin-3-yl)ethan-1-on, 1-(pyridin-2-yl)ethan-1-on, 2,2,2-trifluor-1-(pyridin-2-yl)ethan-1-on, 2,2,2-trifluor-1-(pyridin-4-yl)ethan-1-on, 2,2,2-trifluor-1-(pyridin-3-yl)ethan-1-on, 2,2,2-trifluor-1-(piperidin-4-yl)ethan-1-on, 1-(chinolin-8-yl)ethan-1-on, 1-(chinolin-5-yl)ethan-1-on, 2,2,2-trifluor-1-(1H-imidazol-2-yl)ethan-1-on, 1-(chinolin-4-yl)ethan-1-on, 1-(3-methylpyridin-4-yl)ethan-1-on, 1-(2,3,5,6-tetrafluor-4-mercaptophenyl)ethan-1-on, 1-(cyclopenta-2,4-dien-1-yl)ethan-1-on, 1-(4-hexylphenyl)ethan-1-one, 1-(cyclopenta-2,4-dien-1-yl)-2,2,2, -trifluoroethan-1-one, 1-(4-(5-chloropentyl)phenyl)ethan-1-one, 1-(4-bromophenyl)ethan-1-one, 1-(4-chlorophenyl)ethan-1-one, 1-(4-fluorophenyl)ethan-1-one, 1-(4-iodophenyl)ethan-1-one, 1-(6-methylpyridin-2-yl)ethan-1-one, 1-(6-methylpyridin-3-yl)ethan-1-one, 3-acetylbenzenesulfonic acid, 4-acetyl-2,3,5,6-tetrafluorobenzenesulfonic acid, 1-(2-methylpyridin-3-yl)ethan-1-one, 1-(quinolin-7-yl)ethan-1-one, 1-(quinolin-6-yl)ethan-1-one, di(pyridin-2-yl) methanone, 1-(2-(dimethylamino)phenyl)ethan-1-one, 2,2,2-trifluoro-1-(quinolin-3-yl)ethan-1-one, 1-(3-(dimethylamino)phenyl)ethan-1-one, 1-(4-(dimethylamino)phenyl)ethan-1-one, 1-(quinolin-2-yl)ethan-1-one, 1-(4-(dimethylamino)phenyl)-2,2,2-trifluoroethan-1-one, 1-(3-(dimethylamino)phenyl)-2,2,2-trifluoroethan-1-one, 1-(3-chlorophenyl) 2,2,2-trifluoroethan-1-one, 1-(3-bromophenyl)-2,2,2-trifluoroethan-1-one, 2,2,2-trifluoro-1-(3-iodophenyl)ethan-1-one, 2,2,2-trifluoro-1-(3-fluorophenyl)ethan-1-one, 1-(2-bromophenyl)-2,2,2-trifluoroethan-1-one, 1-(2-chlorophenyl)-2,2,2-trifluoroethan-1-one, 1-(2-iodophenyl)-2,2,2-trifluoroethan-1-one, 1-(2-fluorophenyl)-2,2,2-trifluoroethan-1-one, 1-(2-bromophenyl)-2,2,2-trifluoroethan-1-one, 1-(2-chlorophenyl)ethan-1-one, 1-(2-iodophenyl)ethan-1-one, 1-(2-bromophenyl)ethan-1-one, 1-(2-fluorophenyl)ethan-1-one, 1-(3-chlorophenyl)ethan-1-one, 1-(3-bromophenyl)ethan-1-one, 1-(3-iodophenyl)ethan-1-one, 1-(3-fluorophenyl)ethan-1-one, 2,2,2-trifluoro-1-(4-fluorophenyl)ethan-1-one, 2,2,2-trifluoro-1-(4-iodophenyl)ethan-1-one, 1-(4-chlorophenyl)-2,2,2-trifluoroethan-1-one, 1-(4-bromophenyl)-2,2,2-trifluoroethan-1-one, 2,2,2-trifluoro-1-(perfluorophenyl)ethan-1-one, 8-bromo-1,1,1-trifluorooctan-2-one, 1-(isoquinolin-4-yl)ethan-1-one, 1-(quinolin-3-yl)ethan-1-one, 1-(1,8-naphthyridin-4-yl)-ethan-1-one, 1-(perfluorophenyl)ethan-1-one, 1-(isoquinolin-1-yl)ethan-1-one, 2,2,2-trifluoro-1-(4-nitrophenyl)ethan-1-one, 2,2,2-trifluoro-1-(3-nitrophenyl)ethan-1-one, ferrocenecarboxaldehyde, formylcobaltocene, formylnickelocene.

The structural formulas of starting materials that can be used are shown in the figure below, where ketones and aldehydes are concerned.

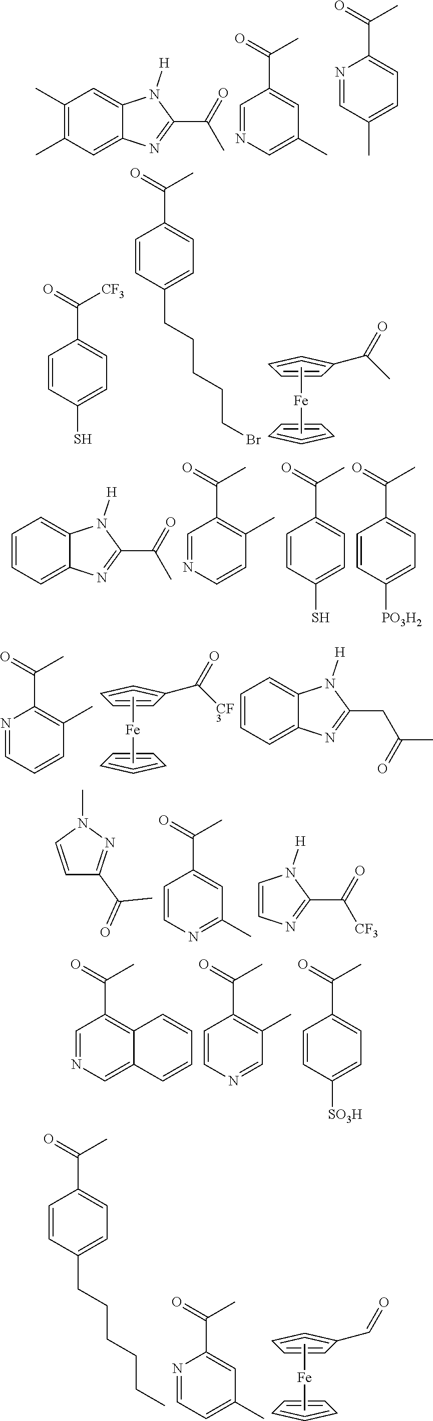

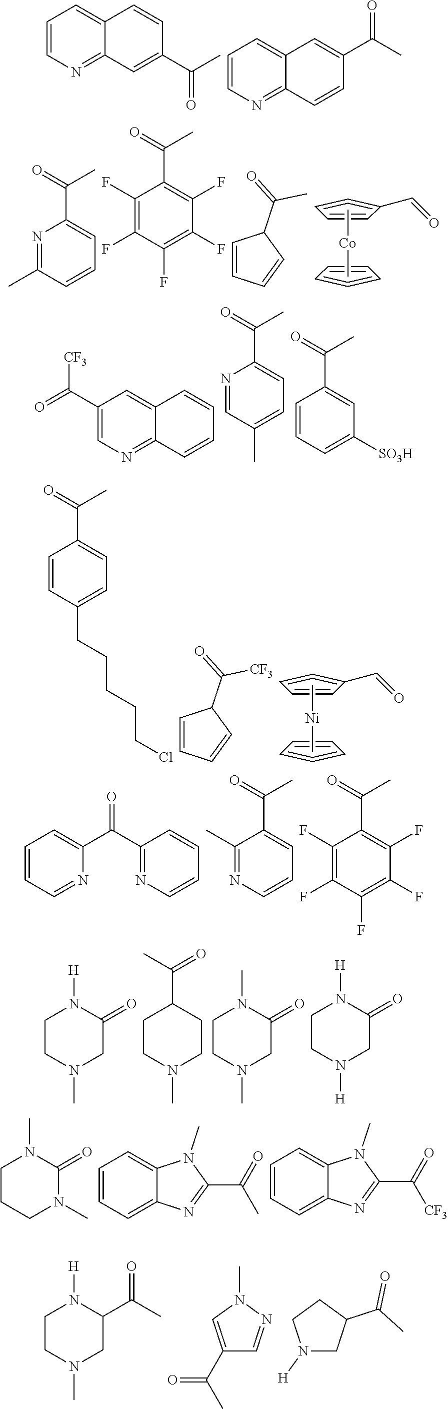

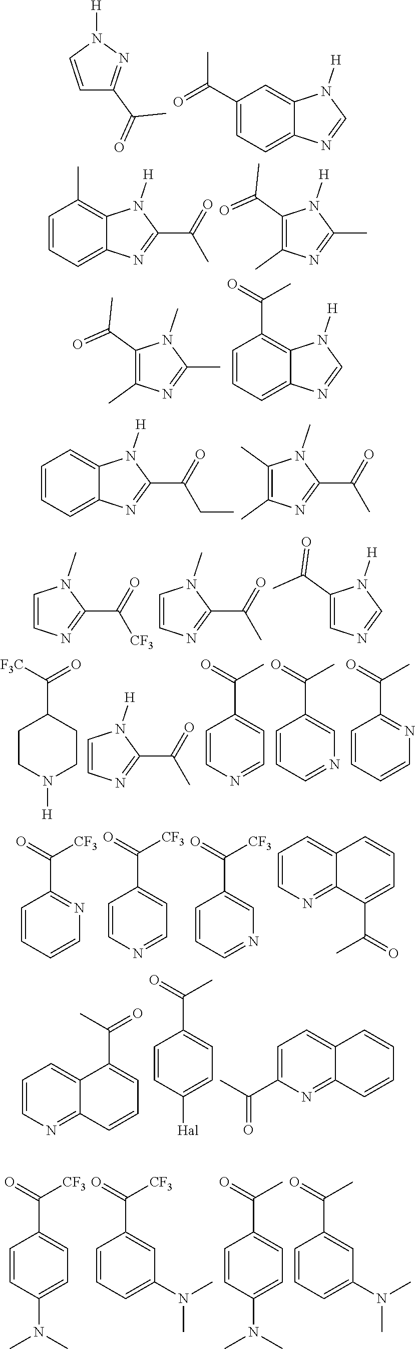

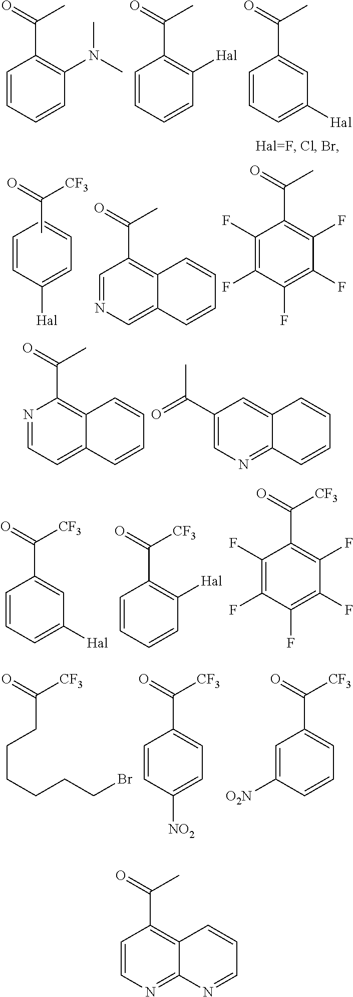

At least one starting material may also contain one or more of the following aryls or aryl groups:

1,2′-binaphthalene, 1,1′-binaphthalene, 2,2′-binaphthalene, 1, 1′-biphenyl, 1,1′,4,1″-terphenyl, 10-methyl-9,10-dihydroacridine, 9,10-diphenylanthracene, 1,4-diphenylnaphthalene, 1,1′: 4′, 1″,4″, 1″-quaterphenyl, 1,1′: 3′, 1″0.3″, 1″-quaterphenyl, 1,1′: 3′, 1″-terphenyl, 9,9,10-trimenthyl-9,10-dihydroacridine, 2,4,6-triphenyl-1,3,5-triazine, 2,3-diphenylnaphthalene, 2′,2″,3′,3″,5′,5″,6′,6″-octafluoro-1,1′: 4′,1″0.4″,1′″-quaterphenyl, 2′, 3′, 5′, 6′-tetrafluoro-1,1′,4′, 1″-terphenyl, 2′,4′, 5′, 6′-tetrafluoro-1,1′: 3′, 1″-terphenyl, 2′,2″,4′,4″,5′,5″,6′,6″-octafluoro-1,1′: 3′, 1″0.3″, 1″-quaterphenyl, 9, 10-dihydroacridine, 2,4,6-triphenylpyridine, 5′-iodo-1,1′: 3′, 1″-terphenyl, 5′-bromo-1,1′: 3′1″-terphenyl, 5′-chloro-1, 1′: 3′, 1″-terphenyl, 2′-bromo-1, 1′: 3′1″-terphenyl, 2′-iodo-1, 1′: 3′, 1″-terphenyl, 4′-bromo-1,1′: 2′, 1″-terphenyl, 9,9-dimethyl-9,10-dihydroacridine, 2,3,6,7-tetraphenylnaphthalene, 2,6-diphenylpyridine, 2,6-diphenylpyrazine, 4,6-diphenylpyrimidine, 3,5-diphenylpyridine, 2,5-diphenylpyridine, 2,5-diphenylpyrimidine, 1,3-diphenylcyclohexane, 5-methyl-5, 10-dihydrophenazine, 5,10-dihydrophenazine, 5′-phenyl-1,1′: 3′, 1″-terphenyl, N-N-dimethyl-[1, 1′: 3′, 1″-terphenyl]-5′-amine, N-N-dimethyl-[1,1′: 3′, 1″-terphenyl]-2′-amine, 6,6′-diphenyl-2,2′-bipyridine, 2,4-diphenyl-1,3,5-triazine, 1,4-diphenylcyclohexane, 1,2-diphenylcyclohexane, 5,10-dimethyl-5, 10-dihydrophenazine, 5′-methyl-1,1′: 3′, 1″-terphenyl, 2′-methyl-1,1′: 3′, 1″-terphenyl, 4-methyl-2,6-diphenylpyridine, 2′,3′-dimethyl-1,1′: 4′, 1″-terphenyl, 2′,3′,5′,6′-tetramethyl-1, 1′: 4′, 1″-terphenyl, 2,3,5,6-tetraphenylpyrazine.

Structural formulas for aryls, which may be contained in a starting material or may form the starting material, are shown in the figure below.

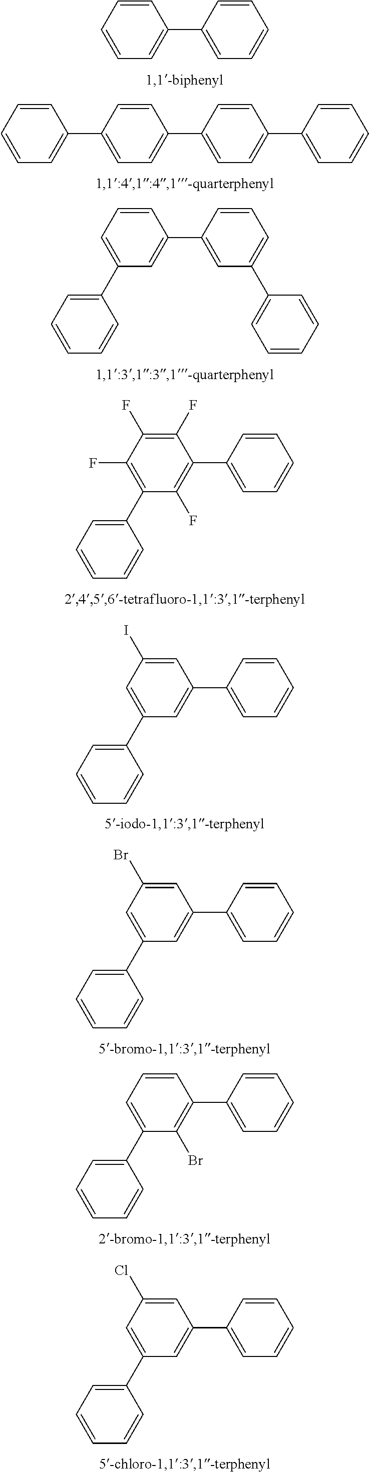

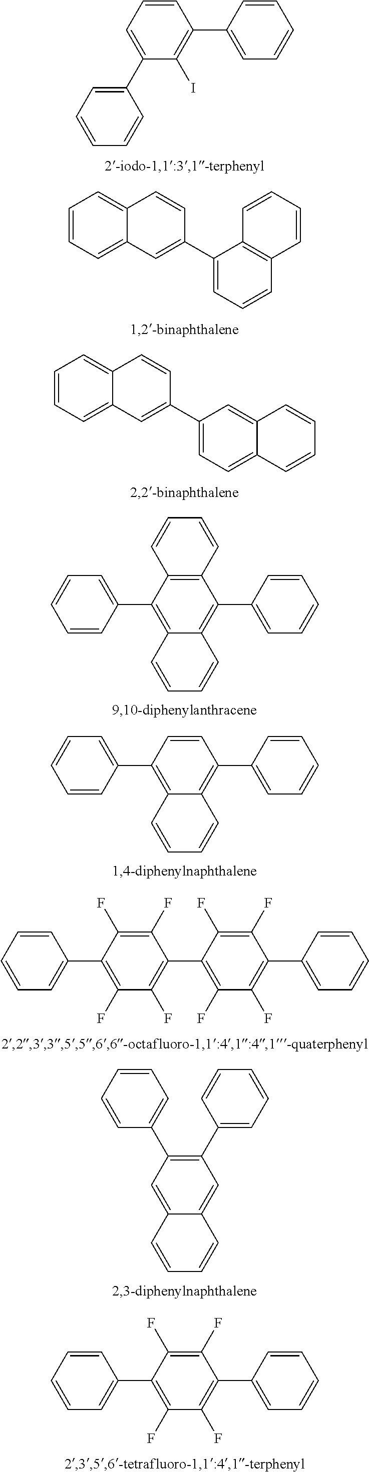

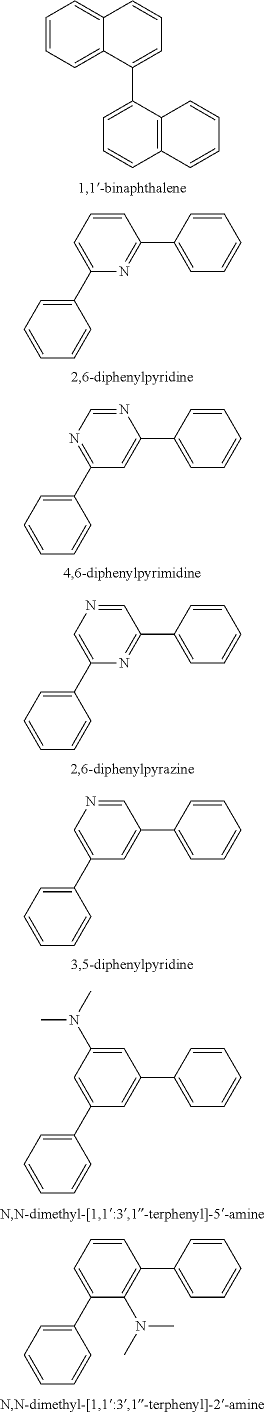

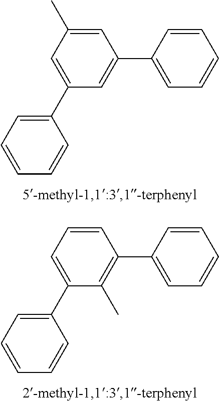

One type of monomer of a starting material may comprise an organic radical, the organic radical comprising or consisting of in particular 1,4-arylene or 1,3-arylene or 1,2-arylene or alkyl or 1,4-perfluoroarylene or 1,3-perfluoroarylene or 1,2-perfluoroarylene or perfluoroalkyl or bromoarylene or chloroarylene or iodoarylene or pyridyl or pyrazinyl or pyrimidyl or triazinyl or 9H-fluorenyl or 9-dialkyl-9H-fluorenyl or 9,9-bis(haloalkyl)-9H-fluorenyl or 1,4-cyclohexyl or 1,3-cyclohexyl or 1,2-cyclohexyl or 1-methylpiperidyl or 1,4-dimethylpiperazinyl or 1,3-dimethylhexahydropyrimidinyl.

According to a preferred embodiment, a starting material may contain at least one ketone group and/or carbonyl group, in particular several different ketone groups and/or several different carbonyl groups. A ketone group may have the following structure:

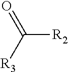

R₂ can stand for hydrogen (H), phenyl, Cₙ H₂ₙ₋₁ with n=1-20, or for Cₙ F₂ₙ₋₁ with n=1-20.

The residue R₃ can be any organic residue containing basic nitrogen. Preferably, it can have the following structure:
(2-R, 3-R, 4-R, 5-R, 6-R)-x-pyridyl with R═H, Cl
Br, I, OMe, Cₙ H₂ₙ₋₁ with n=1-20, Cₙ F₂ₙ₋₁ with n=1-20
NO₂, SO₃ H, SH, SO₂-Cₙ H₂ₙ₋₁ with n=1-20 and x=2, 3 or 4
(2-R, 3-R, 4-R, 5-R, 6-R)-x-pyrimidinyl with R═H,
Cl, Br, I, OMe, Cₙ H₂ₙ₋₁ with n=1-20, Cₙ H₂ₙ₋₁ with n=1-20
and x=2, 3 or 4
1H-benzo[d]imidazolyl
1-Methyl-1H-benzo[d]imidazolyl
1H-imidazolyl
1-Methyl-1H-imidazolyl
1-methylpiperidin-2-,3- or 4-yl
1-(4-methylpiperazin-2-, or 3-yl

Alternatively, the radical R₃ may be a halogen-containing organic radical. Preferably, R₃ can have the following structure:
(CH)kHal with Hal=Cl, Br, I and k=1-10
Pentafluorophenyl
Tetrafluorophenyl
Trifluorophenyl
Difluorophenyl
Fluorophenyl

According to a preferred embodiment, the method according to the invention can be characterized in that exactly two different starting materials are provided, which in particular each comprise or consist of a monomer.

A first starting material can be a phenyl derivative, in particular a biphenyl or a terphenyl.

A preferred embodiment of the method may be characterized in that a first starting material is a phenyl derivative, in particular a terphenyl derivative, preferably m-terphenyl, p-terphenyl, and/or a biphenyl, and a second starting material is an aromatic ketone, in particular an aromatic trifluoroketone, preferably 1,1,1-trifluoro-3-(pyredin-4-y-I) propan-2-one.

According to an alternative embodiment, a first starting material may be a phenyl derivative, in particular a terphenyl, preferably p-terphenyl or m-terphenyl, and/or a biphenyl, and a second starting material may be perfluoroacetophenone. A subsequent reaction may comprise or consist of a sulfonation or a phosphonation, in particular a multiple phosphonation, preferably a double phosphonation.

According to an alternative embodiment, the first starting material may be a terphenyl derivative, in particular p-terphenyl or m-terphenyl, and/or a biphenyl, and the second starting material may be 1-(1H-benzodimidazol-2-yl)ethan-1-ones, and a subsequent reaction may comprise or consist of sulfonation.

It is also possible that the first starting material is 2,6-diphenylpyridine and a second starting material is 2,2,2-trifluoro-1-(pyridin-4-yl)ethan-1-one and a subsequent reaction can take place with Mel or dimethysulfate or by reaction with a dihaloalkane.

According to an alternative embodiment of the method, a first starting material can be an aryl, in particular m-terphenyl, and a second starting material can be or contain a cyclopentadienyl complex, which in particular contains a ferrocene group, and the ferrocene can be partially oxidized in a subsequent reaction.

According to an alternative embodiment of the method, in which a modification of at least one starting material takes place in a preliminary reaction, a starting material can be 1-(4-mercaptophenyl)ethan-1-one and this can be oxidized in a preliminary reaction to 4-acetylsulfonic acid. In a further embodiment, a second starting material can then be a phenyl derivative, in particular m-terphenyl, p-terphenyl, and/or a biphenyl.

According to an alternative embodiment of the method, which comprises a modification of at least one starting material in a preliminary reaction, a first starting material can be a bromohexyl terphenyl, in particular 5′-(6-bromohexyl)-1,1′: 3′, 1″-terphenyl, which reacts with dibromohexane, in particular 1,6-dibromohexane, in a first preliminary reaction. This modified starting material contained in this way can react with 4-methylpyridine in a second preliminary reaction. The second starting material can be 4-acetylpyridine.

The basic reaction scheme of a polyhydroxyalkylation is shown below.

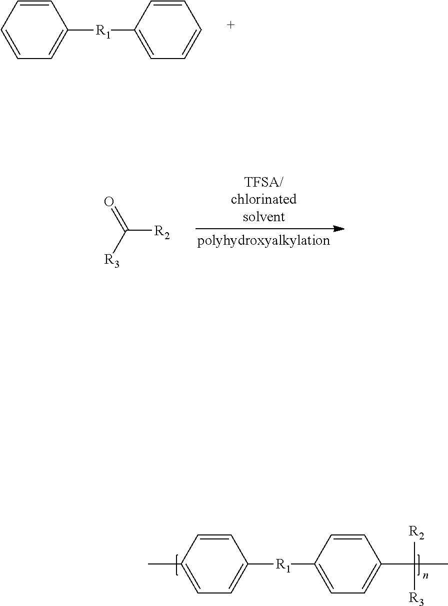

The designation R₁ stands for any organic residue, which preferably has one of the aforementioned structures. The designations R₂ and R₃ have already been explained above.

Preferably, polyhydroxyalkylation takes place under the influence of trifluoromethanesulfonic acid (TFSA). This has the molecular formula CF₃ SO₃ H and is a colorless, pungent smelling, hygroscopic liquid.

In a further embodiment, the polyhydroxyalkylation (PHA) can take place under the influence of a solvent, in particular a chlorinated solvent. Such solvents are commercially available.

The modification of the synthesized polymer in a subsequent reaction and/or the modification of a starting material in a preliminary reaction can each comprise one or more reactions or reaction steps. It is also possible that a modification of the starting material takes place in one or more preliminary reactions before the polymer synthesis by means of PHA and/or that one or more subsequent reactions are carried out after the polymer synthesis by means of PHA in order to modify the synthesized polymer.

The modification of the synthesized polymer in a subsequent reaction and/or the modification of the starting material in a preliminary reaction may comprise a nucleophilic aromatic substitution reaction or an electrophilic aromatic substitution reaction. An electrophilic aromatic substitution reaction may comprise nitration and possible subsequent reactions, sulphonation and possible subsequent reactions, Friedel-Crafts acylation and possible subsequent reactions, Friedel-Crafts alkylation and possible subsequent reactions, halogenation, in particular fluorination, chlorination, bromination or iodination, and a possible subsequent reaction of halogenations, for example lithiations by means of a halogen-metal exchange or Grignard reactions, and possible subsequent reactions of the metallized, for example lithiated, polymers by reactions with any electrophiles.

A nucleophilic substitution reaction can take place in a known manner. One or more atoms of an aromatic compound can be substituted. For example, perfluoroaromatic compounds in which one or more fluorine atoms are substituted by a functional group may be present in the synthesized polymer. For example, a perfluorophenyl unit or a perfluorobiphenyl unit may be present in which the para position is initially substituted by a functional group. A further functional group can then also be coupled at an ortho position and/or a meta position.

Several atoms of an aromatic compound can be nucleophilically substituted simultaneously in one step. Alternatively, the nucleophilic substitution of several atoms can take place in several successive steps.

Any substitution reaction can take place under the influence of other media. This may be a base. Alternatively or additionally, the reaction can take place under the action of acetone, diazabicycloundecene (DBU), dimethylformamide (DMF), dimethylacetamide (DMAc), dimethyl sulfate (DMS), CH₃ I, dimethyl carbonate or mixtures or dilute solutions of these media.

It is also conceivable that a substitution reaction takes place during the evaporation of a solvent, which preferably occurs at a temperature below 150° C.

A molecule with a linear or branched, saturated or unsaturated Cₙ-body, in particular with a C₂-, C₃-, C₆-, C₈-, C₁₀-, C₁₂-, C₁₄-, C₁₆-, or a C₁₈-body, which carries a thiol group at one end, can be used for substitution. Preferably, an S atom of the thiol group then substitutes an F atom of a perfluoroaromatic compound. In other words, a saturated or unsaturated hydrocarbon with a thiol group can be used as a substituent. If an unsaturated hydrocarbon is used, it can be used for a subsequent reaction, in particular for a thiol-ene click reaction.

At its other end, the molecule used for substitution may contain a quinuclidinium group or another quaternary N group, in particular an ammonium, imidazolium, benzimidazolium, piperidinium, piperazinium, guanidinium or pyridinium group, preferably with counterions, in particular with a bis(trifluoromethylsulfonyl)amide anion or a mineral acid anion, in particular a halide (F⁻, Cl⁻, Br⁻, I⁻) or SO₄²⁻, HSO₄⁻, PO₄³⁻, HPO₄²⁻, H₂ PO⁴⁻, SO₃²⁻, SO H₃⁻, Hydrogenphosphonat R-PO H₃⁻, Phosphonat R-PO₃²⁻ (R=any organic residue, preferably an aryl residue, preferably with electron drawing groups such as F, SO₂ R, NO, NO₂, etc.), carbonate CO₃²⁻, HCO₃⁻ or with an organic carboxylic acid anion, in particular CH₃ COO⁻, CF₃ COO—, HCOO⁻. The choice of counterions is not limited to the anions mentioned. Furthermore, the molecule used for substitution may contain a nitrogen atom as a primary, secondary, tertiary or quaternary amine or ammonium group.

A molecule in the form R—SH, R—S⁻, R—OH, R—NH, R—N⁻ or PO₃ R₂ can also be used for substitution. Furthermore, a thiol with a terminal sulfonate group can be used for substitution. In addition, a molecule C₅ NH₁₀ (piperidyl residue) can be used for substitution, with the nitrogen atom taking the position of a fluorine atom of the perfluoroaromatic compound. In particular, if the nitrogen atom is positively charged, a radical (counterion) can be coupled via the nitrogen atom in a further embodiment, the radical preferably being a halide (F⁻, Cl⁻, Br⁻, I⁻) or SO₄²⁻, HSO₄⁻, PO₄³⁻, HPO₄², H₂ PO₄⁻, SO₃²⁻, SO₃ H⁻, hydrogen phosphonate R—PO₃ H⁻, phosphonate R-PO₃²⁻, carbonate CO₃²⁻, HCO₃⁻ or an organic carboxylic acid anion, in particular CH₃ COO—, CF₃ COO⁻, HCOO⁻. The remainder can in principle contain any anion as a counterion, whereby anions such as halide (F⁻, Cl⁻, Br⁻, I⁻) or SO₄²⁻, HSO₄⁻, PO₄³⁻, HPO₄²⁻, H₂ PO₄⁻, SO₃²⁻, SO₃ H⁻, hydrogen phosphonate R—PO H₃⁻, carbonate CO₃²⁻, HCO₃⁻ or an organic carboxylic acid anion such as CH₃ COO⁻, CF₃ COO⁻, HCOO⁻ are preferred.

If the molecule used for substitution has the form S—R, with the sulphur atom taking or intended to take the position of the substituted fluorine atom, the radical R can be formed as shown in the figure below.

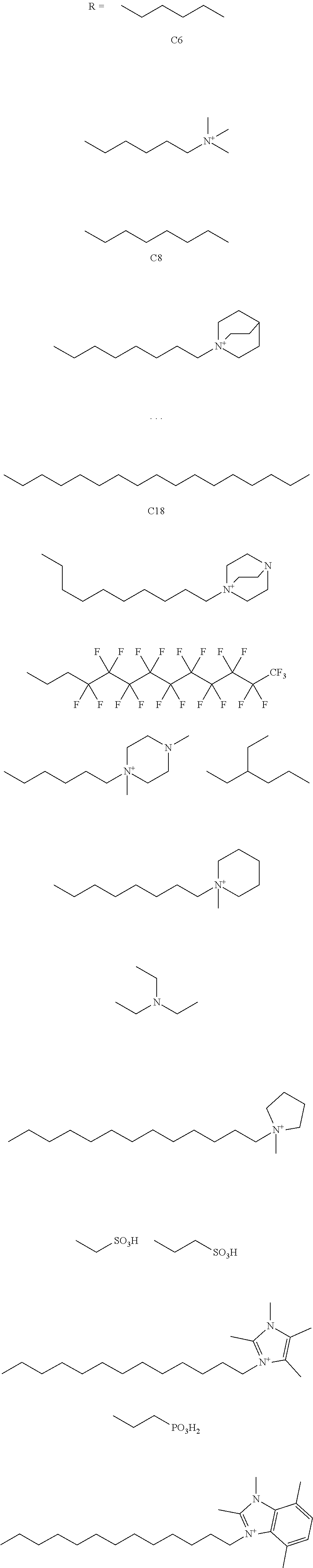

Furthermore, the molecule SO₃⁻ used for substitution can be substituted with a counterion, in particular with a countercation, preferably with a metal countercation or with an ammonium countercation in the form NR₄⁺ with R═H, alkyl, aryl or with another N-based cation, in particular imidazolium, benzimidazolium, guanidinium. A functional group can contain C₅ NH₁₀, whereby the nitrogen atom substitutes the fluorine atom of the perfluoroaromatic compound. In particular, the nitrogen atom can be substituted by a radical or counter anion, the radical preferably being a halide (F⁻, Cl⁻, Br⁻, I⁻) or SO₄²⁻, HSO₄⁻, PO₄³⁻, HPO₄²⁻, H₂ PO₄⁻, SO₃²⁻, SO H₃⁻, hydrogen phosphonate R—PO₃ H⁻, phosphonate R-PO₃²⁻, carbonate CO₃²⁻, HCO₃⁻ or an organic carboxylic acid anion such as CH₃ COO⁻, CF₃ COO⁻, HCOO⁻. The residue or the counter anion may in particular be mineral acid anions (including halides, sulphates, sulphites, phosphates, carbonates, (per) chlorates, borates), or organic counter anions, preferably bis(sulphonyl)imides, carboxylic acid derivatives, sulphonic acid derivatives, phosphonic acid derivatives).

The substitution that takes place can be designed in such a way that a functional group is coupled to several, in particular to two perfluoroaromatic compounds of two organic polymer chains, so that the functional group cross-links the chains with one another. This embodiment is based on the idea of not functionalizing the polymer chains independently of one another, but functionalizing them in such a way that they are additionally crosslinked with one another. This can influence the mechanical properties of the material in particular.

Specifically, the functional group can be chain-like and have a sulphur atom at each end, each of which nucleophilically substitutes a fluorine atom of a perfluoroaromatic compound. One or more Cₙ-bodies and/or a repeating unit may be contained between the sulphur atoms.

In a further embodiment of the method according to the invention, further subsequent reactions can take place following the nucleophilic substitution, for which the functional groups form a reaction basis. The residues of the functional groups, which have been coupled to a perfluoroaromatic compound after the substitution has taken place, can be used as a basis for further subsequent reactions. These include the exchange of the counterions of a positively or negatively charged residue of the functional group, a change in the residues of the functional group or the use of an aromatic/unsaturated residue of the functional group.

Specifically, the counterions of a quaternary ammonium salt or an acid group, which are part of the functional group, can be exchanged. Unsaturated residues of the functional group can be used for downstream functionalization or crosslinking of the polymer/oligomer with the perfluoroaromatic compound.

The modification of the synthesized polymer in a subsequent reaction and/or the modification of the starting material in a preliminary reaction may also comprise a polymer-analogous reaction. In a polymer analog reaction, a functional group is converted into another functional group by a chemical reaction.

The modification in a subsequent reaction and/or in a preliminary reaction may also comprise an alkylation of basic nitrogen atoms to tertiary or quaternary N-based compounds. Furthermore, the subsequent reaction and/or the preliminary reaction may also be microwave-assisted, in particular comprise microwave-assisted synthesis. This can accelerate the reaction and possibly increase the degree of conversion (yield). The selectivity of the reaction can also be improved.

A modification in a subsequent reaction and/or in a preliminary reaction may comprise or consist of a lithiation reaction.

Possible modifications in a subsequent reaction and/or in a preliminary reaction can be or include a lithiation reaction on halogenated, preferably chlorinated or brominated or iodinated polymers or monomers. The reaction scheme of a polymer in which bromine is bonded directly to the aromatic compound is shown below.

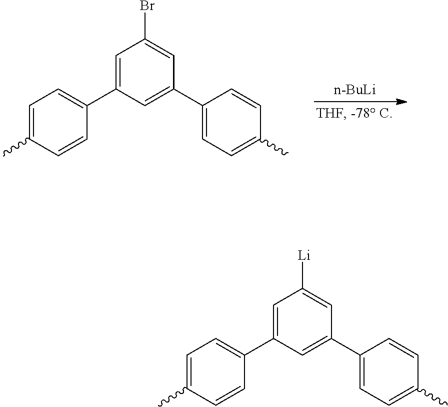

Alternatively, bromine can be in a benzylic position or bonded to an alkylene radical. The corresponding reaction scheme is shown below.

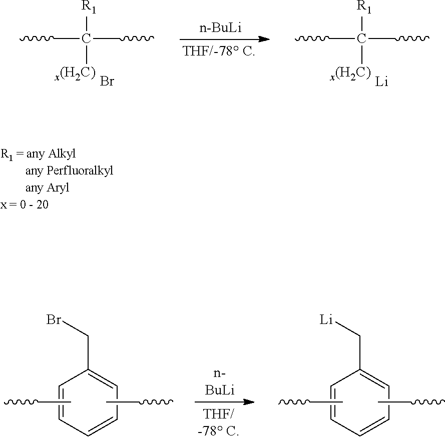

Such a lithiated monomer or a lithiated PHA polymer can be reacted with further reactions, i.e. further preliminary reactions in the case of a monomer or subsequent reactions in the case of a polymer. This may involve, for example, a sulfinate-S-alkylation or a Suzuki coupling. Further exemplary subsequent reactions are shown in the following reaction scheme.

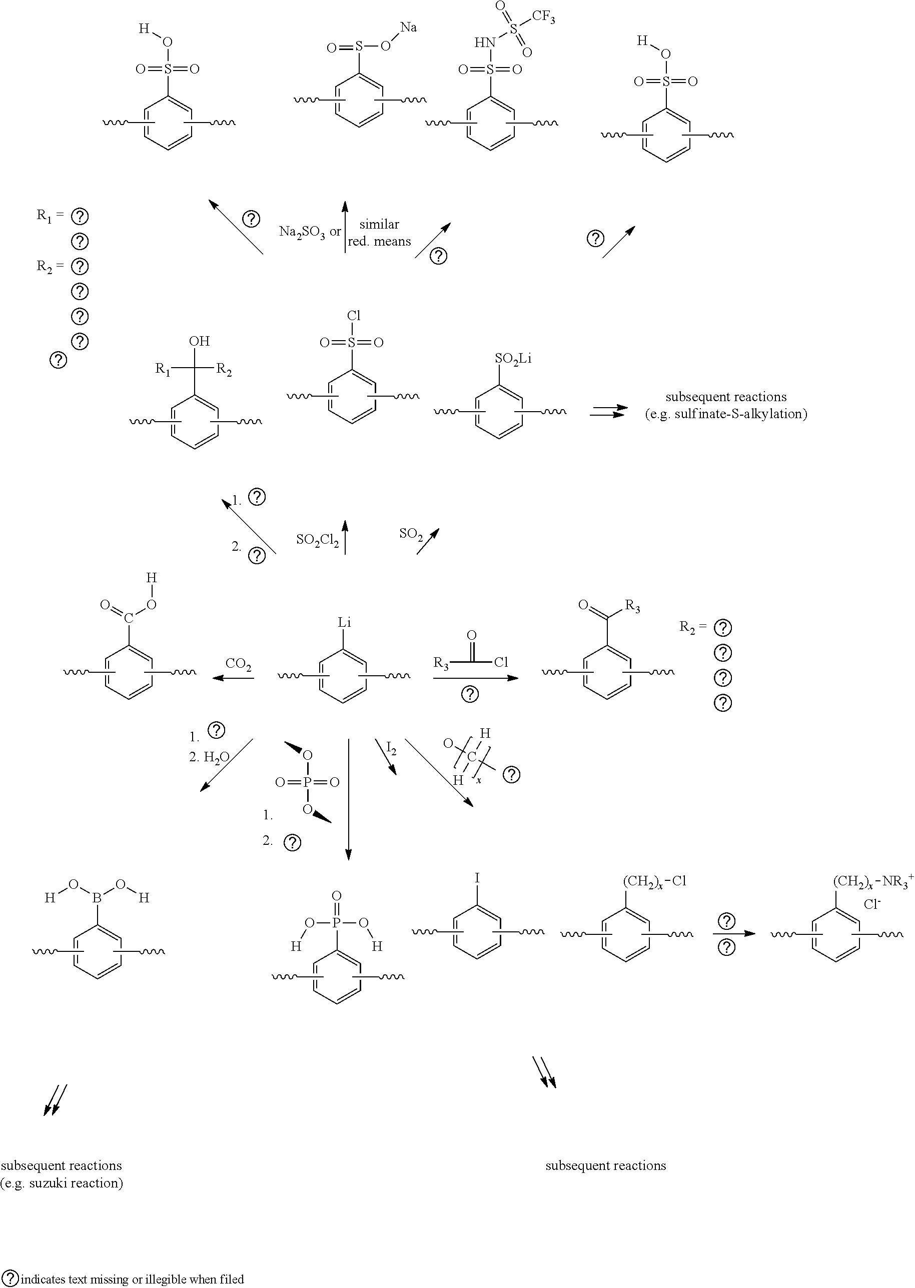

According to a preferred embodiment, the lithiated PHA polymer can be reacted with a carbonyl derivative of a di-(cyclopentadienyl) transition metal complex, in particular ferrocenaldehyde, acetylferrocene or ferrocenic acid chloride. Subsequent partial or complete oxidation of the transition metal central atom of the complex to form an anion exchange polymer produces a material with excellent chemical stability. If a magnetic field is used in the production of membranes from a solution of the partially oxidized di-(cyclopentadienyl) transition metal complex bound to the polymer in a (preferably)dipolar-aprotic solvent such as DMAc, DMF, DMSO, sulfolane, etc., a magnetic field is used, whereby the magnetic field is applied to the membrane. When a magnetic field is applied, with the field lines of the magnetic field aligned perpendicular to the membrane surface, the metal-containing functional groups can be aligned in the direction of the magnetic field, leading to the formation of ion-conducting channels “through-plane” and thus to a higher conductivity than if the ion-conducting channels are not aligned in the magnetic field (for the proof-of-principle of this novel polymer type in the form of partially oxidized vinyl ferrocene, see the following study: Xin Liu, Na Xie, Jiandang Xue, Mengyuan Li, Chenyang Zheng, Junfeng Zhang, Yanzhou Qin, Yan Yin, Dario R. Dekel, Michael D. Guiver, Nature Energy 2022, 7, 329-339, DOI: 10.1038/s41560-022-00978-y).

A benzyl bromination with N-bromosuccinimide (NBS) and a further reaction of the bromomethyl group, in particular a reaction with a tertiary amine to form an anion exchange polymer, can also take place as a subsequent or preliminary reaction. Lithiation on the methyl group of an aromatic compound with n-butyllithium is also conceivable, followed by further reactions, in particular the graphenation of an anionically polymerizable polymer, in particular polystyrene, poly(4-vinylpyridine) or poly(diethylvinylphosphonate). The corresponding reactions can take place both as a preliminary reaction for modifying the starting material and as a subsequent reaction for modifying the synthesized (PHA) polymer.

The modification of the synthesized polymer in a subsequent reaction and/or the modification of the starting material in a preliminary reaction may also comprise a Suzuki-Miyaura coupling reaction and/or an electrophilic sulfonation reaction and/or a phosphonation reaction and/or an amination reaction and/or a thiolation reaction. The sulfonating agent may be concentrated sulfuric acid or TMSA (trimethylsilylacetylene) or chlorosulfonic acid (ClSO₃ H) or oleum (H₂ SO₄ with 5-65% SO₃) or trimethylsilylchlorosulfate (TMS-OSO₂-Cl) or a combination of these materials.

By modifying the synthesized polymer in a subsequent reaction or modifying the starting material in a preliminary reaction, ionic and/or covalent cross-links can also be formed between the individual polymer chains. In principle, this reduces swelling/water absorption, which results in an improvement in the property profile of membranes produced from the material. This can take place, for example, by nucleophilic substitution of a pentafluorophenyl residue of a polymer with an aromatic or aliphatic dithiol.

In the case of a Friedel-Crafts acylation and/or a Friedel-Crafts alkylation, a quaternization of the polymer with any other tertiary N-based compound can be carried out. For example, the compounds may be tetramethylimidazole, trimethylamine, N-methylpiperidine, N-methylpiperazine or 3-methyl-3,6-diazaspiro[5.5]undecan-6-ium bromide. Any nucleophilic aromatic substitutions can be carried out on a pentafluorophenyl radical of the synthesized polymer.

The modification in a preliminary reaction or in a subsequent reaction can also include doping, in particular with phosphoric acid or any phosphonic acid, which has proven to be advantageous in particular for use in high-temperature membrane fuel cells. The membranes doped in this way can be converted into a covalently cross-linked blend membrane by blending with another polymer, in particular with poly(vinylbenzyl chloride)(PVBCI). Specifically, this can be done by reacting the chloromethyl groups of the PVBCI with the N—H of the imidazole function, or by blending with an acidic sulfonated or phosphonated polymer to form acid-base blend membranes.

The modification in a preliminary reaction or in a subsequent reaction may also comprise phosphonation, in particular single phosphonation or double phosphonation, and/or sulphonation, in particular single or double sulphonation. It is also possible that, in a first subsequent reaction, a single or multiple, for example a double, phosphonation takes place first and then a sulfonation, in particular a single or multiple, for example a double sulfonation, takes place. The phosphonation and/or sulfonation can each take place as an electrophilic aromatic substitution and/or as a nucleophilic aromatic substitution. In the case of nucleophilic substitution, thiolation can take place in a first step before the thiol formed is highly oxidized to sulfonic acid in a second step.

The preliminary reaction or the subsequent reaction can also include functionalization with or to an alkali-stable dication. This may be a nitrogen dication. In particular, a bromine site formed or present on a synthesized polymer or polymer modified in a first subsequent reaction can be converted with or to a dication. Such embodiments lead to anion exchange polymers with high ion exchange capacities. Surprisingly, it has been shown that such polymers are not water-soluble, so that membranes with high conductivities can be produced.

In particular, the synthesized polymer can be a basic polymer. The polymer can be functionalized in a first step. In a further step, a bromine site can be reacted with a compound containing in particular a tertiary amino group and a quaternary ammonium ion, such as 1,1-dimethyl-4-(3-(1-methylpiperidin-4-yl) propyl) piperidin-1-ium, to form a dication.

In principle, a subsequent reaction can include or consist of an electrophilic aromatic substitution.

The method or the or a subsequent reaction according to the invention may further comprise blending the synthesized polymer with a further polymer to form a blended polymer mixture. The modification of the synthesized polymer in a subsequent reaction may thus also comprise or consist of blending the synthesized polymer with a second polymer. In other words, it is envisaged that the polymer synthesized by means of polyhydroxyalkylation, which in particular has corresponding modifications, is blended with at least one other polymer.

In particular, the synthesized polymer may be a sulfonated polymer. It is also possible that the further polymer was produced using the method according to the invention. The further polymer or the synthesized polymer may have haloalkyl side chains.

The synthesized polymer or the further polymer may be a cation exchange polymer. It is also possible that the synthesized polymer or the further polymer is an anion exchange polymer. Preferably, the synthesized polymer or the further polymer is a cation exchange polymer and the other of the two polymers is an anion exchange polymer. The mixing ratio when blending the synthesized polymer with a further polymer can be between 99:1 and 1:99, in particular between 95:5 and 5:95.

It is also possible that the synthesized polymer is a benzimidazole polymer and the other polymer has a bromoalkyl side chain.

Cross-linking, in particular ionic and/or covalent cross-linking between the polymers, can occur as a result of blending. In this way, the mechanical and chemical stability of membranes made from such materials can be improved compared to membranes consisting only of the synthesized polymer. At the same time, the ionic conductivity can be increased.

It is also possible that further post-treatment of the blended polymer mixture takes place. Specifically, doping can take place. The blended polymer mixture can be doped with mineral acids, in particular with sulphuric acid or phosphoric acid or any organic phosphonic acid with the structure R(PO₃ H₂)×(R=any organic residue, preferably an electron-poor aromatic grouping such as one with one or more For one or more other electron-withdrawing groups such as NO, NO₂, SO₂ R etc.), because electron-withdrawing groups increase the acidity and thus the ionic conductivity of the phosphonic acid, x=1-12). Furthermore, the post-treatment may include the introduction of further ion exchange groups, in particular medium to strongly acidic phosphonic acid and/or acidic sulfonic acid groups and/or strongly acidic sulfonimide groups.

Furthermore, anion exchange groups can be generated on the blended polymer mixture. The generation of anion exchange groups can take place by the alkylation (quaternization) of any tertiary N-basic groups contained in the blended polymer mixture and/or by the reaction of halomethyl groups of the form CH₂ Hal with Hal=Cl, Br, I contained in the blended polymer mixture with tertiary N-basic groups. These method steps can further improve the properties of the substance obtained in this way and, in particular, of a membrane produced from this substance.

A substance produced by such a method is characterized by a particularly favorable property profile. The substance is preferably a polymer or a polymer mixture. Specifically, the substance can be a synthesized polymer which contains halogens Hal directly bound to the aromatic compounds (Hal=CI, Br, I). These may already be contained in the monomers of the starting material or may have been formed by a polymer-analogous bromination of the synthesized polymers with elemental bromine, possibly under FeCl₃ or AlCl₃ catalysis, or by reaction with NBS (N-bromo-succinimide).

It is also possible that the materials produced by the method according to the invention are method by means of electrospinning or centrifugal spinning to form fiber mats, in particular porous fiber mats, which are also known as random nonwovens. In a further step, the fiber mats can be impregnated with a second polymer, either with a cation-exchange or anion-exchange polymer according to the invention or with a basic polymer according to the invention, and/or with an inert filler polymer. In this way, composite membranes consisting of the fiber mat and the infiltrated polymer, in which the fiber mat acts as a mechanical reinforcement and, depending on the type of polymer of which the fiber mat consists, can even be ion-conductive if the material of the fiber mat consists of a cation exchange polymer or an anion exchange polymer or of a mixture of an anion exchange polymer with a cation exchange polymer. The mixture of a sulfonated polymer with a basic polymer can also be spun into fibers if necessary, whereby the conductivity of the fibers can be adjusted by the molar mixing ratio between the polymers. As long as the acidic polymer is in molar excess in the polymer mixture, the fibers are cation-conductive. If the molar mixing ratio between acidic and basic polymers is 1:1, i.e. if there are no more excess cation-conductive groups, the fibers are no longer cation-conductive.

The blended polymer mixture can be an acid-acid blend. One of the two polymers can be a sulfonated, in particular partially fluorinated polymer, which was produced in particular by means of polyhydroxyalkylation, and the other of the two polymers can be a phosphonated, in particular partially fluorinated polymer, which was preferably synthesized by means of polyhydroxyalkylation. Preferably, an additional covalent crosslinking may be present, which takes place in particular by a nucleophilic aromatic substitution of fluorine atoms. Preferably, the nuclophilic substitution can take place by a thiol, in particular a dithiol, preferably an alkanedithiol. In this way, the water absorption of a membrane produced in this way can be limited.

The problem underlying the invention is further solved by a membrane comprising or consisting of such a substance produced by a method as described above.

The thickness of the membrane can be less than 100 μm, in particular less than 75 μm, preferably less than 50 μm. To produce the membrane, the material produced by a methods as described above can be dissolved in a suitable solvent and doctored onto a corresponding surface. This results in corresponding thicknesses of the membrane. In a preferred embodiment, the membrane can be an ion exchange membrane, preferably a cation exchange membrane or an anion exchange membrane.

A further object of the invention is the use of such a membrane in a fuel cell, in particular in a high-temperature or low-temperature fuel cell and/or in a direct alcohol fuel cell, or in a battery, in particular in a redox flow battery, and/or in an electrochemical method, in particular in an electrolysis method or in an electrosynthesis method, preferably in a water electrolysis method, and/or as a proton exchange membrane.

For further embodiments of the invention, reference is made to the subclaims and to the following description of embodiments with reference to the figures. The substances mentioned in the description of the embodiments, in particular the polymers mentioned, are preferred embodiments of a substance according to the present invention. The starting materials mentioned in connection with the description of the embodiments are preferred embodiments of starting materials for the method according to the invention. In some cases, the individual figures or the description of the embodiments only show individual method steps (e.g. synthesizing a polymer or modifications as part of a subsequent reaction) of the method according to the invention. The figures show

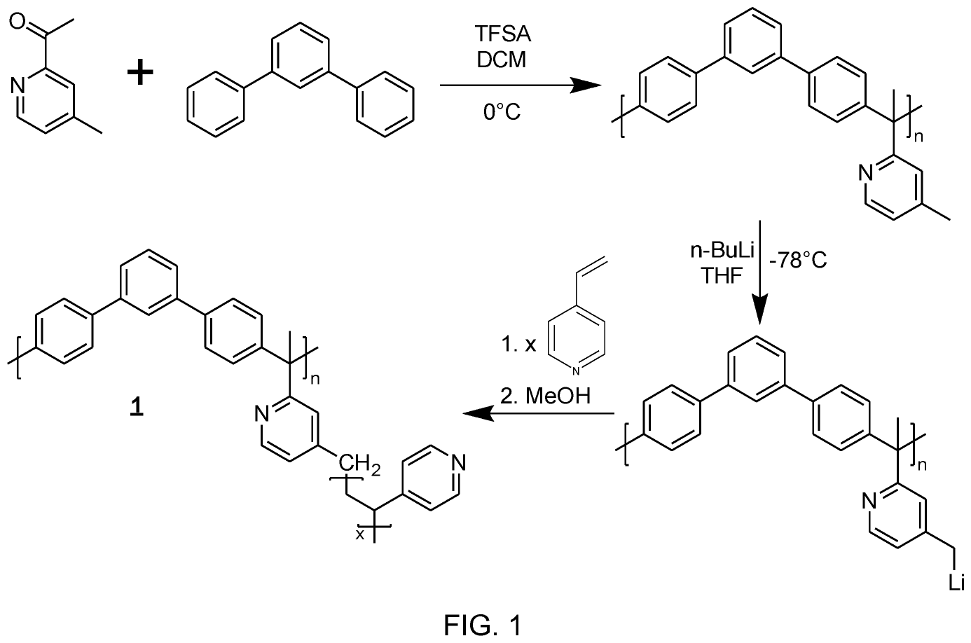

FIG. 1 a reaction scheme of a method according to the invention according to a first example of the present invention;

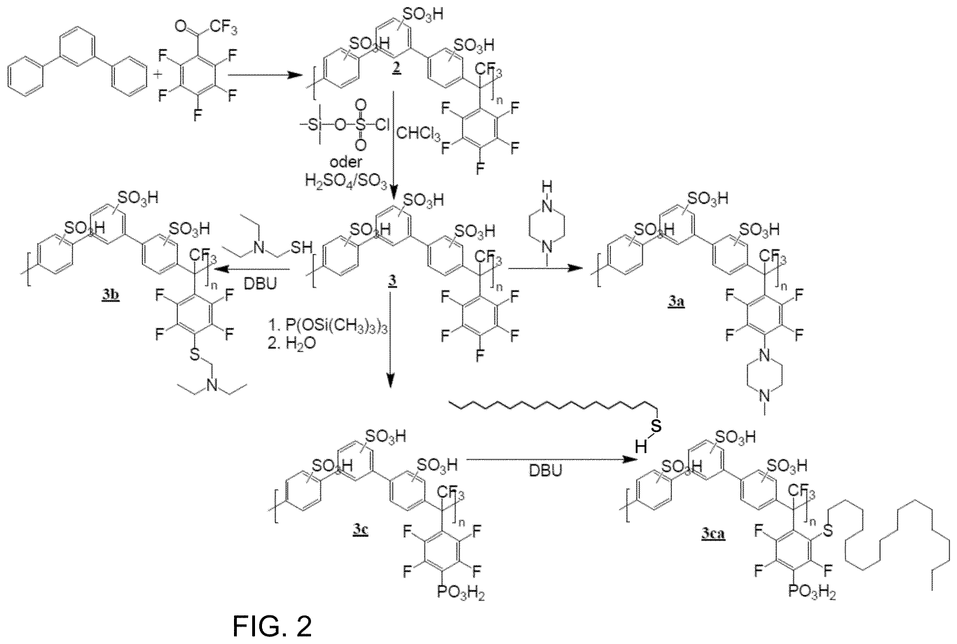

FIG. 2 a reaction scheme of methods according to the invention according to a second embodiment of the present invention;

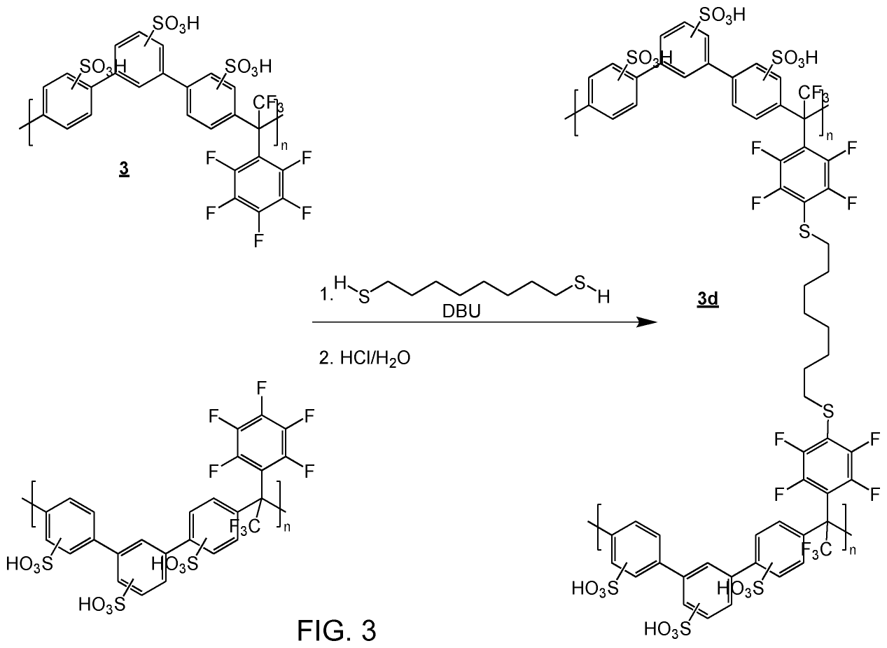

FIG. 3 a reaction scheme of another possible subsequent reaction of the methods shown in FIG. 2;

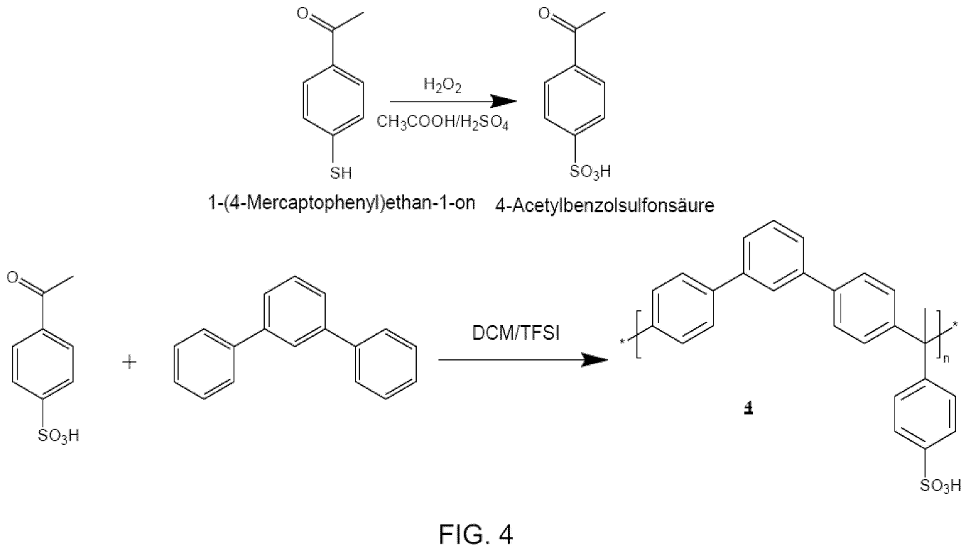

FIG. 4 a reaction scheme of a method according to the invention according to a third embodiment of the present invention;

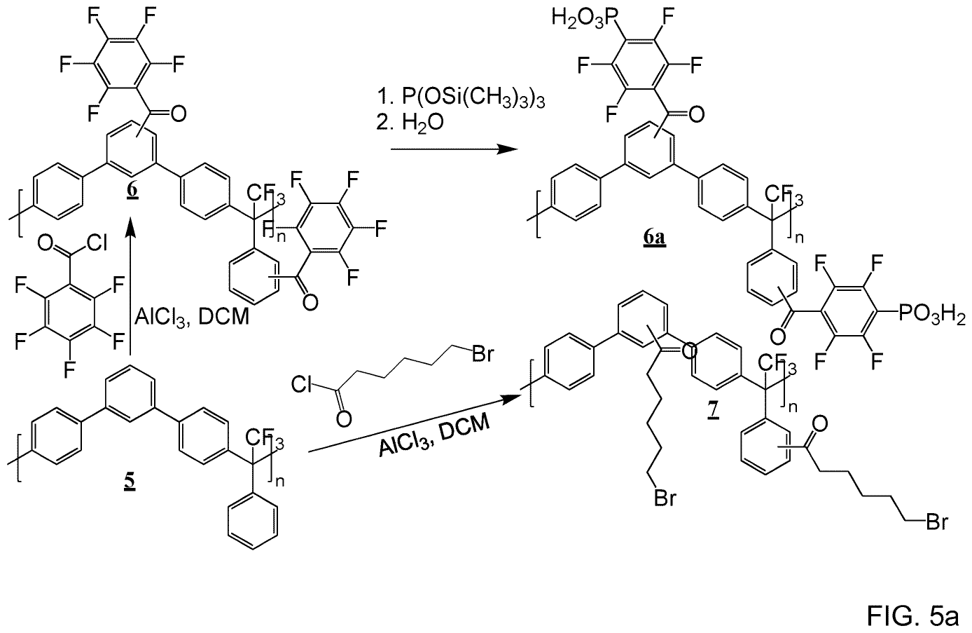

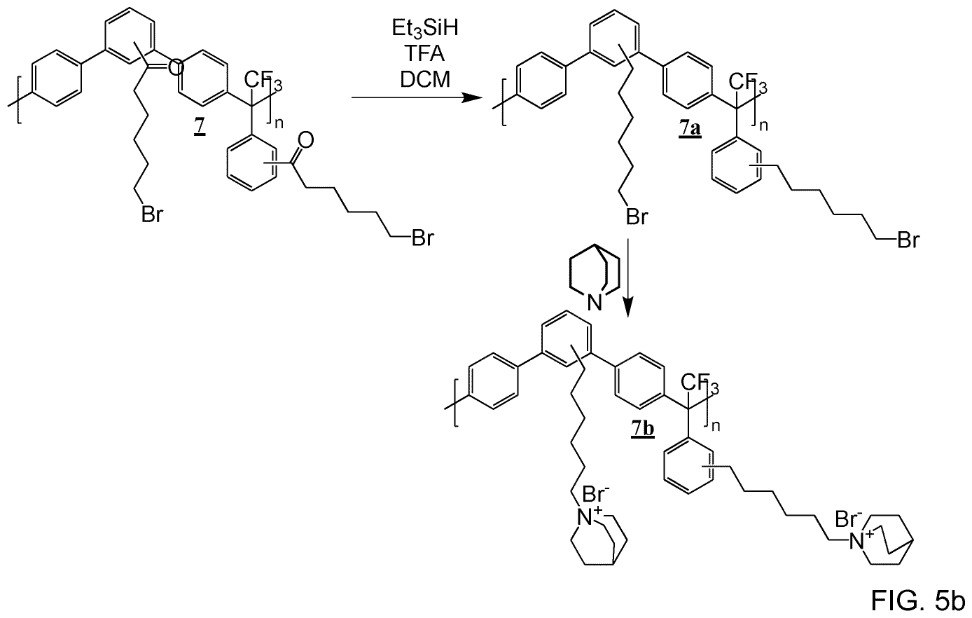

FIG. 5 a-b reaction schemes of methods according to the invention according to a fourth embodiment of the present invention;

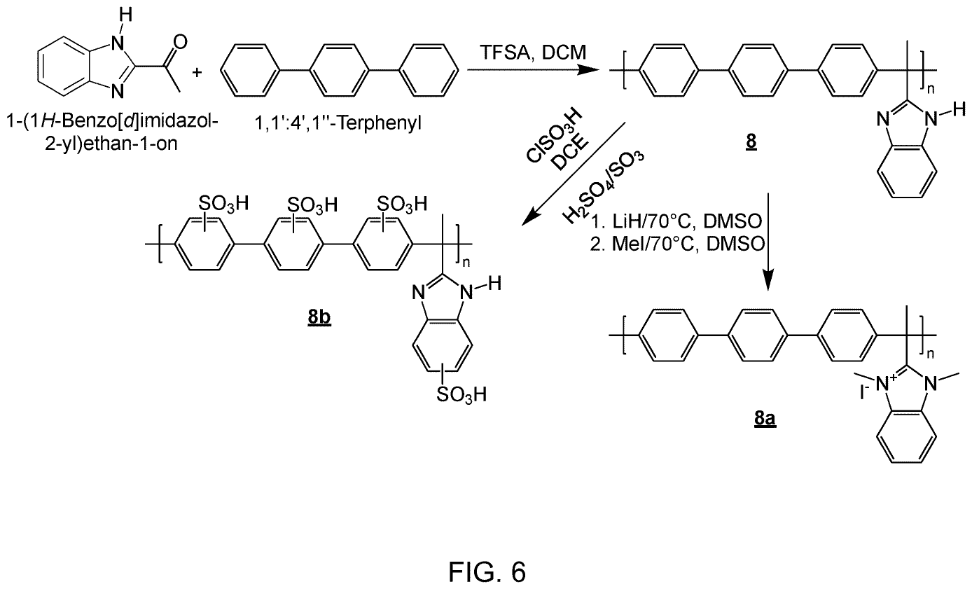

FIG. 6 a reaction scheme of methods according to the invention according to a fifth embodiment of the present invention;

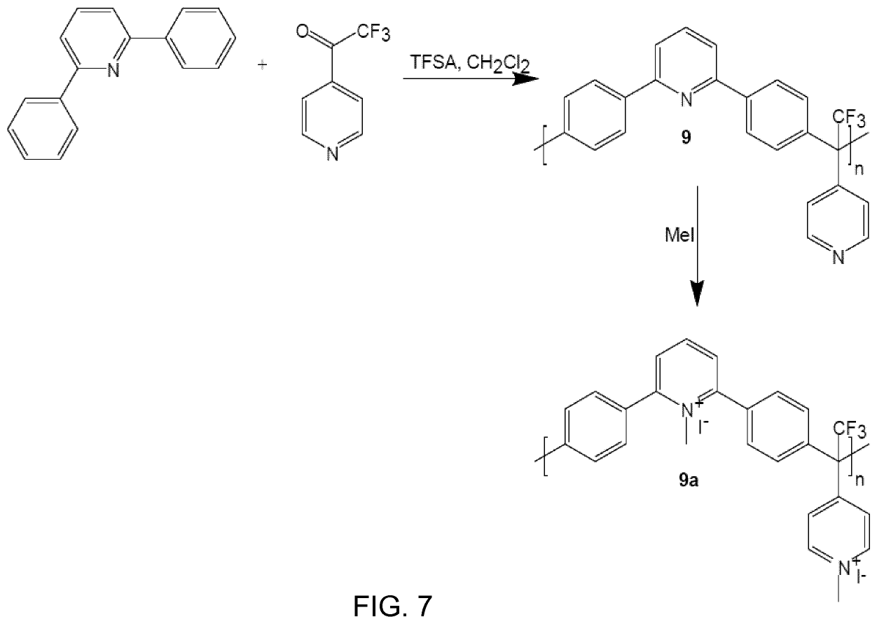

FIG. 7 a reaction scheme of a method according to the invention according to a sixth embodiment of the present invention;

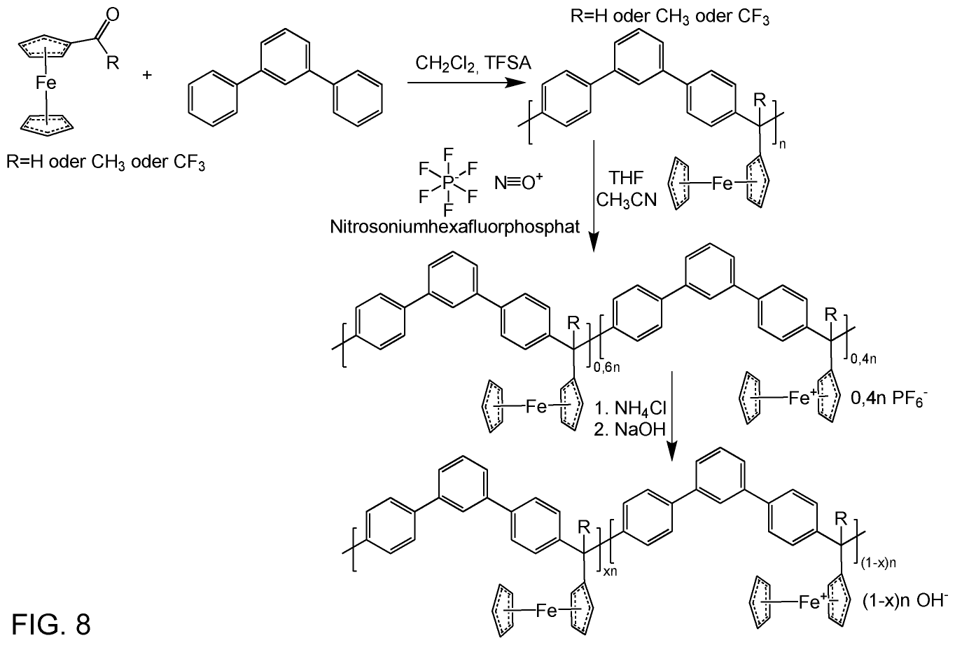

FIG. 8 a reaction scheme of the method according to the invention according to a seventh embodiment of the present invention;

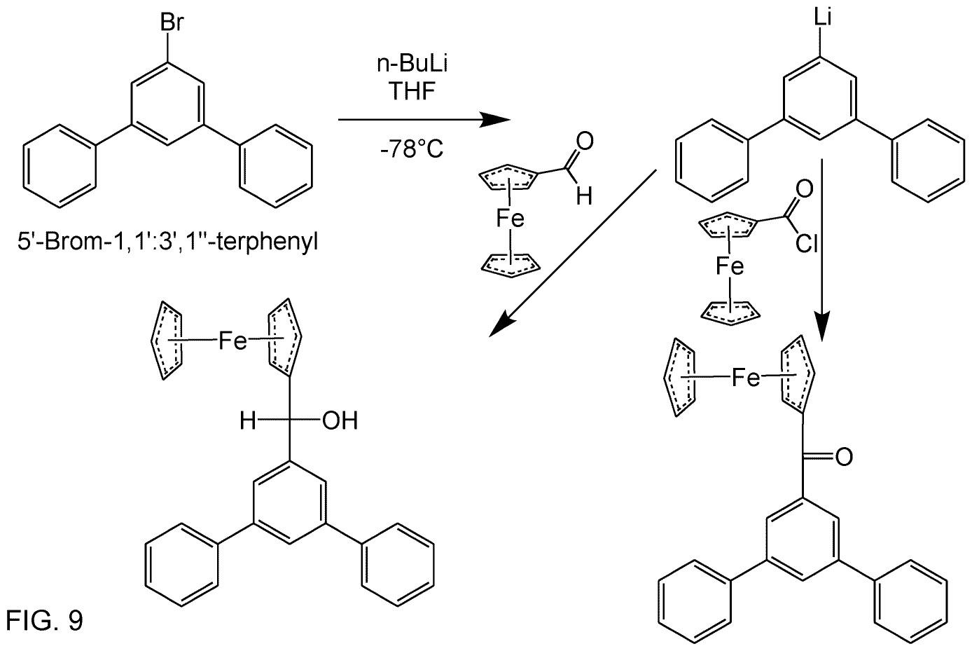

FIG. 9 an alternative or complementary preliminary reaction to the Procedure from FIG. 8;

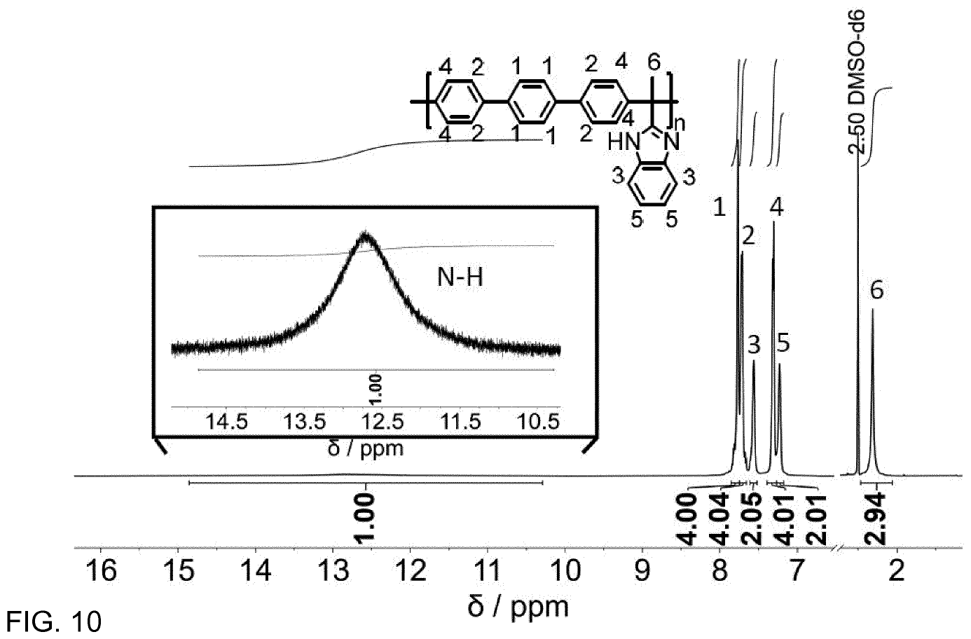

FIG. 10 a ¹H-NMR spectrum of a copolymer of paraterphenyl and 1-(1H-benzimidazol-2-yl)ethanone (embodiment 8);

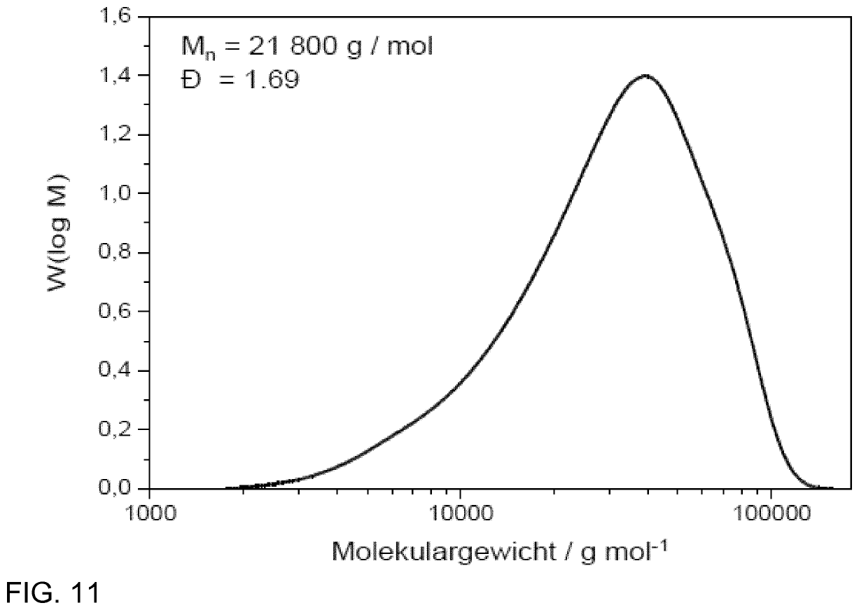

FIG. 11 a GPC curve of the copolymer from FIG. 10;

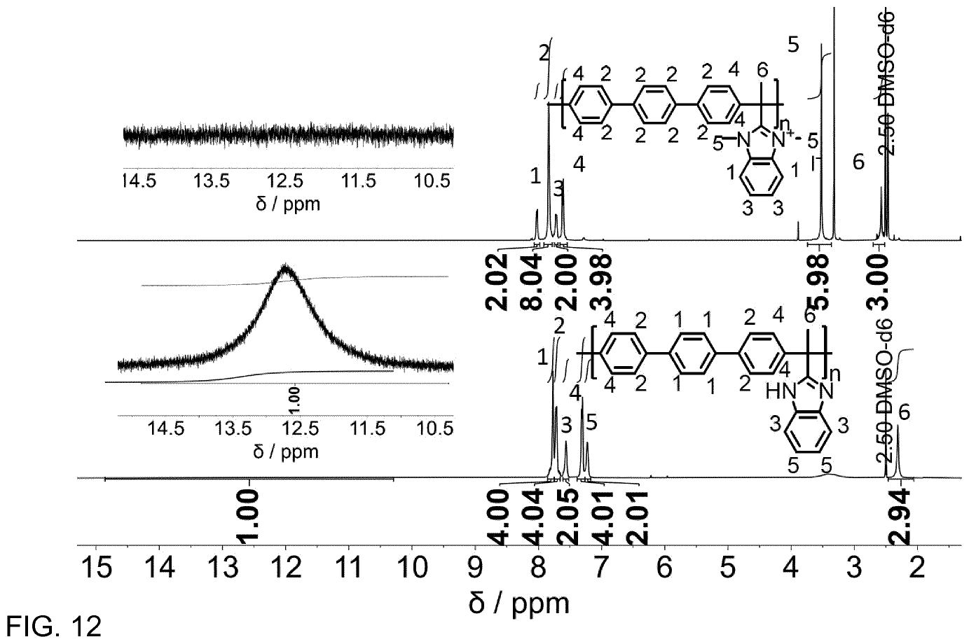

FIG. 12 a ¹H-NMR spectrum of the fully methylated copolymer of paraterphenyl and 1-(1H-benzimidazol-2-yl)ethanone compared to the unmethylated starting polymer;

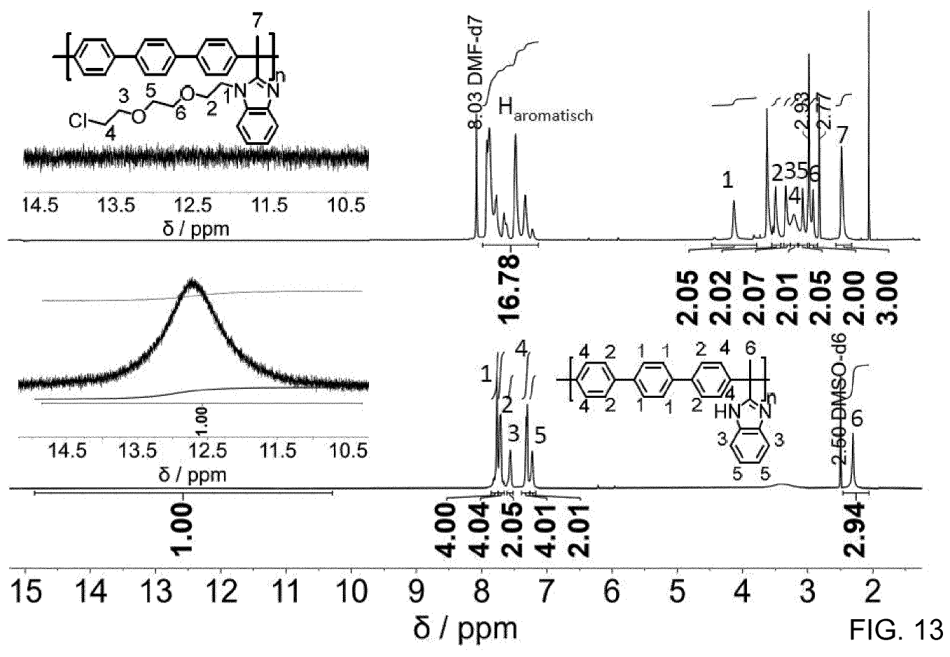

FIG. 13 a ¹H-NMR spectrum of the copolymer from FIG. 10, which was reacted with 1,2-bis(chloroethoxy)ethane in comparison to the starting polymer;

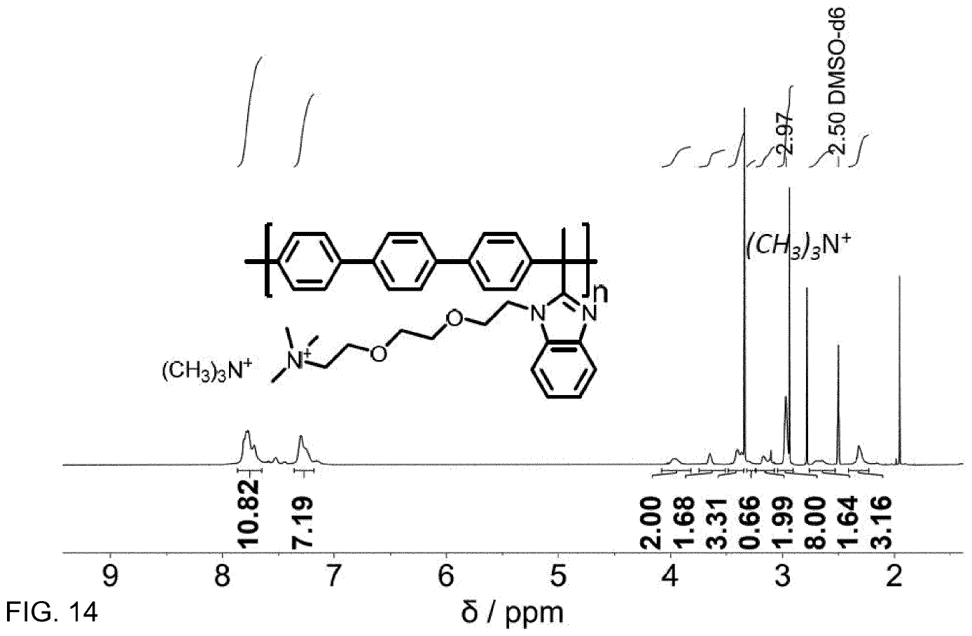

FIG. 14 a ¹H-NMR spectrum of the copolymer of para-terphenyl and 1-(1H-benzimidazol-2-yl)ethanone, which was reacted with 1,2-bis(chloroethoxy)ethane in DMSO-d₈, which was quaternized with trimethylamine to form an anion exchange polymer;

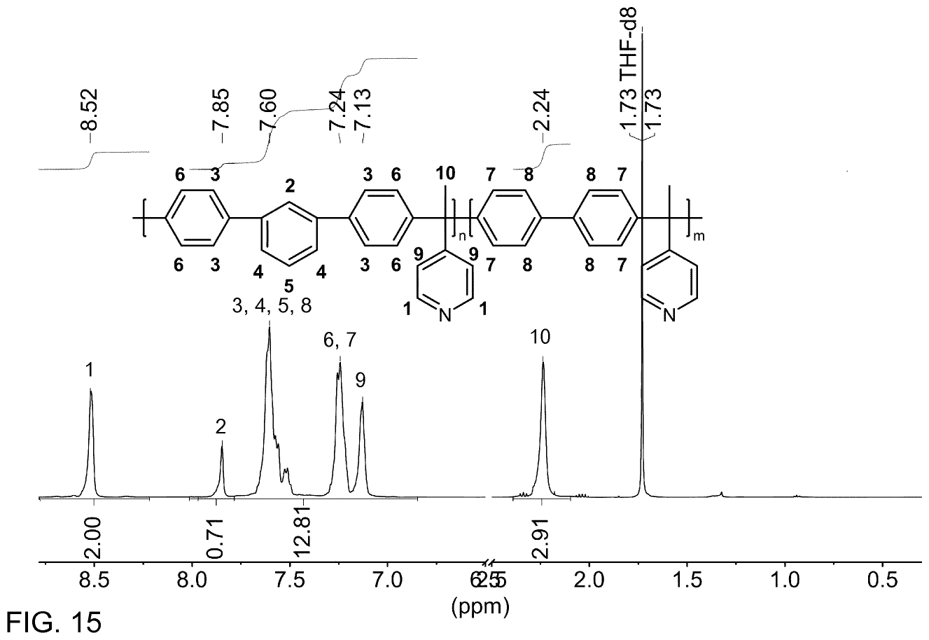

FIG. 15 a ¹H-NMR spectrum of the copolymer of m-terphenyl, biphenyl and 4-acetylpyridine in CH₂ Cl₂ (embodiment 9);

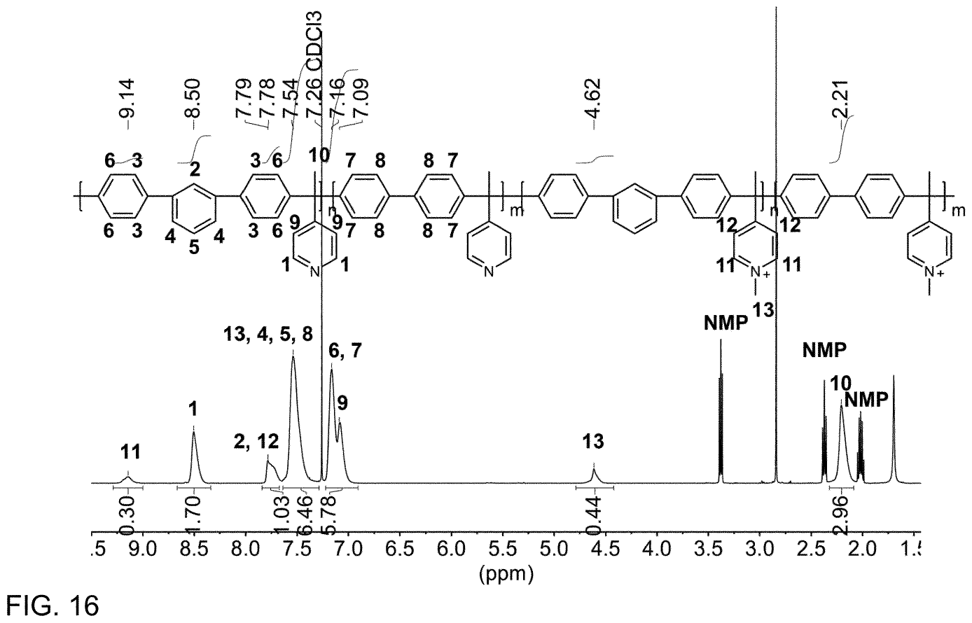

FIG. 16 a ¹H-NMR spectrum of the 15% methylated copolymer from FIG. 15;

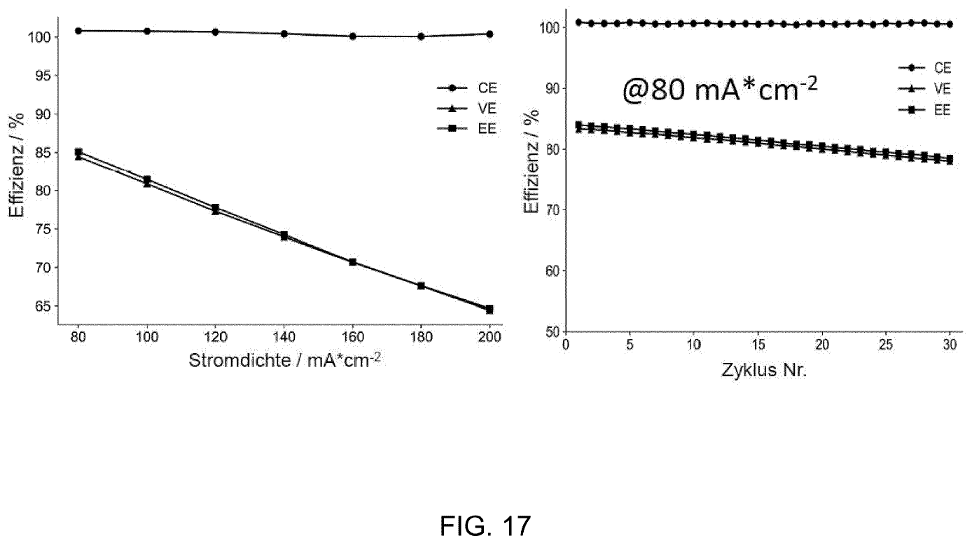

FIG. 17 a graph with Coulomb efficiency, voltage efficiency and energy efficiency of a membrane made from the substances of the embodiments 9;

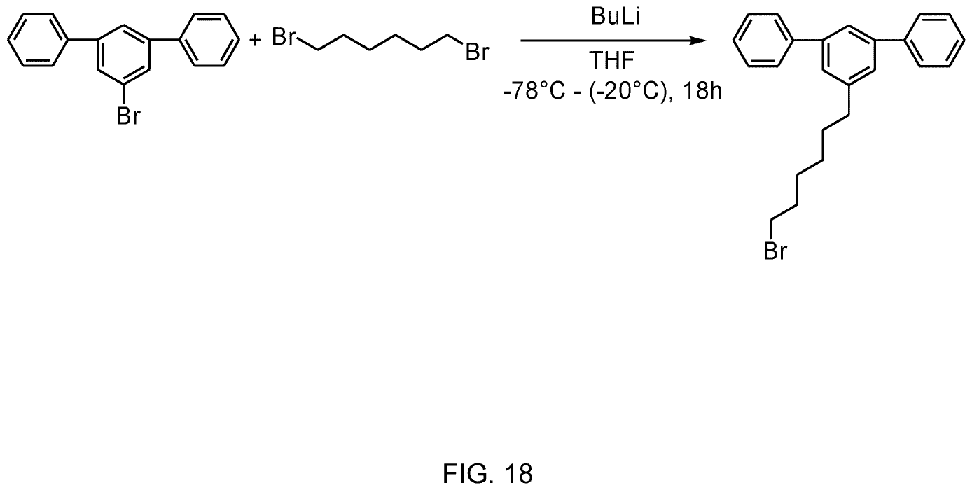

FIG. 18 a reaction scheme of a method according to the invention according to a tenth embodiment example;

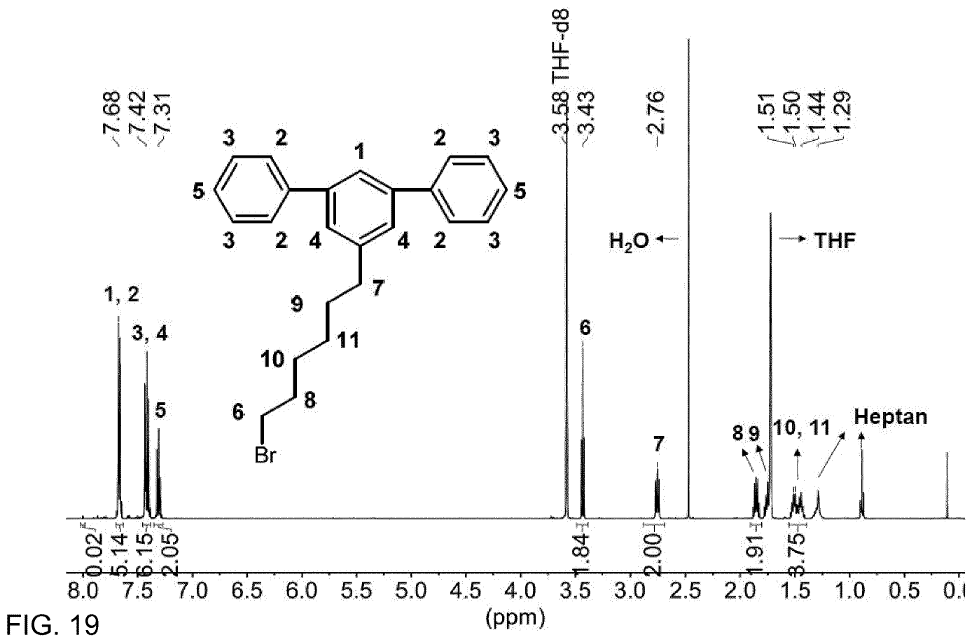

FIG. 19 the ¹H-NMR spectrum of the reaction scheme from FIG. 18 manufactured fabric;

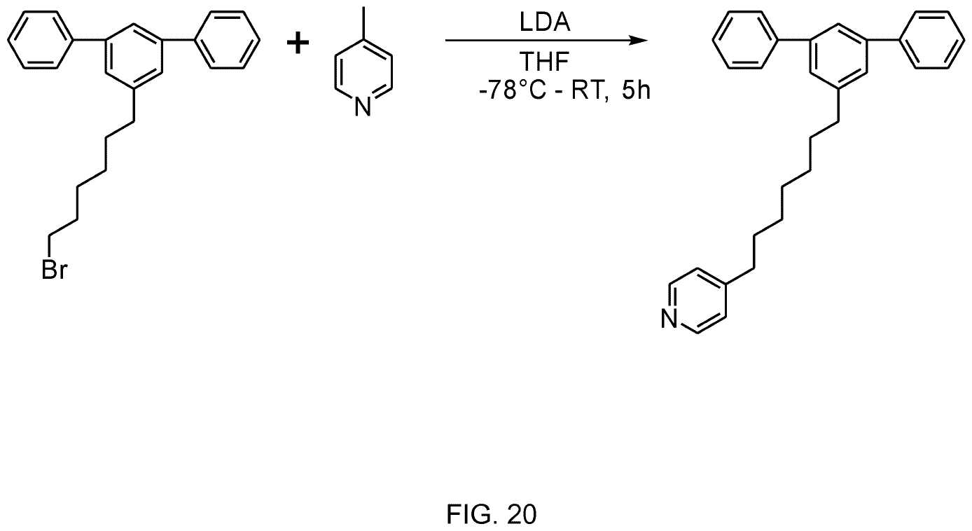

FIG. 20 a reaction scheme of a preliminary reaction of a method according to the invention according to an eleventh embodiment;

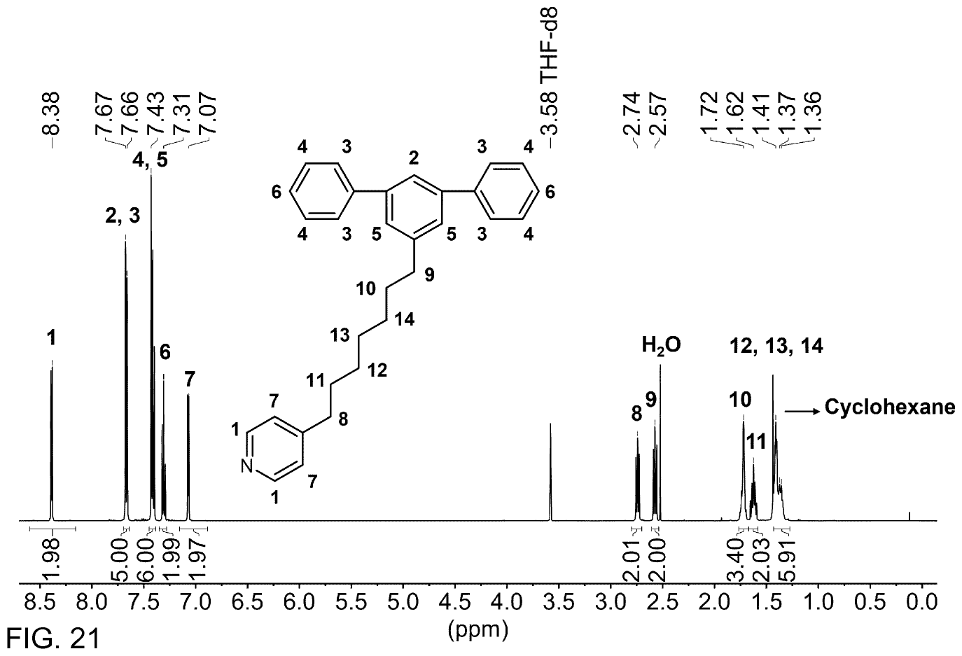

FIG. 21 The 1H-NMRspectrum of the substance prepared by the method according to the reaction scheme in FIG. 20;

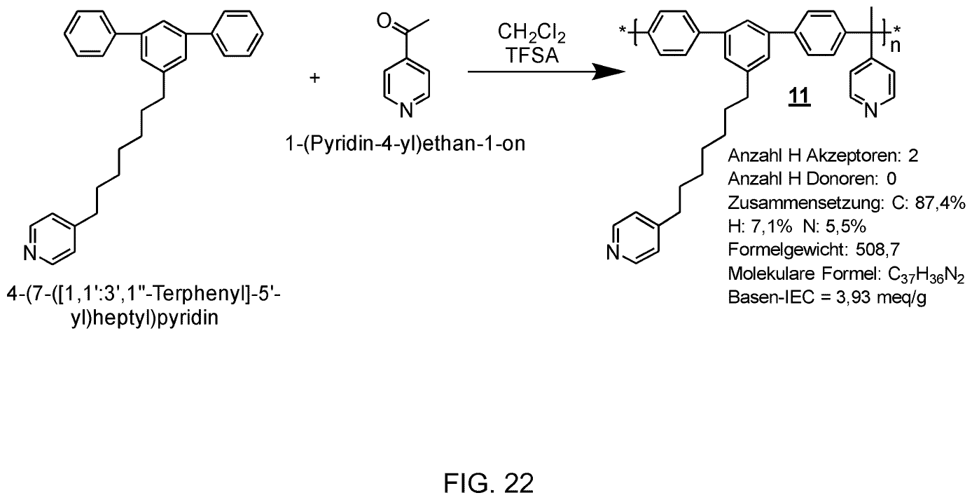

FIG. 22 a reaction scheme of a polyhydroxyalkylation, wherein a starting material was modified using the method shown in FIG. 20;

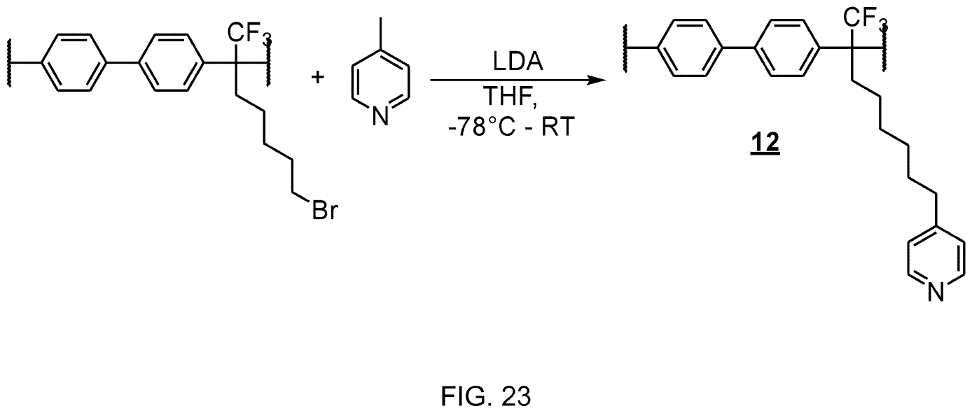

FIG. 23 a reaction scheme of a method according to the invention according to a twelfth embodiment example;

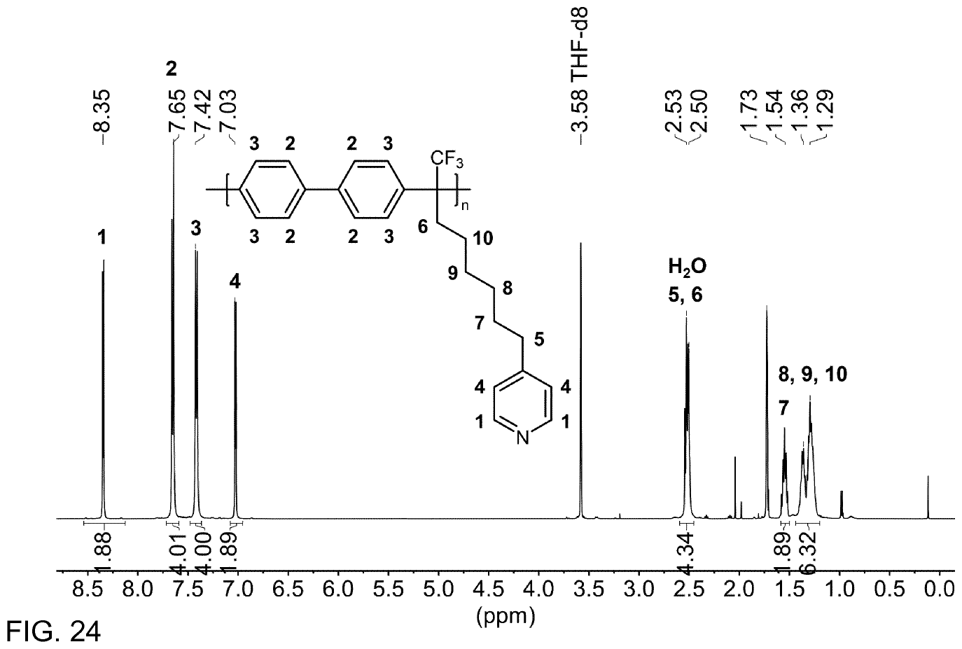

FIG. 24 The 1H-NMRspectrum of the material obtained by means of the substance obtained by the method;

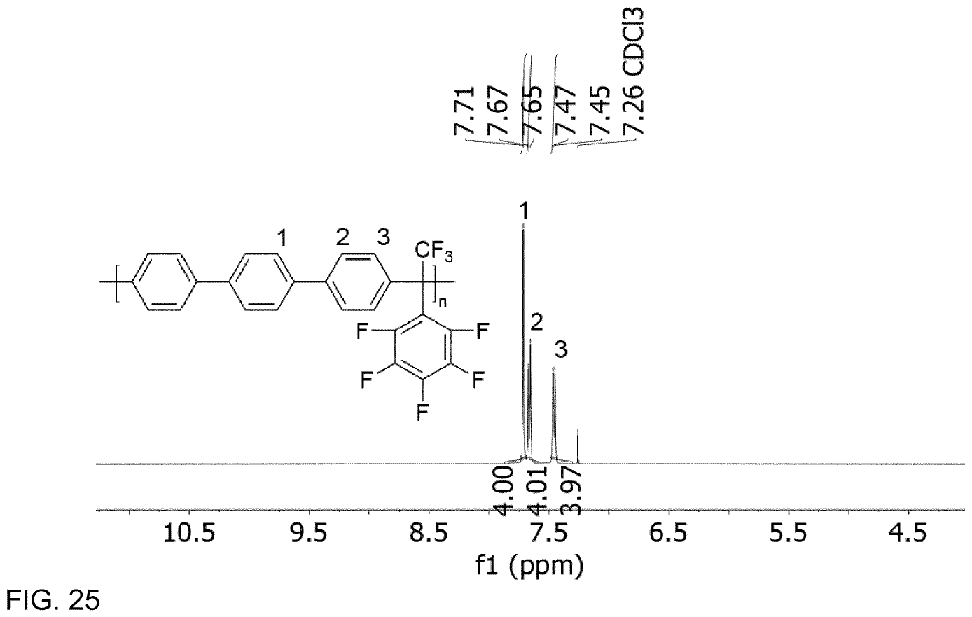

FIG. 25 The 1H-NMRspectrum of a substance obtained from a method according to the invention according to a 13th embodiment;

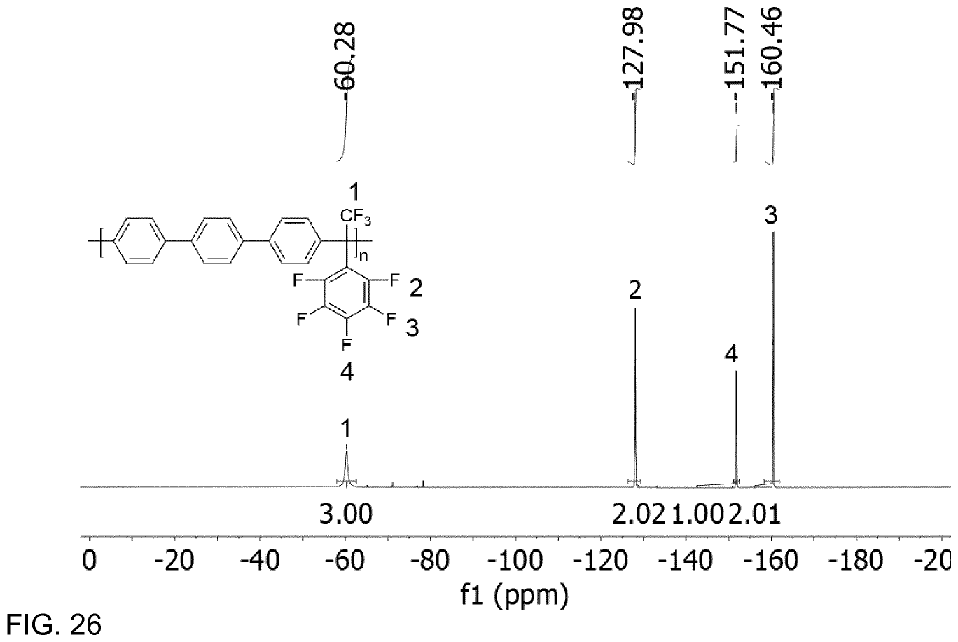

FIG. 26 the ¹⁹ F-NMR spectrum of the substance obtained by a method according to the 13th embodiment;

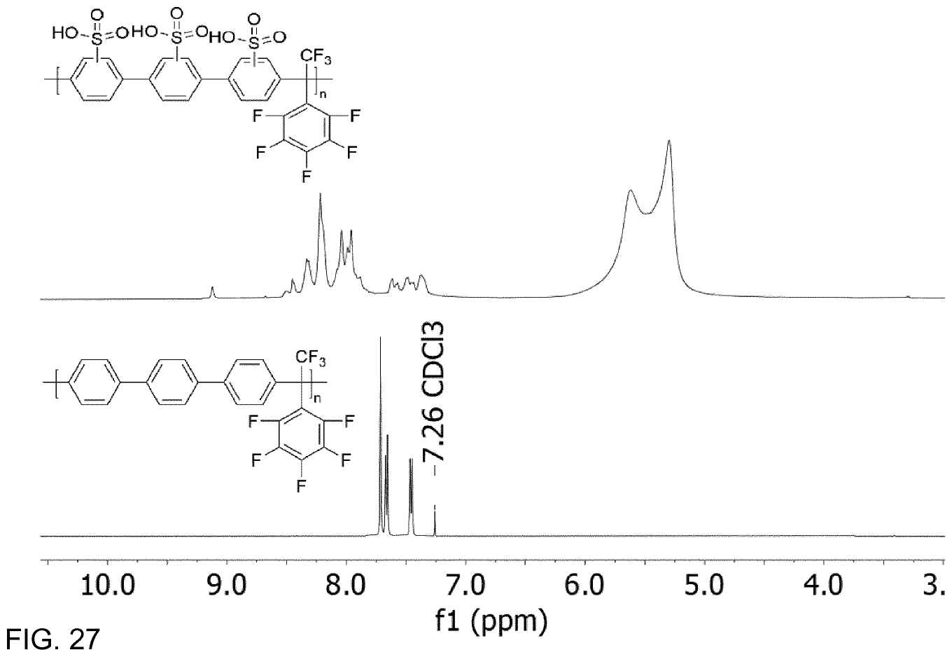

FIG. 27 an additional ¹ H-NMR spectrum of the starting polymer and the modified sulfonated polymer of the 13th embodiment;

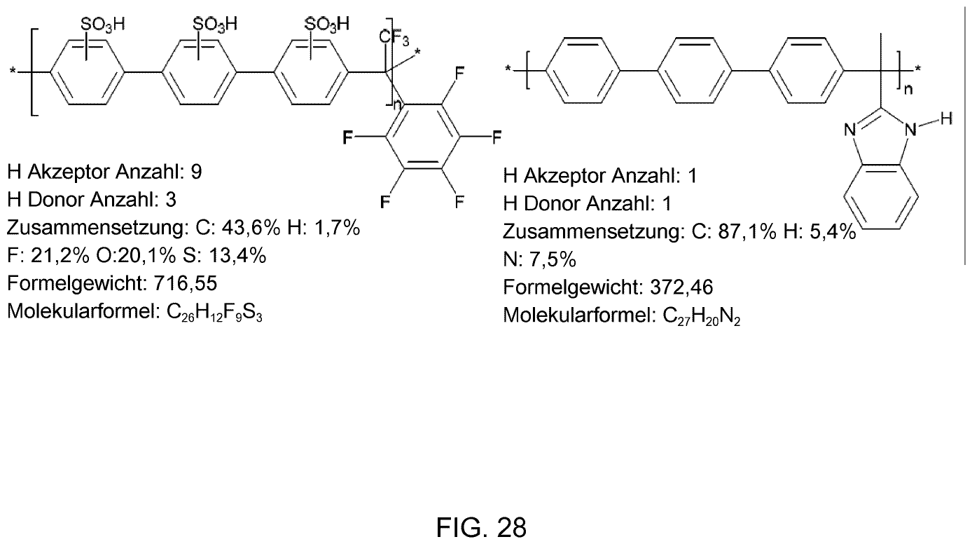

FIG. 28 structural formulas of polymers prepared according to a 14 example of a method according to the invention were produced;

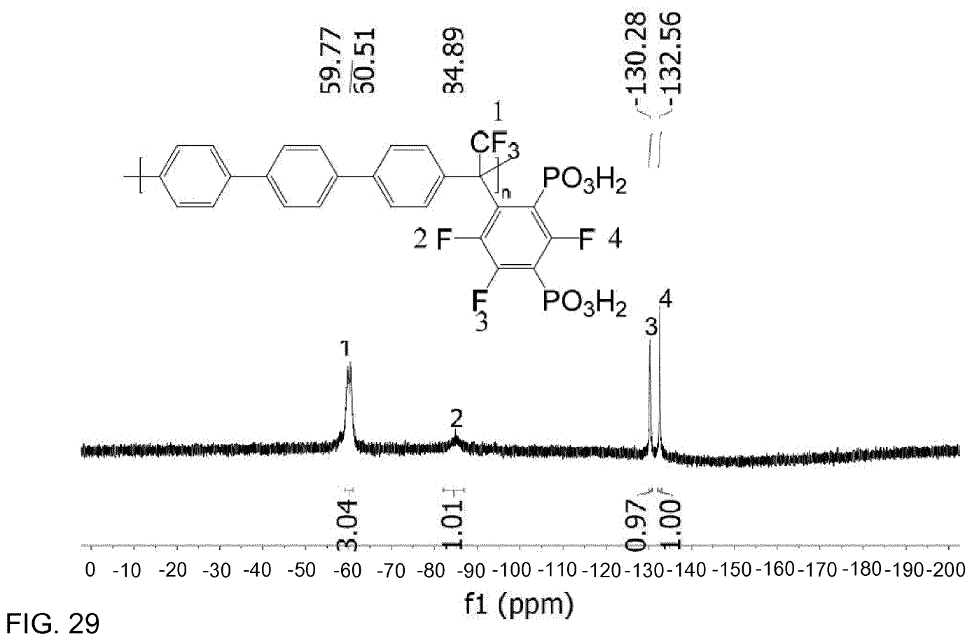

FIG. 29 a ¹⁹ F-NMR spectrum of a double-phosphonated copolymer of p-terphenyl and perfluoroacetophenone (15th embodiment);

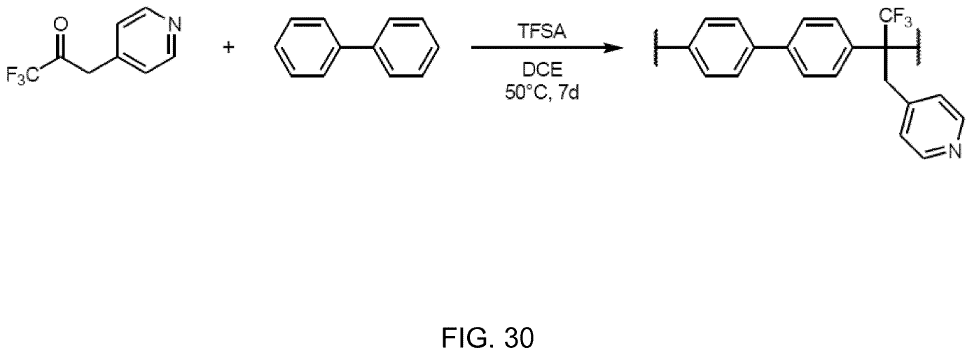

FIG. 30 a reaction scheme of a method according to the invention according to a 16th embodiment example;

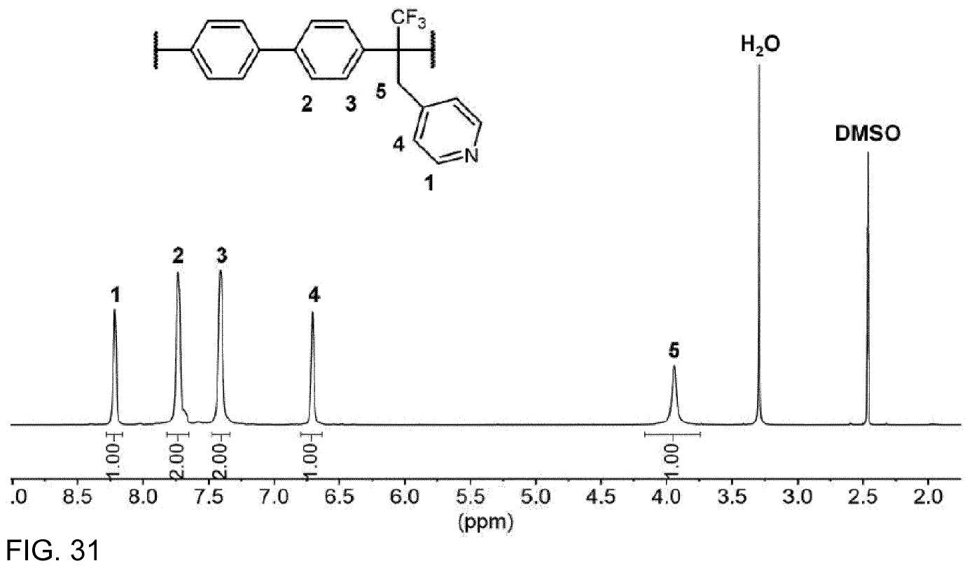

FIG. 31 a ¹H-NMR spectrum of the substance obtained by a method according to the 16th embodiment;

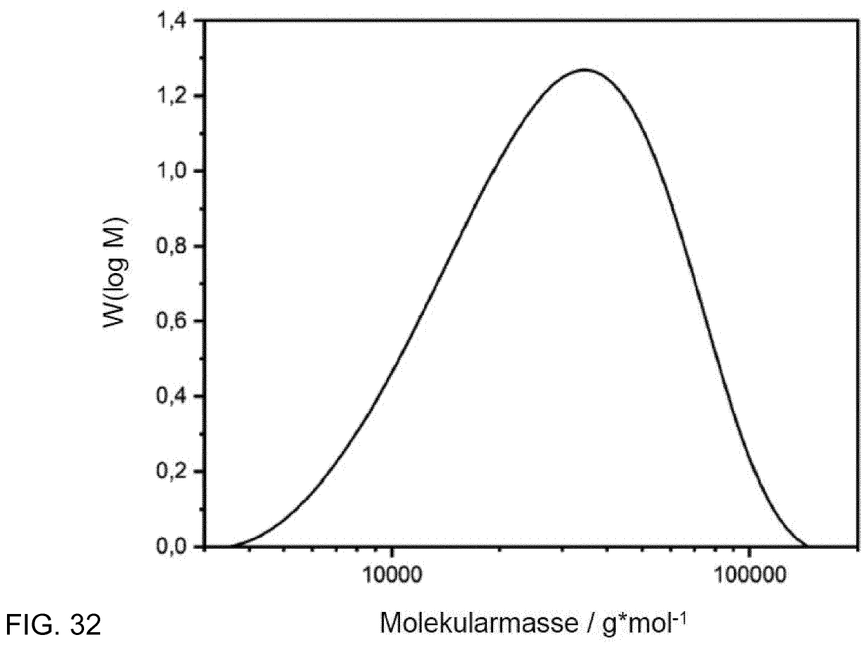

FIG. 32 the molar mass distribution of the substance obtained by a method according to the 16th embodiment;

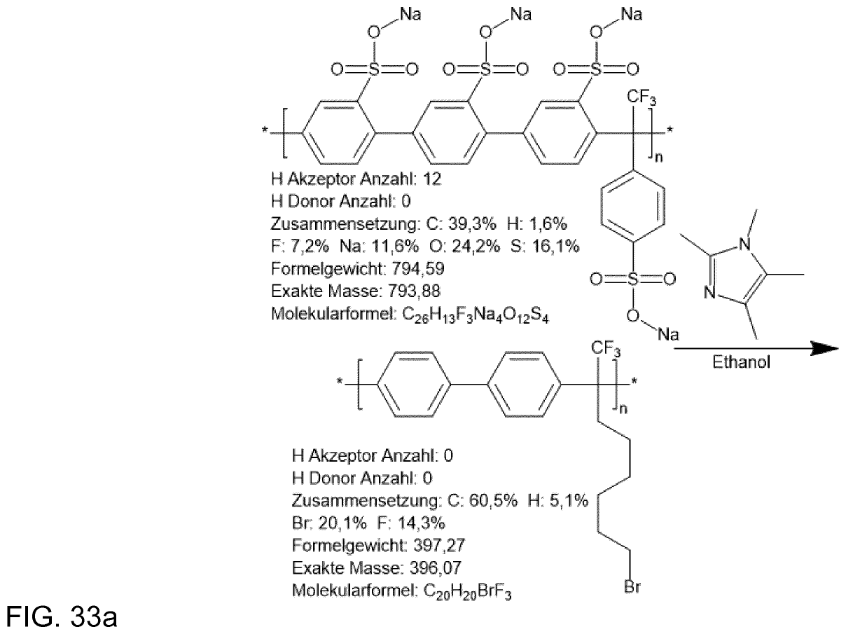

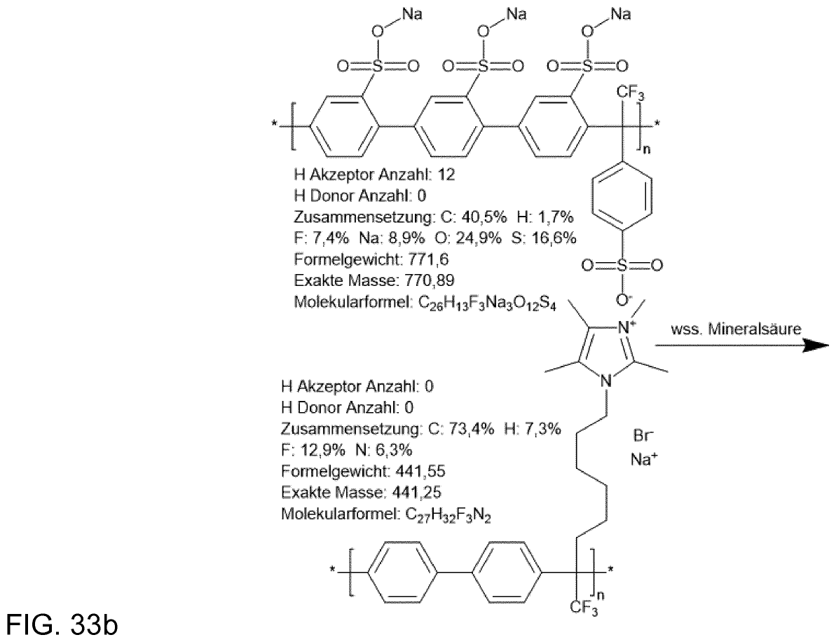

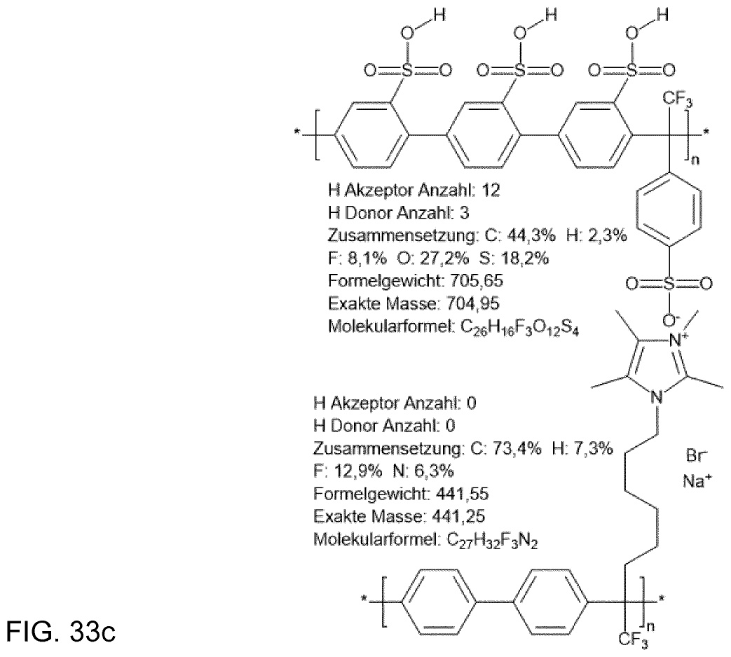

FIG. 33a-c reaction schemes for subsequent reactions of a method according to the invention (17th embodiment);

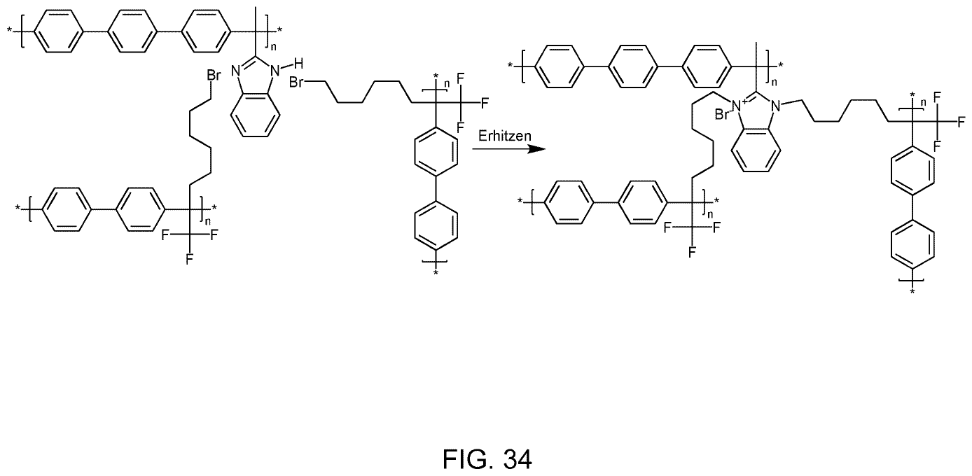

FIG. 34 a reaction scheme for subsequent reactions of a method according to the invention (18th embodiment);

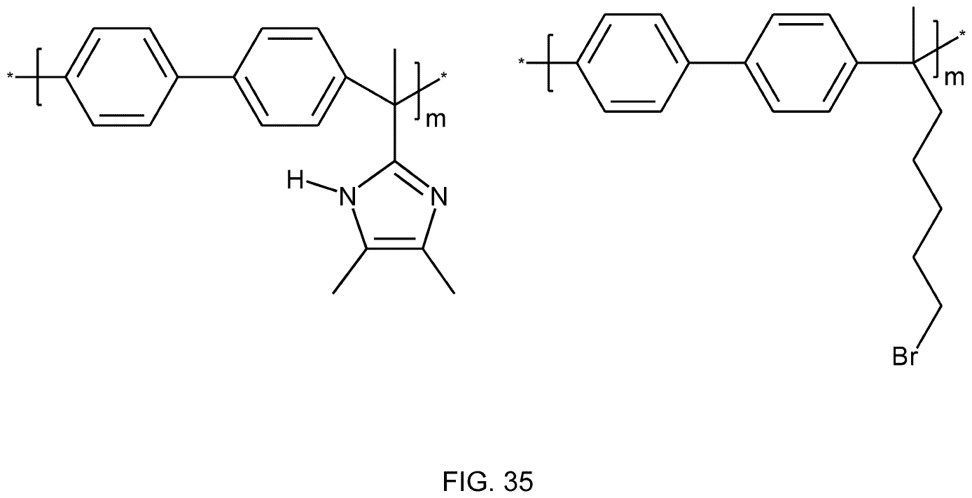

FIG. 35 structural formulae of alternative PHA polymers for the subsequent reactions of FIG. 34;

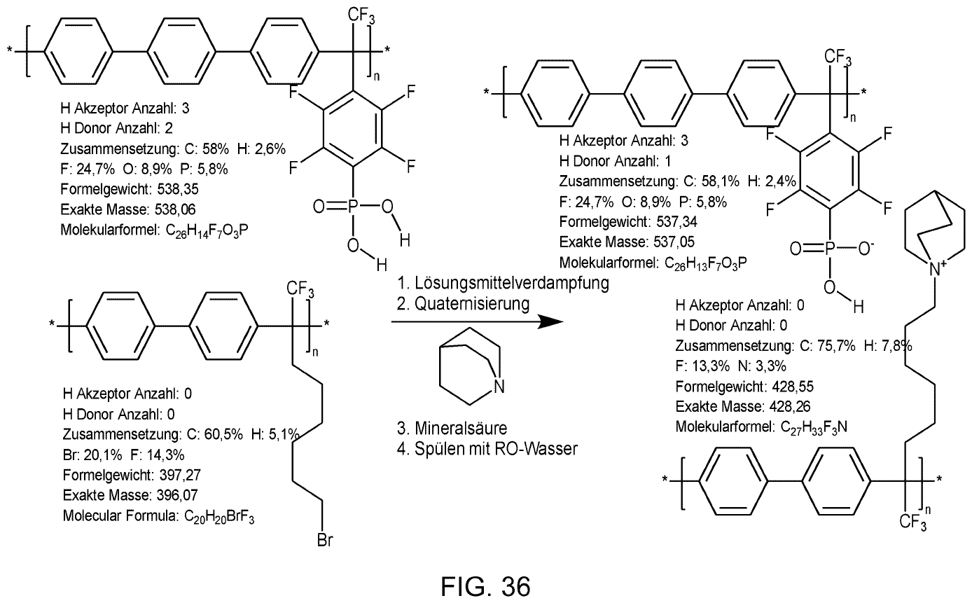

FIG. 36 reaction schemes for subsequent reactions of a method according to the invention (19th embodiment);

FIG. 37 reaction schemes for subsequent reactions of a method according to the invention (20th embodiment);

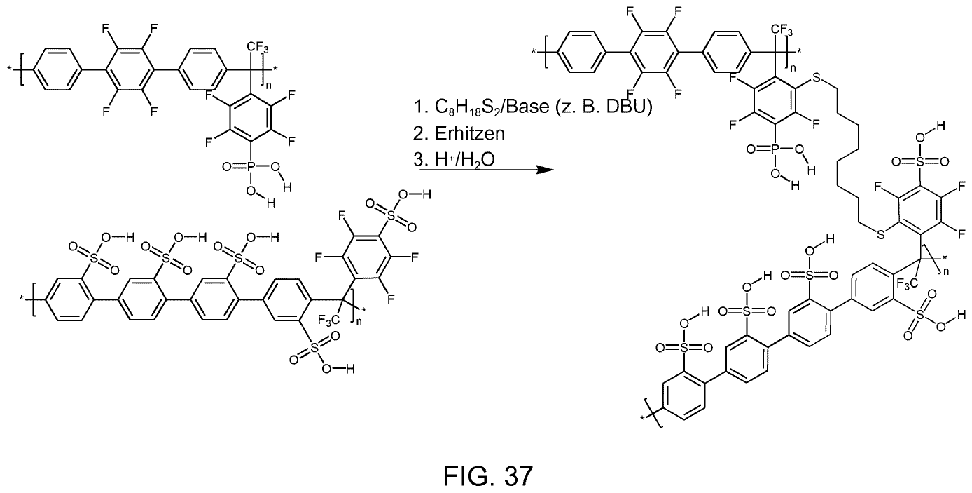

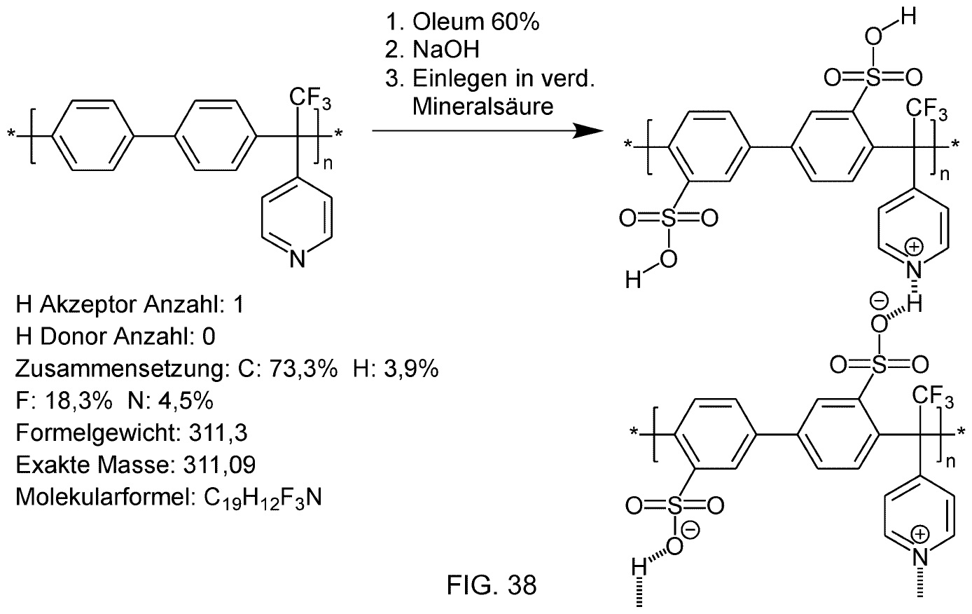

FIG. 38 a reaction scheme for subsequent reactions of a method according to the invention (21st embodiment);

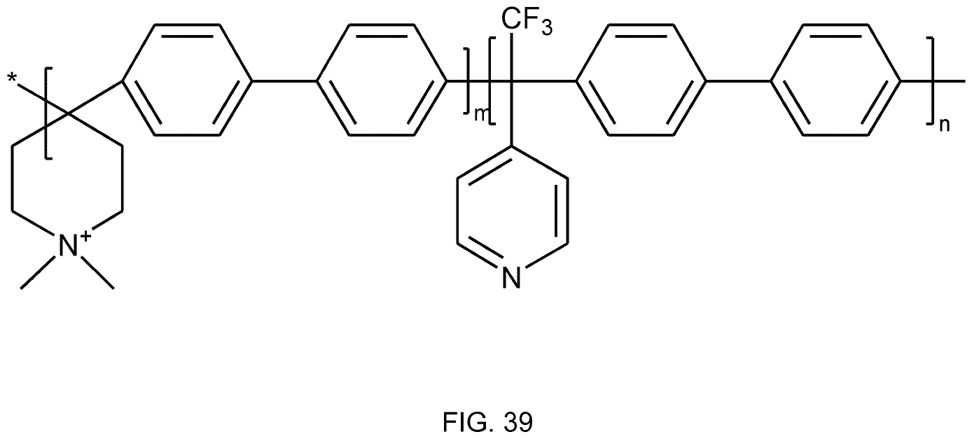

FIG. 39 a structural formula of an alternative PHA polymer for the subsequent reaction shown in FIG. 38;

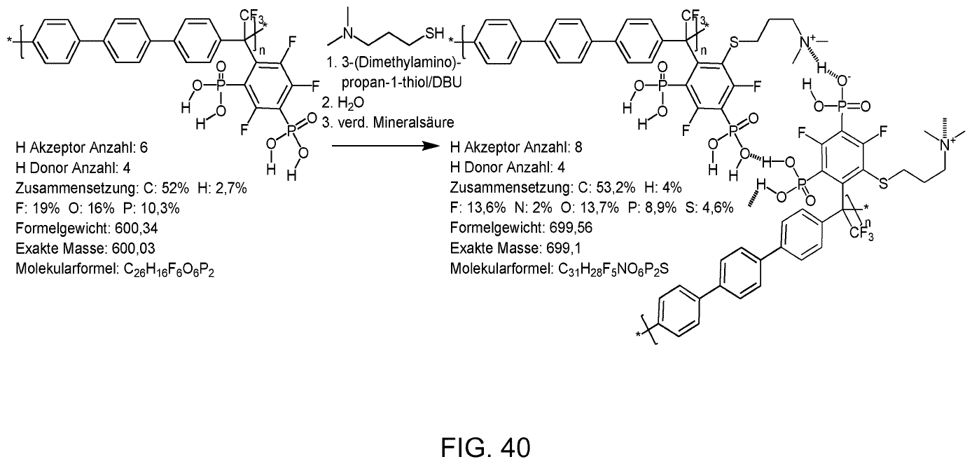

FIG. 40 a reaction scheme of a subsequent reaction of a method according to the invention (22nd embodiment);

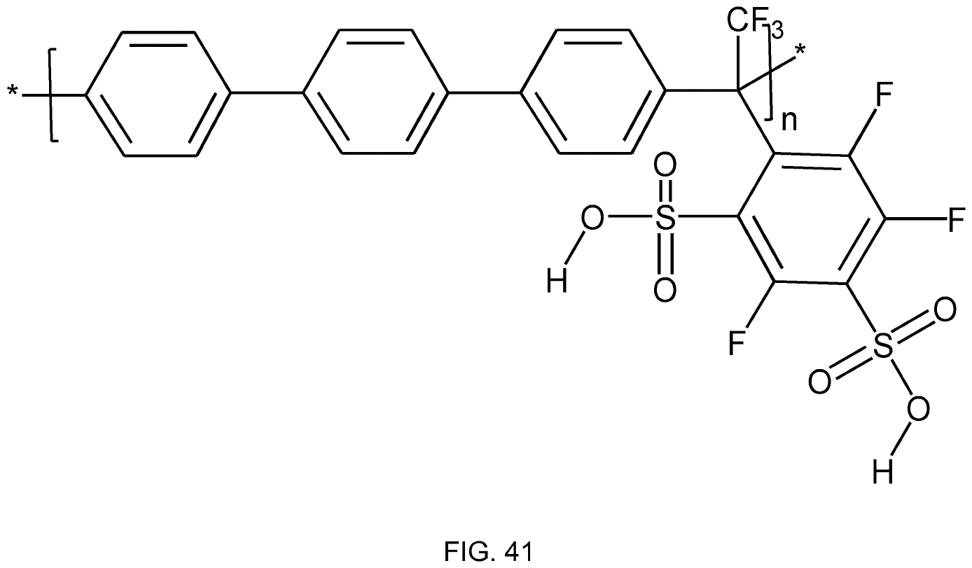

FIG. 41 a structural formula of an alternative PHA polymer for the subsequent reaction from FIG. 40;

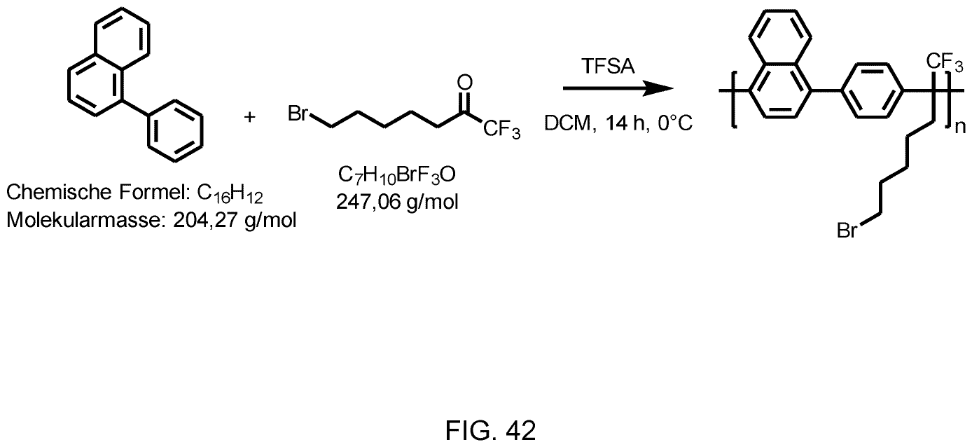

FIG. 42 a reaction scheme for synthesizing a polymer according to a method according to the invention (23rd embodiment);

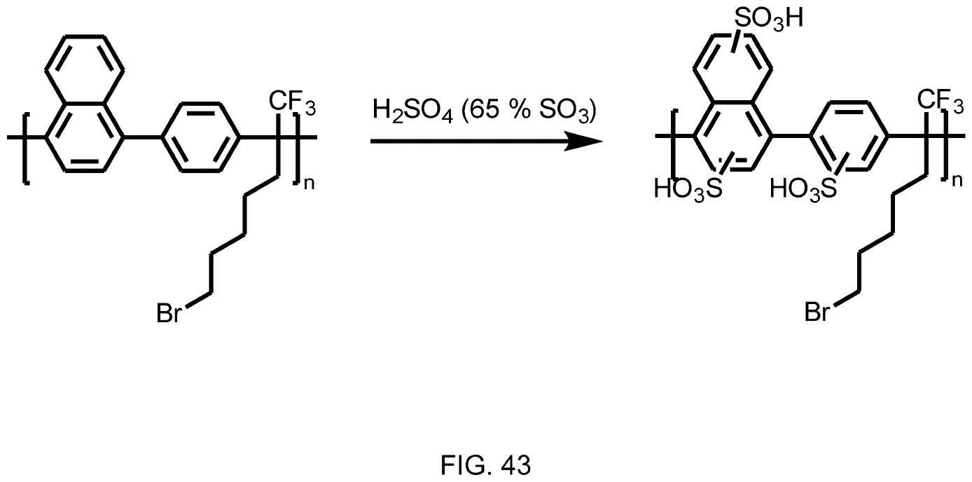

FIG. 43 a reaction scheme of a subsequent reaction of a method according to the invention (24th embodiment);

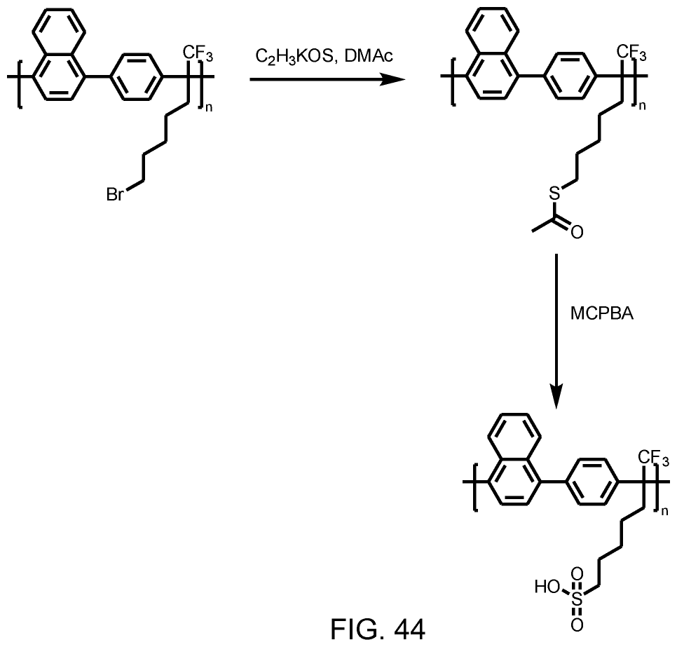

FIG. 44 a reaction scheme of a subsequent reaction of a method according to the invention (25th embodiment);

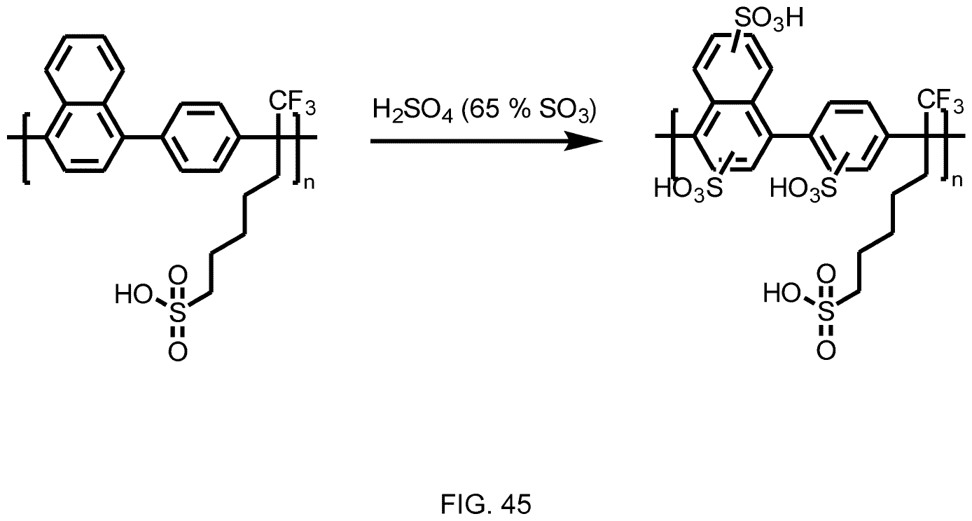

FIG. 45 a reaction scheme of a further subsequent reaction to the subsequent reaction of FIG. 44 (26th embodiment);

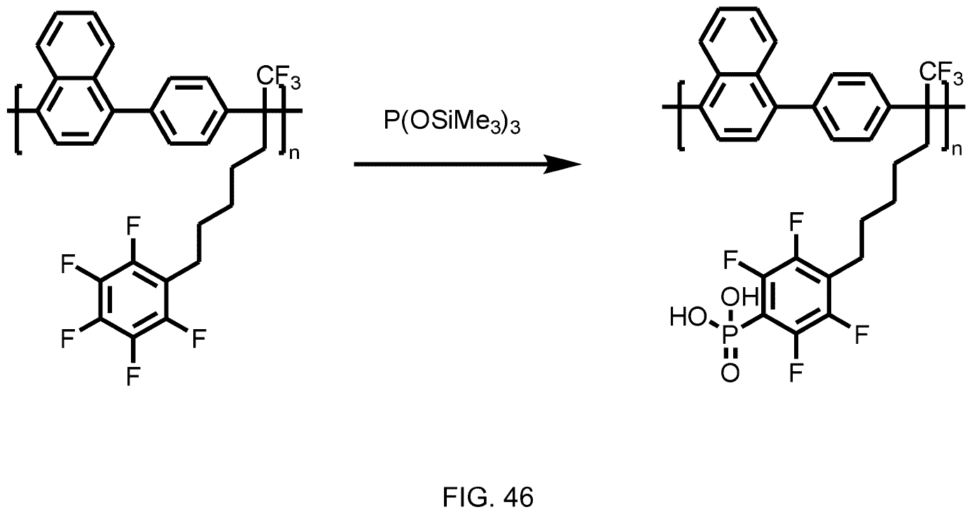

FIG. 46 a reaction scheme of a possible subsequent reaction of a method according to the invention (27th embodiment);

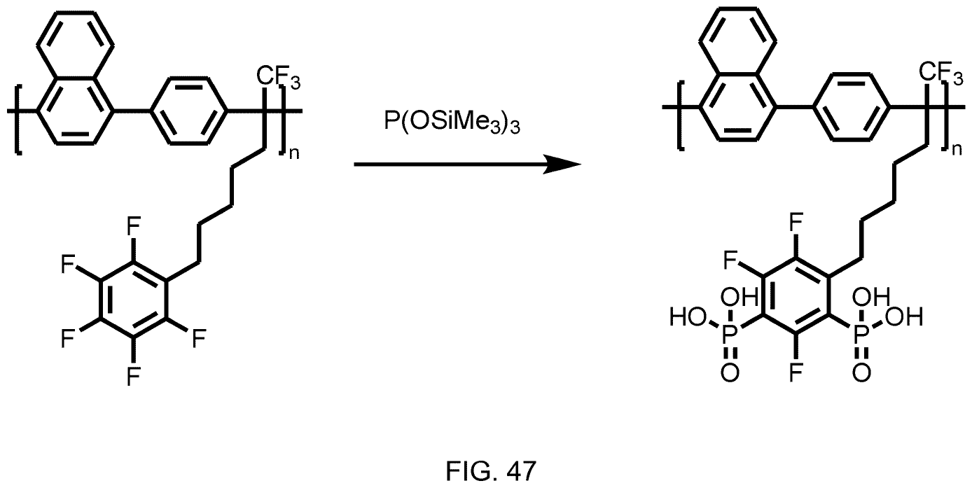

FIG. 47 a reaction scheme of a possible subsequent reaction of a method according to the invention (28th embodiment);

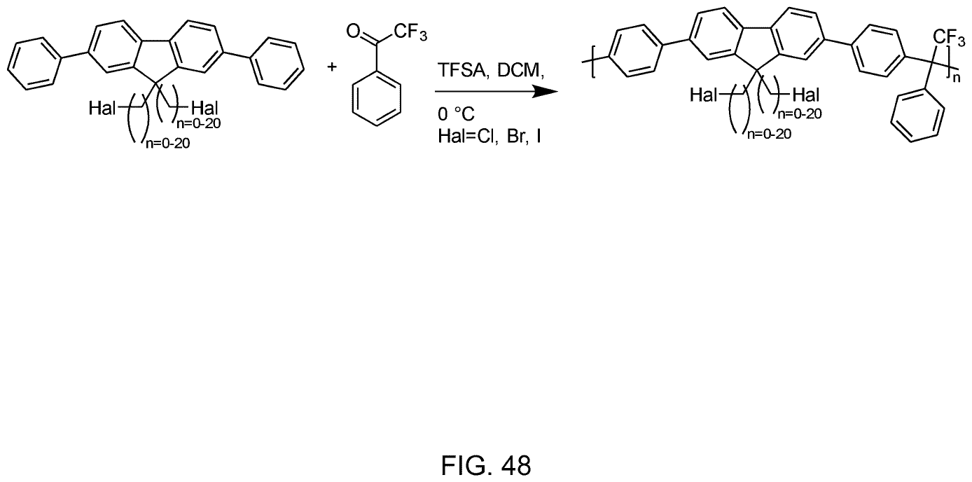

FIG. 48 a reaction scheme for synthesizing a polymer of a method according to the invention (29th embodiment);

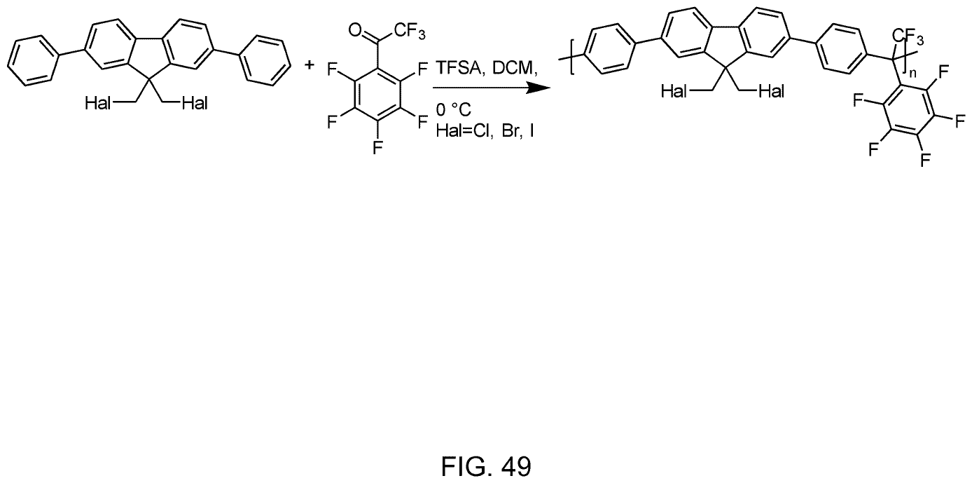

FIG. 49 a reaction scheme for synthesizing a polymer of a method according to the invention (30th embodiment);

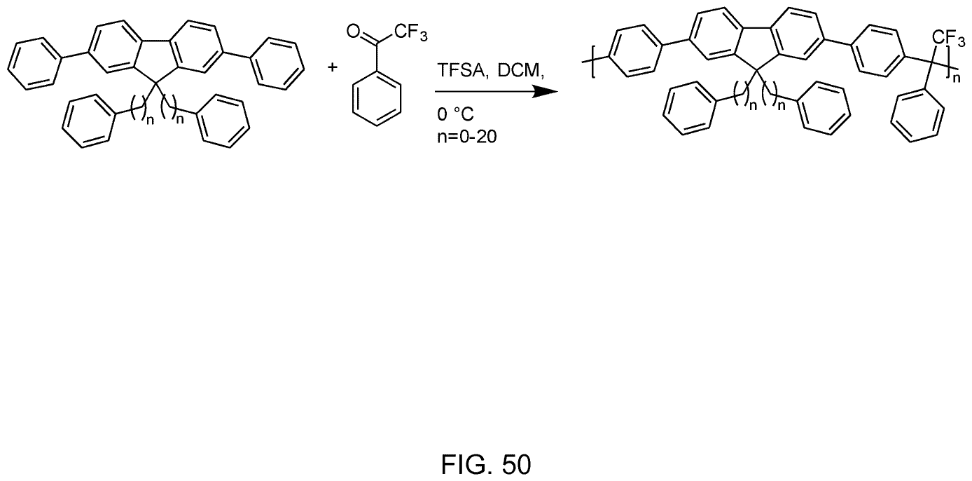

FIG. 50 a reaction scheme for synthesizing a polymer of a method according to the invention (31st embodiment);

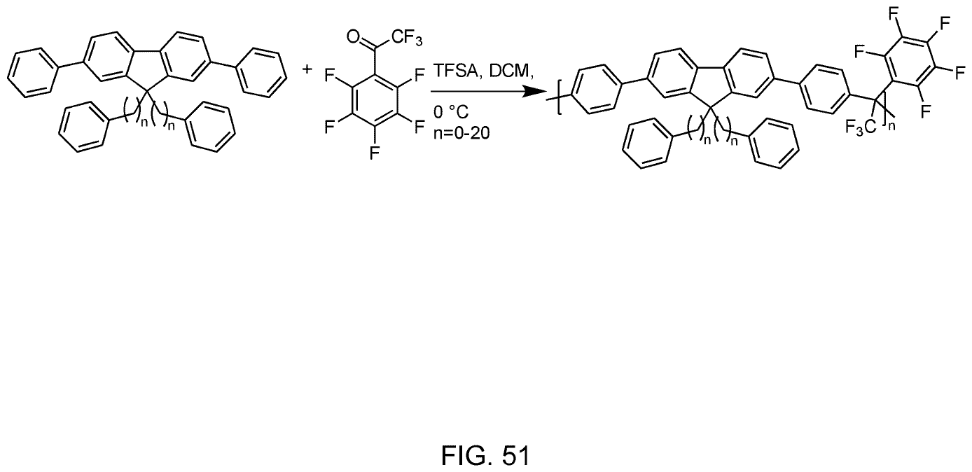

FIG. 51 a reaction scheme for synthesizing a polymer of a method according to the invention (32nd embodiment);

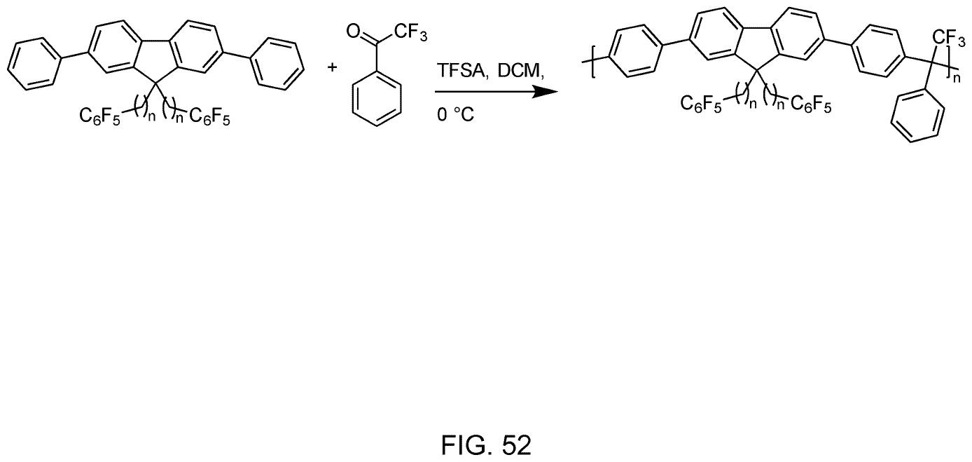

FIG. 52 a reaction scheme for synthesizing a polymer of a method according to the invention (33rd embodiment);

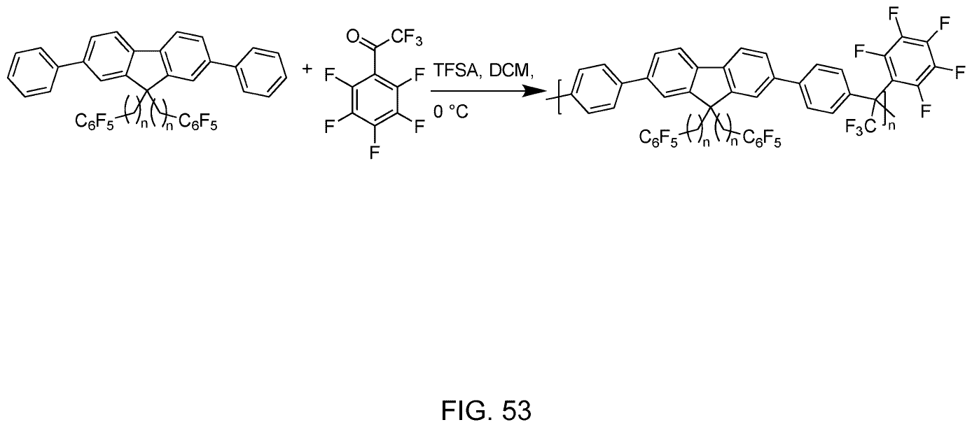

FIG. 53 a reaction scheme for synthesizing a polymer according to a method according to the invention (34th embodiment);

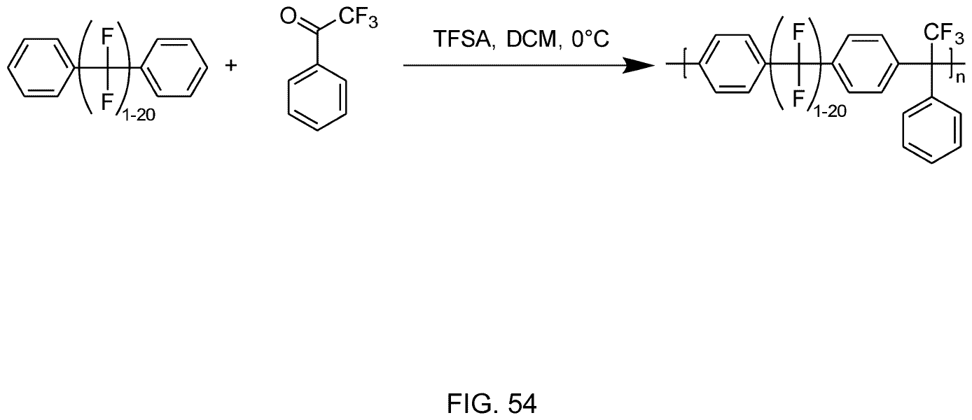

FIG. 54 a reaction scheme for synthesizing a polymer according to a method according to the invention (35th embodiment);

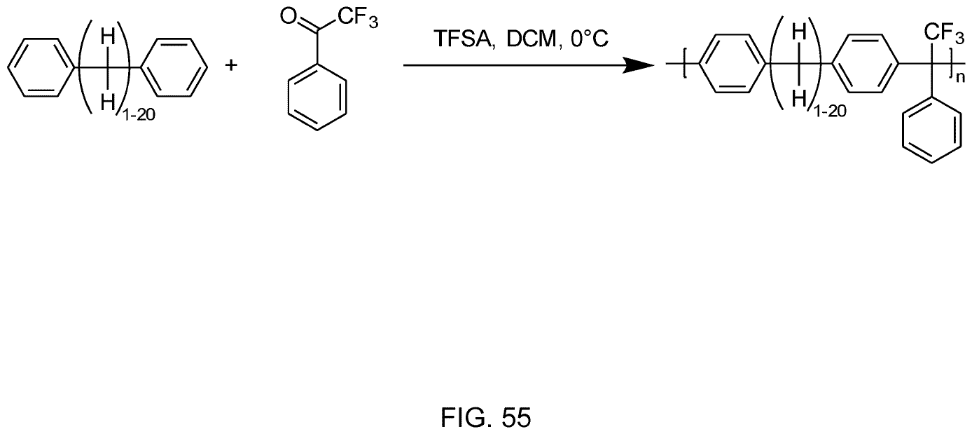

FIG. 55 a reaction scheme for synthesizing a polymer according to a method according to the invention (36th embodiment);

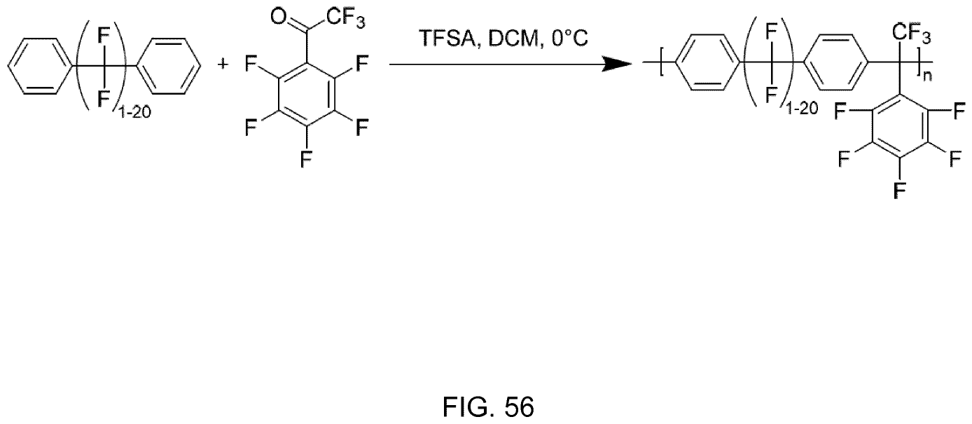

FIG. 56 a reaction scheme for synthesizing a polymer according to a method according to the invention (37th embodiment);

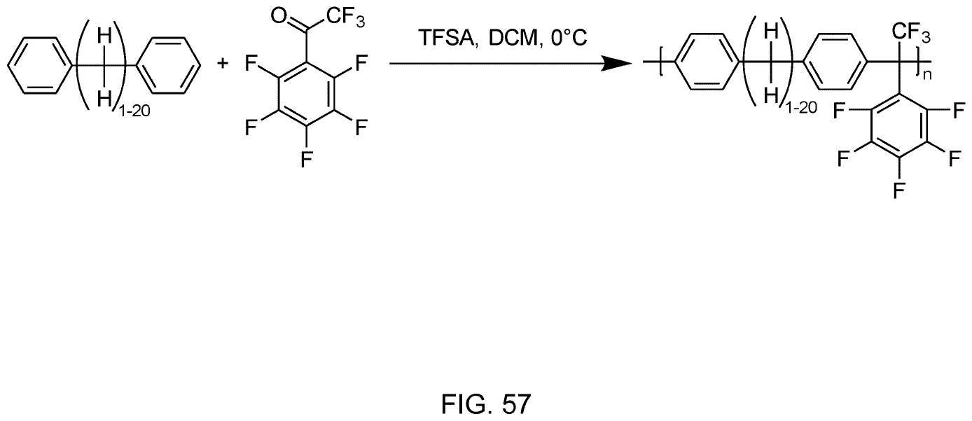

FIG. 57 a reaction scheme for synthesizing a polymer according to a method according to the invention (38th embodiment);

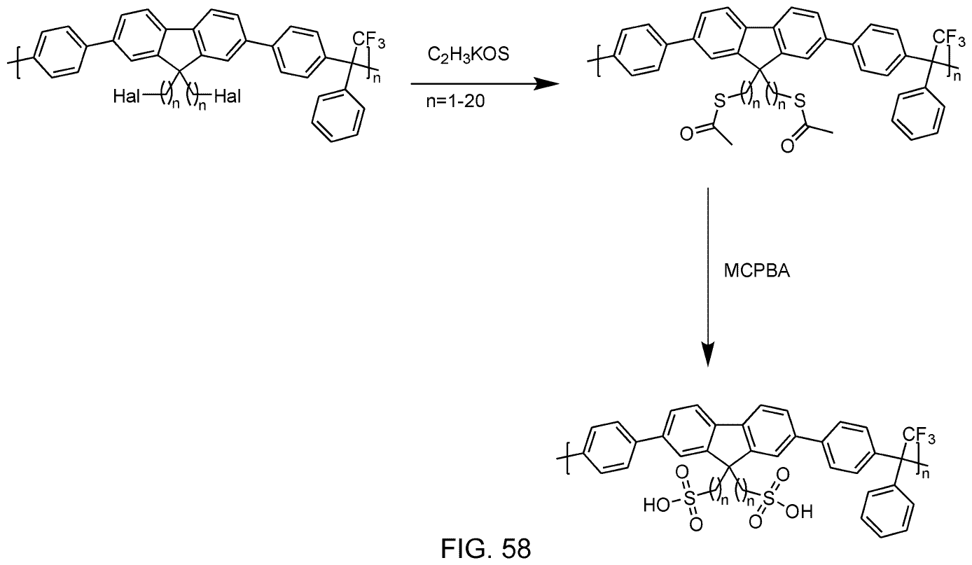

FIG. 58 a reaction scheme of a method according to the invention (39th embodiment);

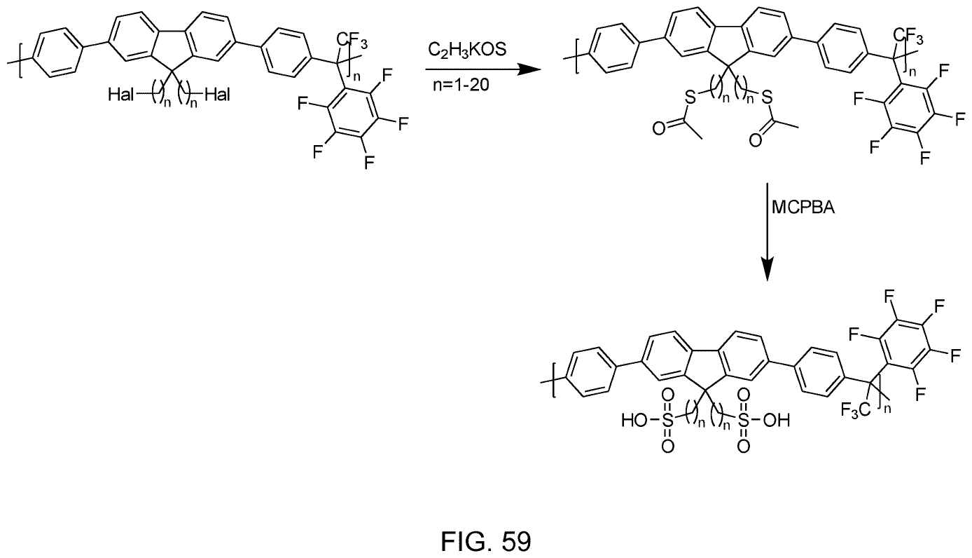

FIG. 59 a reaction scheme of a method according to the invention (40th embodiment);

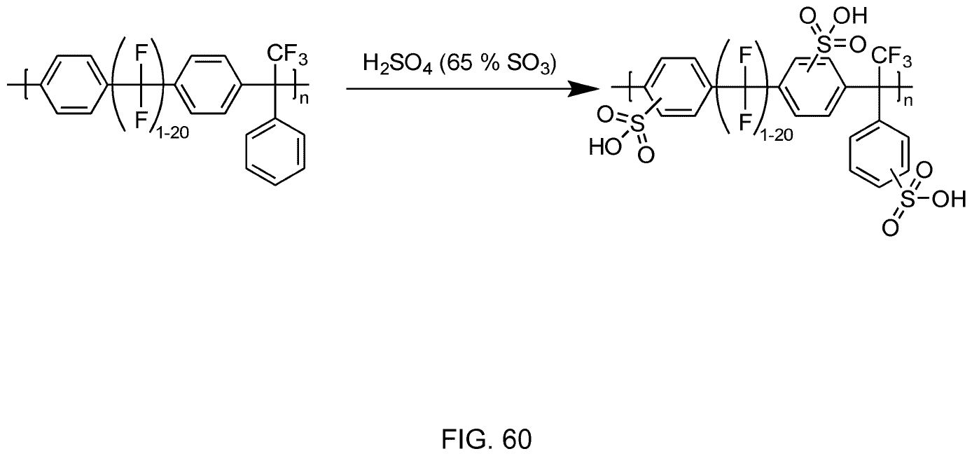

FIG. 60 a reaction scheme of a possible subsequent reaction of a method according to the invention (41st embodiment);

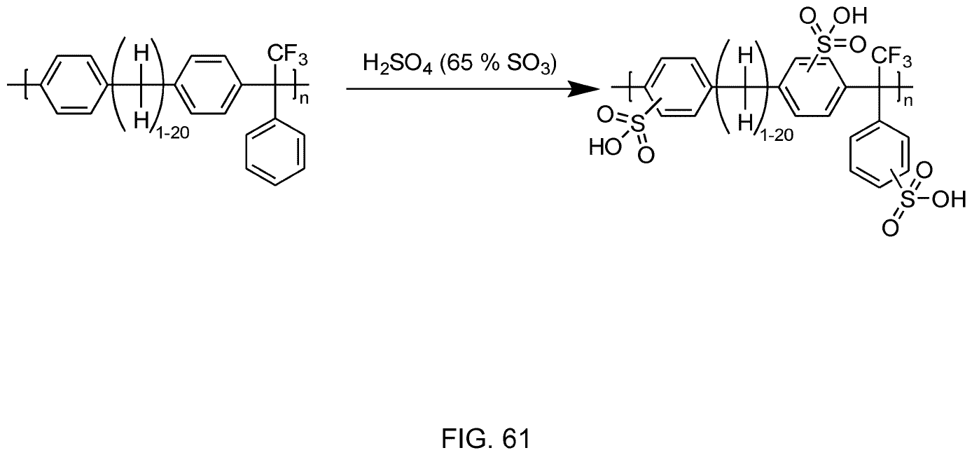

FIG. 61 a reaction scheme of a possible subsequent reaction of a method according to the invention (42nd embodiment);

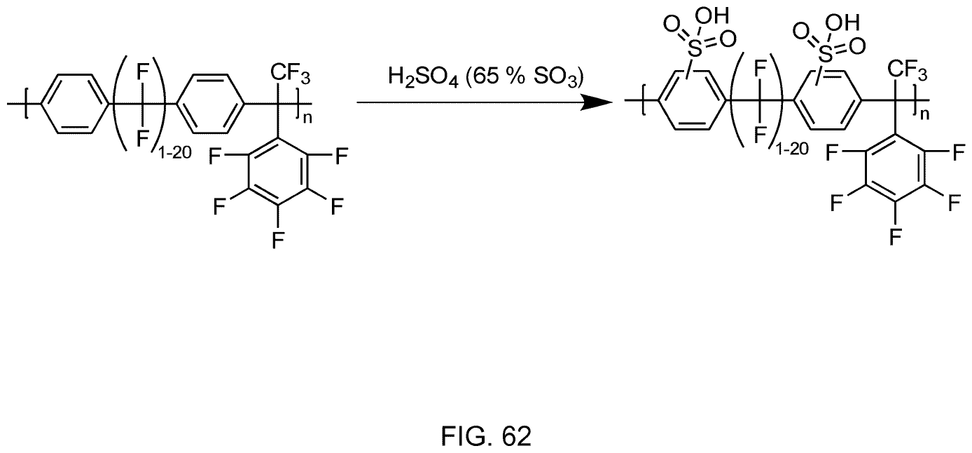

FIG. 62 a reaction scheme of a possible subsequent reaction of a method according to the invention (43rd embodiment);

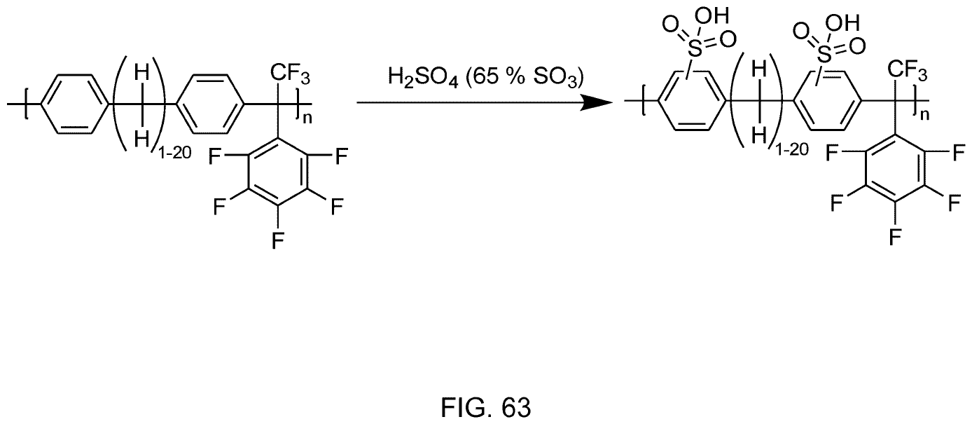

FIG. 63 a reaction scheme of a possible subsequent reaction of a method according to the invention (44th embodiment);

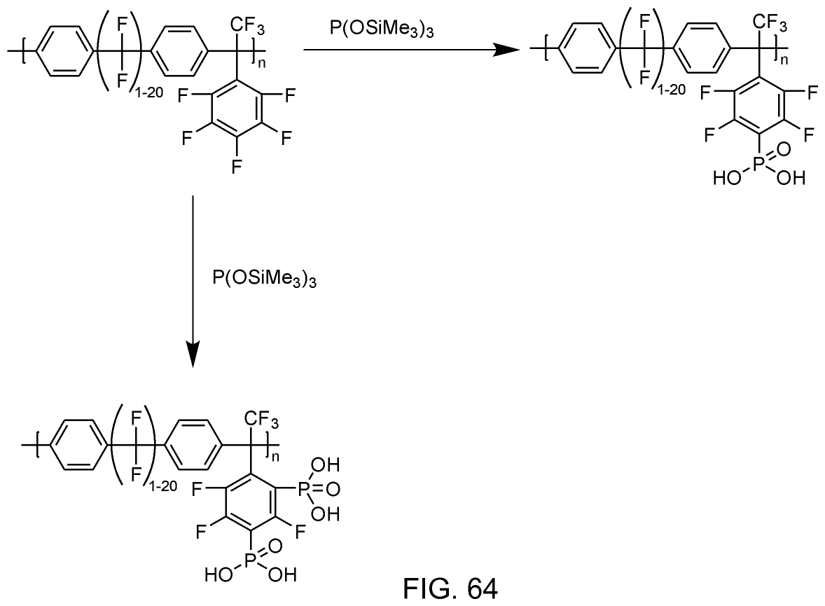

FIG. 64 a reaction scheme of possible subsequent reactions of a method according to the invention (45th embodiment);

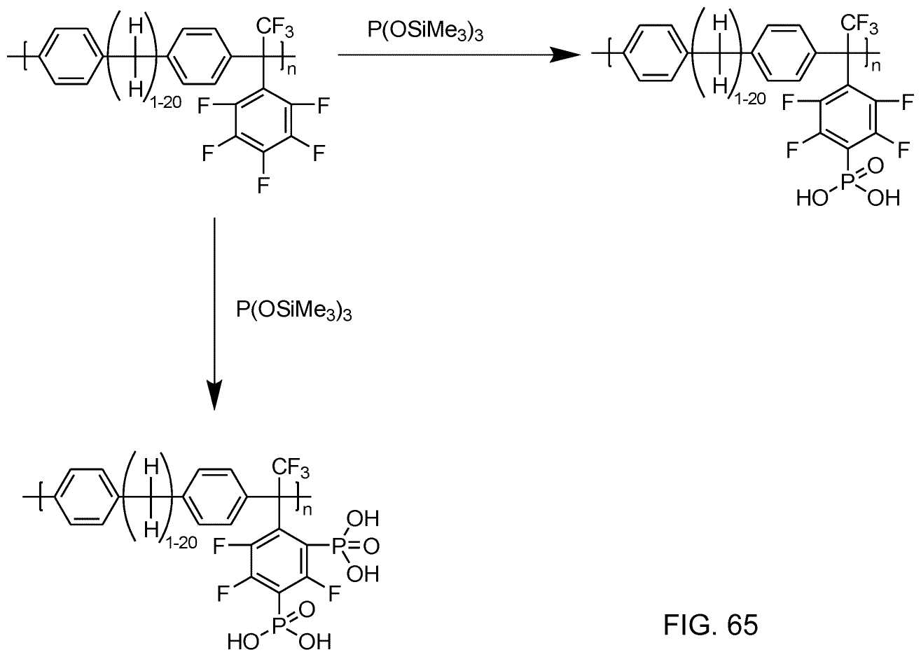

FIG. 65 a reaction scheme of possible subsequent reactions of a method according to the invention (46th embodiment);

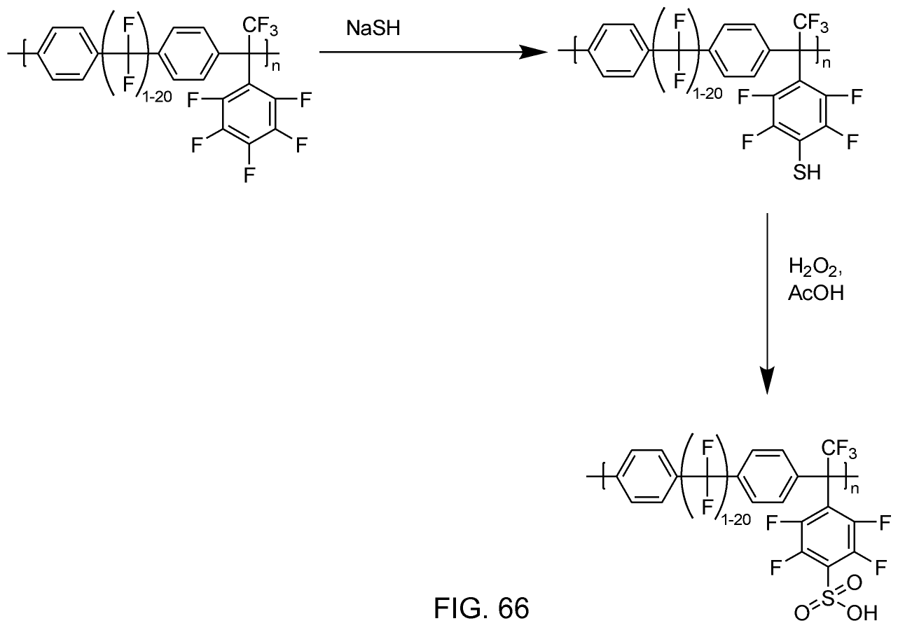

FIG. 66 a reaction scheme of possible subsequent reactions of a method according to the invention (47th embodiment);

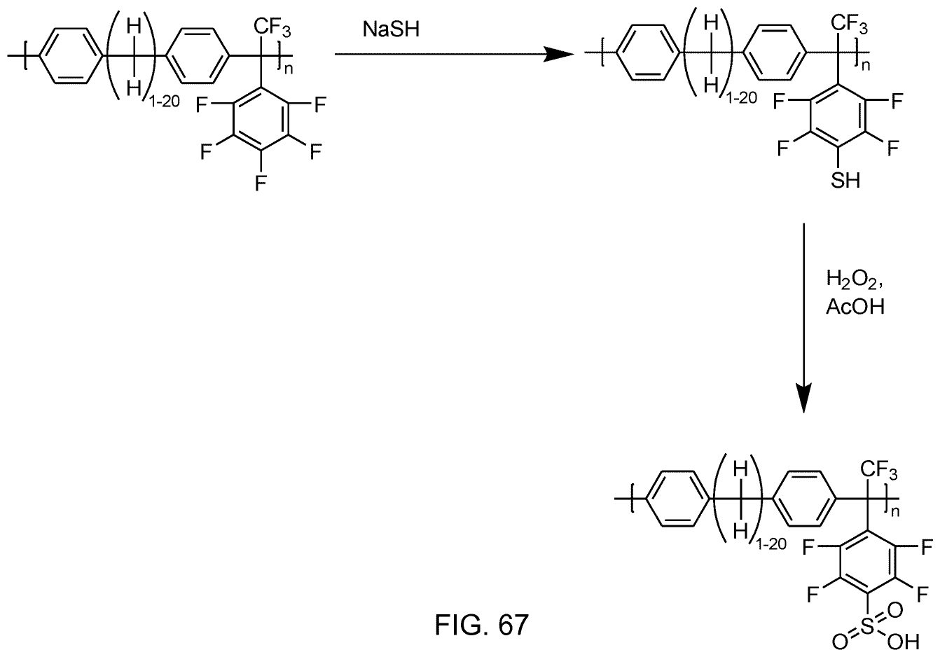

FIG. 67 a reaction scheme of a possible subsequent reaction of a method according to the invention (48th embodiment);

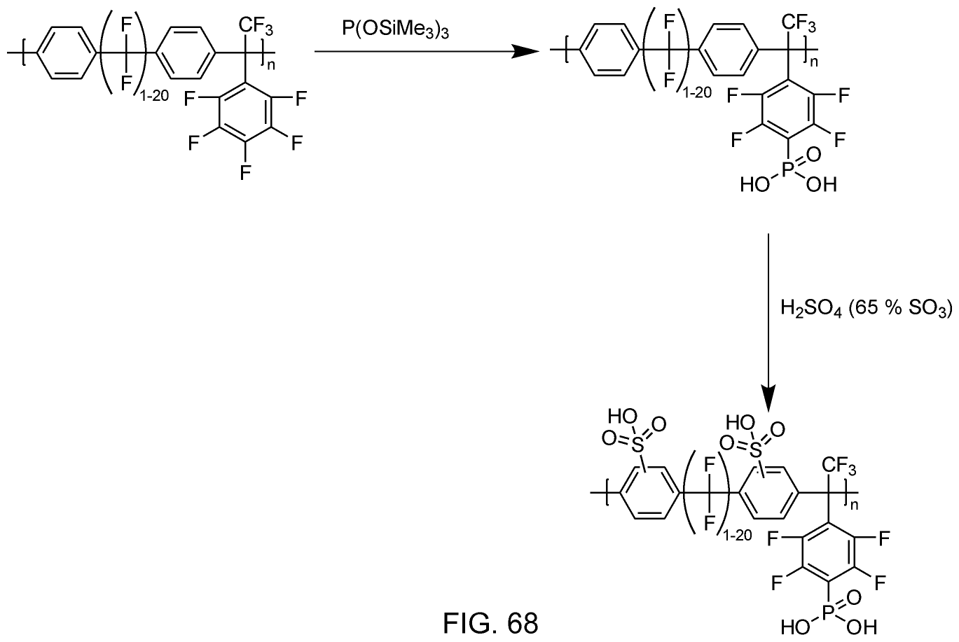

FIG. 68 a reaction scheme of a possible subsequent reaction of a method according to the invention (49th embodiment);

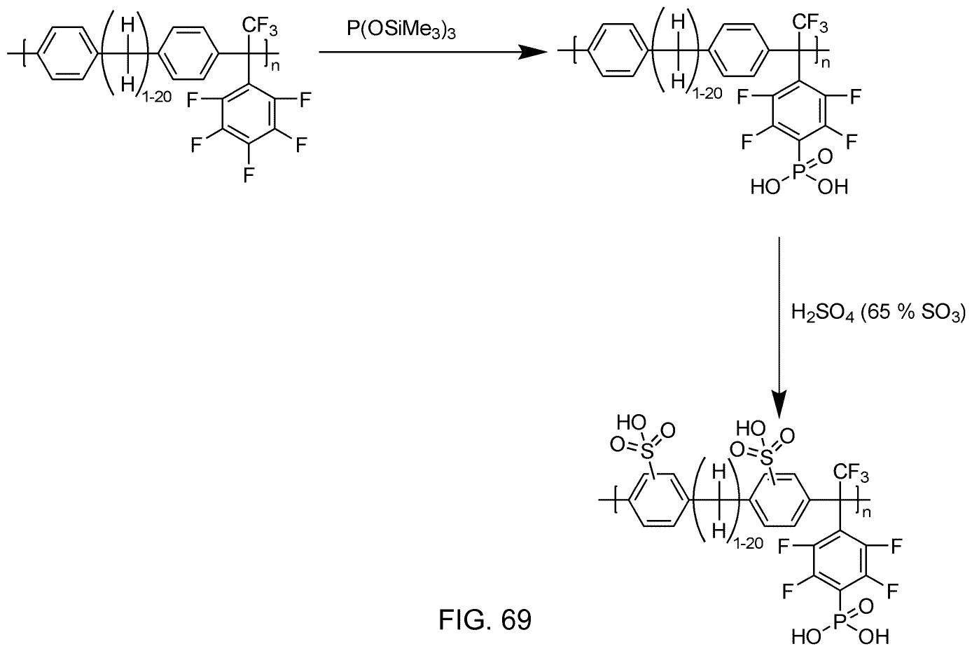

FIG. 69 a reaction scheme of possible subsequent reactions of a method according to the invention (50th embodiment);

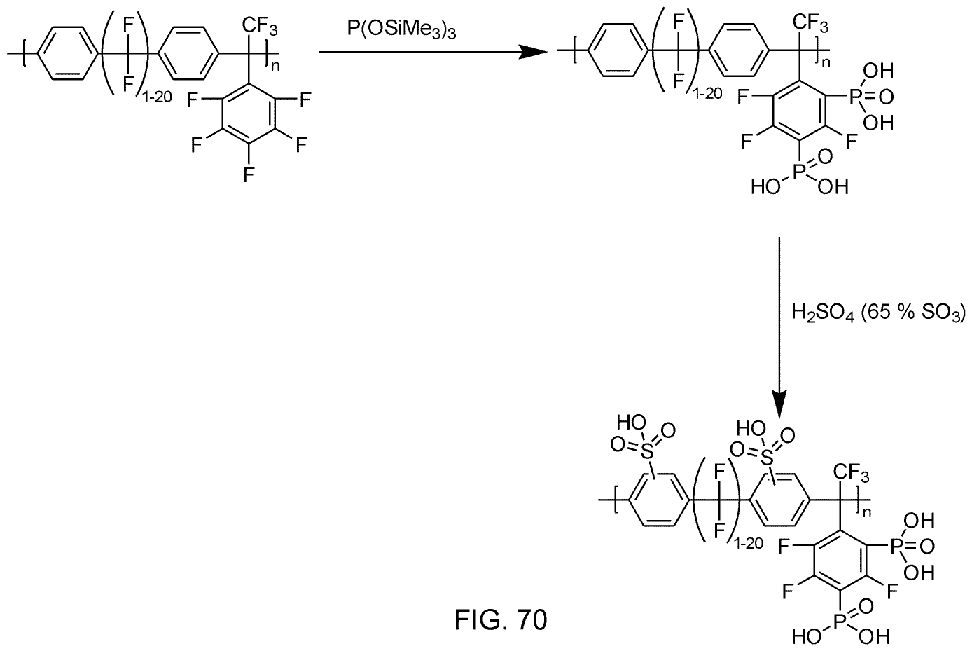

FIG. 70 a reaction scheme of possible subsequent reactions of a method according to the invention (51st embodiment);

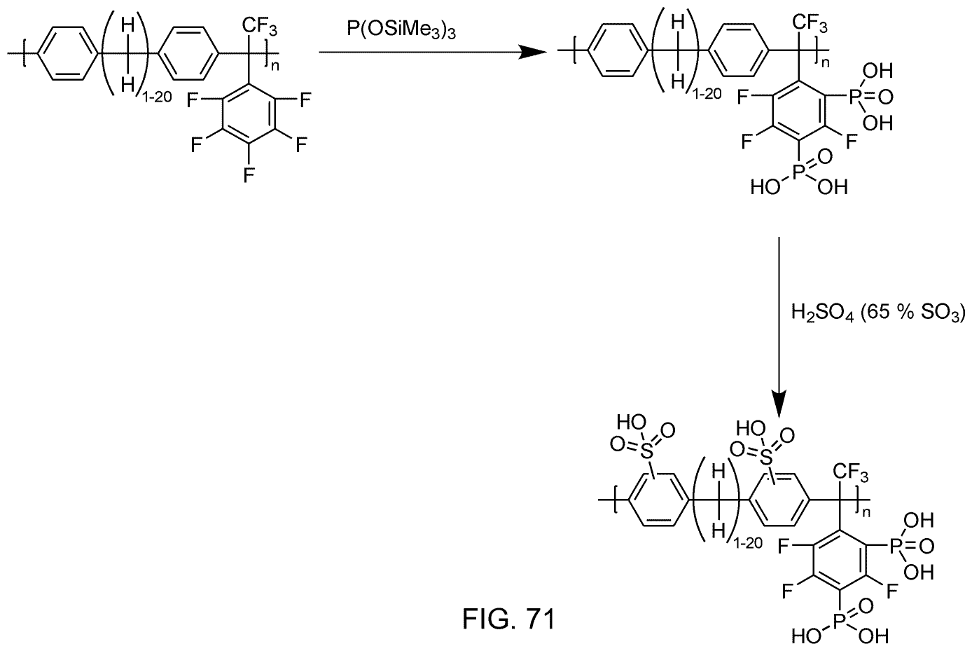

FIG. 71 a reaction scheme of possible subsequent reactions of a method according to the invention (52nd embodiment);

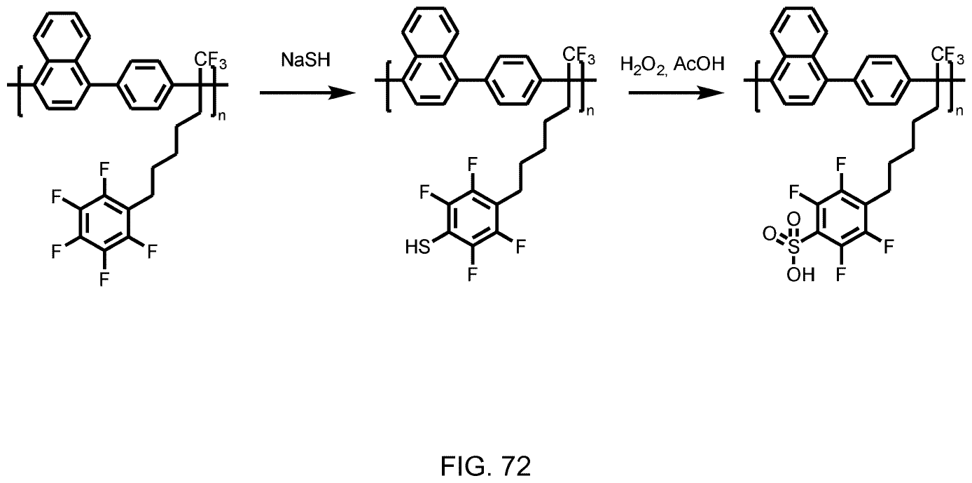

FIG. 72 a reaction scheme of possible subsequent reactions of a method according to the invention (53rd embodiment);

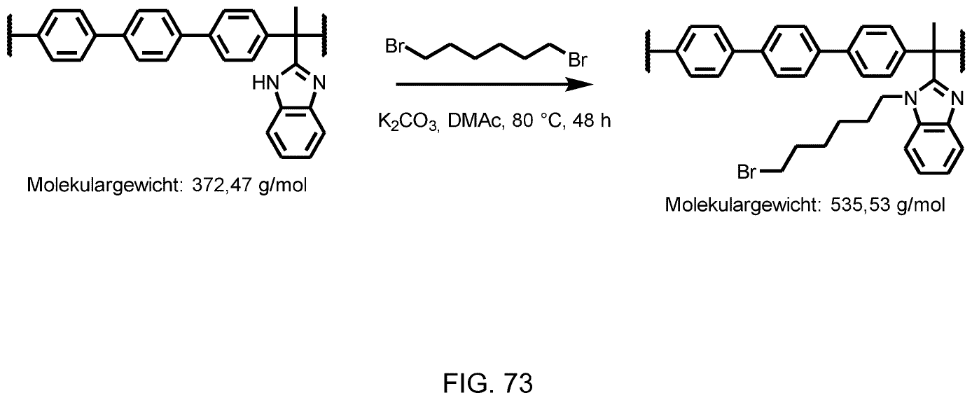

FIG. 73 a reaction scheme of a possible subsequent reaction of a method according to the invention (54th embodiment); and

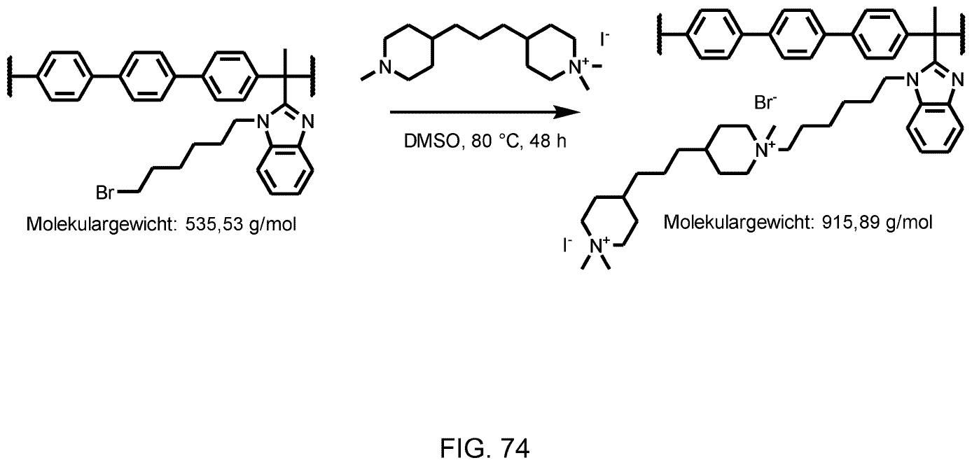

FIG. 74 a reaction scheme of a further subsequent reaction of the polymer shown in FIG. 73.

### EMBODIMENT 1

FIG. 1 shows a reaction scheme of an embodiment of a method according to the invention for producing a substance for a membrane. A starting material is used which contains 1-(4-methylpyridin-2-yl)ethan-1-one (first starting material) and an m-terphenyl (second starting material). A polymer is synthesized from this by polyhydroxyalkylation, which is then lithiated with n-butyllithium. In a further subsequent reaction, 4-vinyl-pyridine is anionically grafted.

### EMBODIMENT 2

FIG. 2 also shows a reaction scheme of methods according to the invention. A starting material is provided which contains m-terphenyl(first starting material) and perfluoroacetophenone (second starting material). In a first step, the polymer is synthesized by means of polyhydroxyalkylation. The resulting PHA polymer (polymer 2) is then sulfonated in a subsequent reaction to obtain polymer 3. Subsequently, a modification can optionally be carried out in a subsequent reaction with basic groups (polymer 3a, polymer 3b), whereby the basic groups can form ionic crosslinking sites with the sulfonic acid groups. This reduces the swelling and water absorption of a membrane made from such a polymer, so that the usage properties are improved, particularly in electrochemical applications such as fuel cells, PEM electrolysis or redox flow batteries. It is also conceivable to blend the sulfonated polymer 3 with a basic polymer, e.g. with polymers 3a, 3b or another basic polymer such as a polybenzimidazole, so that ionically crosslinked acid-base blend membranes are formed.

Following sulphonation, additional phosphonation can take place to improve the proton conductivity, particularly at temperatures above 100°. The improvement in proton conductivity results from the intrinsic proton conductivity of the phosphonic acid group (polymer 3c). Based on this, an alkyl side chain can be introduced by a nucleophilic substitution reaction (polymer 3ca), which reduces the brittleness of the resulting polymer.

As shown in FIG. 3, the sulfonated polymer 3 can also be covalently crosslinked by nucleophilically substituting the 4F atoms of the pentafluorophenyl residue of the polymer with an aromatic or aliphatic dithiol. This then results in the polymer 3d shown in FIG. 3.

### EMBODIMENT 3

An alternative method according to the present invention is shown in FIG. 4. In this method, a starting material is first modified in a preliminary reaction. Specifically, in a first step, commercially available 1-(4-mercaptophenyl)ethan-1-one (first starting material) is oxidized to 4-acetylbenzenesulfonic acid. In the next step, a polymer synthesis is then carried out by means of polyhxdroxyalkylation with m-terphenyl (second starting material) to form a sulfonated aromatic polymer 4.

### EMBODIMENT 4

FIG. 5 shows various methods for producing a substance for a membrane, which in particular comprise a Friedel-Crafts acylation and/or a Friedel-Crafts alkylation. Starting from polymer 5, which is shown in FIG. 5, a corresponding modification can take place (polymers 7 or 6). Starting from polymer 6, any desired nucleophilic aromatic substitution can then be carried out on the pentafluorophenyl radical (polymer 6a). Polymer 6a is a cation exchange polymer. Starting from polymer 7, a Friedel-Crafts acylation can take place in order to obtain an anion exchange polymer 7b.

### EMBODIMENT 5

FIG. 6 shows a reaction scheme of method s according to the invention, in which 1-(1H-benzo[d]imidazol-2-yl)ethan-1-one (first starting material) is first reacted with p-terphenyl (second starting material) in a PHA polymer synthesis to form the polymer 8. The N—H group can then be deprotonated using LiH and subsequently alkylated with methyl iodide to give the anion exchange polymer 8a. Alternatively, the polymer 8 can be sulfonated, for example with chlorosulfonic acid, to form the acid-base polymer 8b.

Doping with phosphoric acid (PA) or any phosphonic acid (PhnA) R(PO H)₃₂ₓ (R=any organic residue, where R is preferably an aromatic residue with electron-withdrawing groups/atoms such as F, NO, NO₂, SO₂ R etc., x=1-12) is also conceivable in order to be able to use the polymer in high-temperature membrane fuel cells. The PA-doped high-temperature membranes can be converted into a covalently cross-linked blend membrane by blending with poly(vinylbenzyl chloride)(PVBCI), in which the chloromethyl groups of the PVBCI react with the N—H of the imidazole function. Instead of PVBCI, a styrene polymer can also be used for the reactive blending (reaction of the CH₂ Hal groups with N—H) of the PHA polymer of 1-(1H-benzo[d]imidazol-2-yl)ethan-1-one and p-terphenyl, which carries the halomethyl group CH₂ Br or CH₂ Cl at the end of a side chain which is attached in the 4-position of the aromatic of the polystyrene (for example the polymer which can be produced from 1-(6-chlorohexyl)-4-vinylbenzene by radical polymerization). Alternatively, it is also possible to produce an acid-base blend membrane by blending with an acidic sulfonated or phosphonated polymer.

### EMBODIMENT 6

FIG. 7 shows a further embodiment of a method according to the invention for producing a substance for a membrane. In this method, an acetylpyridine (first starting material) is reacted with a biphenyl and/or terphenyl (second starting material), in this case 2,2,2-trifluoro-1-(pyridin-4-yl)ethan-1-one (first starting material), with a pyridine-containing oligophenyl (second starting material), in this case 2,6-diphenylpyridine, as part of a polyhydroxyalkylation to obtain a synthesized, basic PHA polymer (polymer 9). The polymer 9 can then be converted either completely or partially to the anion exchange polymer 9a. The ratio between pyridine groups and quaternized pyridinium groups can be adjusted so that the property profile is favourable for use in electrochemical membrane methods, for example in redox flow batteries. The quaternization of the polymer 9 to the anion exchange polymer 9a can be carried out either by reaction with Mel or dimethyl sulfate or by reaction with a dihaloalkane, for example 1,4-diiodobutane, 1,6-diiodohexane, 1-chloro-6-iodohexane, 1-bromo-6-iodohexane or the like. The reaction of both halogen atoms of the dihaloalkane simultaneously generates a covalent cross-linking of the resulting anion exchange polymer. If a mixed halogenoalkane is used, the reaction conditions can be selected so that only the more reactive halogen (reactivity series of halogenoalkanes for nucleophilic substitution I>Br>Cl>>F) reacts off by quaternization and the more reactive halogen is retained and can be used for further downstream nucleophilic substitution reactions, for example for the quaternization reaction with another tertiary N-basic compound.

It is conceivable that the anion exchange polymer 9a produced by alkylation of the polymer 9 can be blended with any basic polymer, for example with the polymer 8 from FIG. 6, in order to optimize the properties such as ion conductivity, water absorption and mechanical properties for the respective application of a membrane.

### EMBODIMENT 7

FIG. 8 shows a reaction scheme of a method according to the invention, by means of which a so-called ferrocene polymer is produced. In this way, novel anion exchange polymers can be synthesized (for the proof-of-principle of this novel type of polymer in the form of partially oxidized poly(vinylferrocene), see the following study: Xin Liu, Na Xie, Jiandang Xue, Mengyuan Li, Chenyang Zheng, Junfeng Zhang, Yanzhou Qin, Yan Yin, Dario R. Dekel, Michael D. Guiver, Nature Energy 2022, 7, 329-339, DOI: 10.1038/s41560-022-00978-y). According to the invention, cyclopentadienyl complexes such as ferrocene (bis(cyclopentadienyl) iron) in the form of a methyl ketone (acetylferrocene) of its aldehyde (ferrocenaldehyde)(first starting material) are reacted with an aryl (second starting material) in a polyhydroxyalkylation. In the polymer synthesized in this way, the ferrocene is then partially oxidized at the metal central atom to obtain a positively charged polymer with a mixed oxidized state. As the polymer is paramagnetic due to the iron, the polymer chains can be aligned with the aid of a magnetic field, creating directed, ion-conducting paths in the polymer. Compared to a ferrocene polymer in the form of a poly(vinylferrocene), the polyferrocene according to the invention, shown in FIG. 8, is chemically more stable in its polymer main chain, since it does not contain any tertiary C—H bonds that are vulnerable to radical attack.

FIG. 9 shows another reaction scheme that can be used to increase the content of ferrocene groups in a polymer. For this purpose, a monobrominated terphenyl monomer can first be substituted with ferrocene groups.

According to the reaction scheme in FIG. 9, the ferrocene-modified m-terphenyl is first synthesized with ferrocene ketone or aldehyde by polyhydroxyalkylation to form a polymer and then partially oxidized, as shown in FIG. 8, to produce a corresponding ferrocene anion exchange polymer.

### EMBODIMENT 8

### Poly (terphenyl-co-1-(1H-benzimidazol-2-yl)ethanone)(Polymer 8)

A terphenyl derivative such as para-terphenyl (second starting material) and an aromatic ketone such as 1-(1H-benzimidazol-2-yl)ethanone (first starting material) are suspended in a halogenated solvent such as dichloromethane, preferably with an excess of the ketone of between 1.00 and 2.00 equivalents and particularly preferably with an excess of between 1.15 and 1.40 equivalents. The trifluoromethanesulfonic acid is then added and the reaction mixture is stirred between 0° C. and 60° C. The trifluoromethanesulfonic acid is preferably used in a molar excess in relation to the ketone of 5-20 equivalents, with 8-13 equivalents being particularly preferred. After a preferred PHA reaction time of between 7 h and 72 h, the reaction is terminated by pouring the reaction mixture into water. FIG. 10 shows The 1H-NMRspectrum of the copolymer (8) prepared in this way with clear assignment of all resonance signals to the protons of the polymer. Depending on the reaction time and the molar excess of the ketone, gel permeation chromatography (GPC)(FIG. 11) shows molecular weights (Mₙ) between 20,000 g/mol and 300,000 g/mol and dispersities of 1.40 to 2.00 (FIG. 15), whereby 0.1 M LiCl DMSO and narrowly distributed PMMA standards were used as solvents for the GPC. Furthermore, the thermogravimetric analysis showed a high decomposition temperature of 480° C.

The conversion of the copolymer of para-terphenyl and 1-(1H-benzimidazol-2-yl)ethanone into an anion-conducting polymer is possible by methylation of the two nitrogens using suitable methylating agents such as methyl iodide, dimethyl sulphate or dimethyl carbonate. Methylation can be carried out by dissolving the polymer in DMSO and adding K₂ CO₃ or NaH to the resulting solution. An excess of the methylating agent is then added. After stirring for 16-30 h at 25° C.-130° C., (partial or complete)methylation of both nitrogens of the benzimidazole ring takes place. Different degrees of methylation are possible depending on the reaction temperature and reaction time.

In the example shown in FIG. 12, it was surprisingly found that a complete methylation of both nitrogen atoms to the imidazolium cation has taken place, which is characterized by the complete absence of the resonance signal of the N—H protons (12-15 ppm, top, FIG. 12), the shift of the aromatic signals to the low field and by a new signal belonging to the two introduced methyl groups. The integrals are in complete agreement with the expected protons. The complete methylation of both nitrogen atoms becomes clear when comparing The 1H-NMRspectrum of the methylated polymer (8a, top, FIG. 12)) with The 1H-NMRspectrum of the original polymer (bottom, FIG. 12). The conductivity of the fully methylated polymer in iodide form is 1.7 mS/cm, which further emphasizes the successful introduction of charged groups and demonstrates the polymer's applicability in principle as an anion exchange material. If the above reaction is carried out with meta-terphenyl instead of para-terphenyl and then methylation is also carried out as described above, the chloride conductivity increases to 5.7 mS/cm.

In addition to the direct alkylation of the benzimidazole unit to the positively charged imiadzolium, the introduction of the positively charged group is also possible by attaching a flexible side chain. Surprisingly, it was found that only one nitrogen can be selectively alkylated by reacting the copolymer of para-terphenyl and 1-(1H-benzimidazol-2-yl)ethanone with a 5- to 60-fold excess of 1,2-bis(chloroethoxy)ethane in the presence of a base (e.g. K₂ CO₃, NaH, etc.) at temperatures between 25° C. and 150° C. Furthermore, it was found that no crosslinking took place either, as the polymers were still soluble in polar-aprotic solvents such as N,N-dimethylacetamide or N,N-dimethylformamide or dimethyl sulfoxide. FIG. 13 shows the comparison of the¹ H NMR spectra of the starting polymer with the spectrum of the polymer 8b functionalized with a flexible ether group. The resonance signal of the NH group is no longer detectable, and the integrals of the introduced side chain match the expected number of protons. When calibrated to the methyl group of the polymer backbone, it can be seen that, surprisingly, quantitative functionalization has taken place (FIG. 13). Following the introduction of the side chain, the chlorine substituent can be reacted with a tertiary amine in a Menschutkin reaction to form an anion-conducting group. Analogous to functionalization with the flexible ether side chains described above, functionalization with other dihaloalkanes such as dibromohexane or diiodohexane with subsequent quaternization is possible. The separation of the anion exchanger group from the polymer backbone by a flexible chain has the advantage of phase separation, which leads to the formation of ionic channels and thus higher conductivities. FIG. 14 shows The 1H-NMRspectrum of polymer 8b, which was converted into an anion exchange polymer with trimethylamine. The successful quaternization can be recognized by the characteristic signal of the methyl groups of the introduced trimethylammonium group at 2.97 ppm.

### EMBODIMENT 9

### Poly (m-terphenyl-co-biphenyl-co-(4-acetylpyridine))(polymer 10)

A terphenyl derivative such as m-terphenyl and/or biphenyl (second starting material) and an aromatic ketone such as 4-acetylpyridine (first starting material) are suspended in a halogenated solvent such as dichloromethane, preferably with an excess of the ketone of between 1.00 and 2.00 equivalents and particularly preferably with an excess of between 1.10 and 1.40 equivalents of the ketone. The trifluoromethanesulfonic acid is then added and the reaction mixture is stirred between 0° C. and 60° C. The trifluoromethanesulfonic acid is preferably used in a molar excess in relation to the ketone of 5-20 equivalents, with 8-13 equivalents being particularly preferred. After a preferred reaction time (PHA) of between 7 h and 48 h, the reaction is terminated by pouring the reaction mixture into water. FIG. 15 shows the¹ H NMR spectrum of the copolymer produced in this way with clear assignment of all resonance signals to the protons of the polymer. Depending on the reaction time and the molar excess of ketone, gel permeation chromatography (GPC) shows molecular weights (Mₙ) between 10,000 g/mol and 300,000 g/mol and dispersities (Ð) of 1.40

To adjust the water uptake, a partial methylation of the pyridine units in the aforementioned copolymer can be carried out in a subsequent reaction by stirring the polymer dissolved in NMP with a methylating agent (e.g. methyl iodide) for 1 h-30h. The 1H-NMRspectrum shown in FIG. 16 represents such a polymer (polymer 10a) with a degree of methylation of 15%.

Membranes can be produced from the polymers described above using a doctor blade. For this purpose, solutions of the polymers are prepared in NMP, DMAc or DMSO with a mass fraction of the polymer between 1% and 30%. The conductivities, degrees of methylation and thicknesses of two membranes produced in this way are shown in the table below.

| Membrane/ | degree of | thickness | |
|---|---|---|---|
| Polymer | methylation (%) | (μm) | σ(mS*cm⁻¹) |
| 10 MTp-Bp-Pyr-0 | 0 | 35 | 17.4 ± 3.5 |
| 10a MTp-Bp Pyr-15 | 15 | 32 | 20.1 ± 0.1 |

The membranes described above can potentially be used in various electrochemical applications. An example of such an application is the vanadium redox flow battery. FIG. 17 shows the Coulomb efficiency (CE), the voltage efficiency (VE) and the energy efficiency (EE) as a function of the current density and over the course of 30 cycles at a current density of 80 mA*cm⁻² of a single-cell test with a membrane consisting of the polymer MTp-Bp Pyr-15.

### EMBODIMENT 10

### 5′-(6-bromohexyl)-1,1′: 3′,1″-terphenyl

The synthesis route to obtain the starting material or starting monomer is shown in FIG. 18. 12.56 g (39.8 mmol) of 5′-(6-bromohexyl)-1,1′: 3′, 1″-terphenyl is taken up in 50 mL of THF and cooled to −85° C. 16.72 mL (41.8 mmol) of a 2.5 M butyllithium solution in hexane is added and the solution is stirred for 3h. 24.1 mL (159.0 mmol) of 1,6-dibromohexane is slowly added to the reaction mixture using a dropping funnel. The temperature is raised to −20° C. and the reaction is stirred for 16 hours. The reaction is terminated by adding 5 mL of a 10 wt. % HCl solution. The reaction equation for this reaction is shown in FIG. 18. The organic and aqueous phases are separated for work-up. The aqueous phase is shaken out 3 times with 10 mL ethyl acetate. The organic phase is dried using magnesium sulfate. THF and ethyl acetate are distilled off under vacuum. The excess dibromohexane is distilled off under high vacuum at 110° C. The product mixture is purified using flash chromatography. FIG. 19 shows The 1H-NMRspectrum of the fraction used for the further reaction.

### EMBODIMENT 11

### 4-(7-[1,1′: 3′,1″-terphenyl]-5′-yl)heptyl)pyridine

The synthesis route to obtain the starting material or starting monomer is shown in FIG. 20. 22 mL of dry THF is placed in a 100 mL Schlenk flask and cooled to −78° C. 2.66 mL (18.9 mmol) of diisopropylamine are added. After approx. 5 min, 7.38 mL of a 2.5 M butyllithium solution in hexane (18.5 mmol) is added. After 30 min, 1.36 mL (13.8 mmol) of 4-methylpyridine is added and the solution is stirred for 1h. 3.63 g 5′-(6-bromohexyl)-1,1′: 3′, 1″-terphenyl (9.2 mmol) is dissolved in 15 mL dry THF and slowly added to the reaction mixture (15 min). The solution is stirred for 1 h at −78° C. and 4 h at RT and then terminated by adding 20 mL saturated ammonium chloride solution and 20 mL water. The organic and aqueous phases are separated for work-up. The aqueous phase is shaken out 3 times with 20 mL ethyl acetate. The organic phases are combined and washed twice with 20 ml of water and then dried using magnesium sulfate. THF and ethyl acetate are distilled off under vacuum and the product mixture is purified using flash chromatography (isolated yield: 74%). FIG. 21 shows The 1H-NMRspectrum of the product.

Both compounds shown above can be converted into polymers by means of the polyhydroxyalkylation described above. Initial preliminary tests on the polyhydroxyalkylation of this monomer with 4-acetylpyridine have yielded molecular masses of around 8,000 g/mol. By optimizing the reaction conditions (mass ratio between the pyridine-modified m-terphenyl and the acetylpyridine, reaction time and temperature), it can be assumed that the molecular mass of the polymers can be further increased.

FIG. 22 shows the PHA reaction of 4-(7-([1,1′: 3′, 1″-terphenyl]-5′-yl) heptyl)pyridine with 4-acetylpyridine. If the polymer 11 is partially or completely pyridine-alkylated, it can be used in alkaline applications (AEMWE or AEMFC) as well as in redox flow batteries.

### EMBODIMENT 12

### 4-methylpyridine coupling Poly-biphenyl-co-7-bromo-1,1,1-trifluoroheptan-2-one

The synthesis of poly-biphenyl-co-7-bromo-1,1,1-trifluoroheptan-2-one is shown in FIG. 23. 25 mL of dry THF is introduced into a 250 mL Schlenk flask and cooled to −78° C. 1.10 mL (7.8 mmol) diisopropylamine is added. After approx. 5 min, 3.09 mL of a 2.5 M butyllithium solution in hexane (7.74 mmol) is added. After 30 min, 0.51 mL (5.2 mmol) of 4-methylpyridine is added and the solution is stirred for 1 h. 0.50 g (1.3 mmol) of poly-biphenyl-co-7-bromo-1,1,1-trifluoroheptan-2-one is dissolved in 75 ml of dry THF and slowly added to the reaction mixture (15 min). The solution is stirred for 4 h at −78° C. and 20 min at RT and then terminated by addition of 2 mL methanol. The reaction equation for the synthesis of polymer 12 is shown in FIG. 23. For purification, the product mixture is concentrated to 20 mL under vacuum, precipitated in 200 ml methanol, filtered off, washed 3 times with fresh methanol and dried at 85° C. in a drying oven. FIG. 24 shows The 1H-NMRspectrum of the product.

Membranes can be produced from the polymer 12 described above using a doctor blade. For this purpose, solutions of the polymer in NMP, DMAc or DMSO with a mass fraction of the polymer between 1% and 30% and an optional addition of an organic acid, such as trifluoroacetic acid, are prepared. Such a membrane with a thickness of 32-35 μm showed a conductivity of σ=14 mS*cm.⁻¹

### EMBODIMENT 13

### Sulfonated poly-p-terphenyl-co-perfluoroacetophenone analogous to polymer 3

In a Schlenk flask, 1.0 equivalents of terphenyl and 1.0 to 2.0 equivalents (preferably 1.1 to 1.4 equivalents) of ketone are introduced into 9-13 equivalents of dichloromethane. At 0° C., 9-13 equivalents of tri-fluoromethanesulfonic acid are added to the mixture. The resulting mixture is warmed to room temperature and stirred for 48 to 96 h at RT. The polymer is precipitated in methanol and reprecipitated from THF into methanol.

The corresponding¹ H-NMR spectrum is shown in FIG. 25 and the¹⁹ F-NMR spectrum of the resulting polymer (analogous to polymer 2) is shown in FIG. 26.

The polymer 2 prepared as described above is suspended in a sulphonating agent (e.g. sulphuric acid, chlorosulphonic acid, oleum 20%, oleum 65% etc.). The mixture is stirred at room temperature for 5 to 96 hours. The resulting highly viscous polymer solution is precipitated in ice water. The resulting polymer 3 is filtered off and washed with water. Depending on the sulfonating agent, a degree of sulfonation of between 2 and 3 sulfonic acid groups per repeat unit is achieved.

The polymers obtained were characterized using NMR spectroscopy. The successful substitution can be confirmed by the deep field shift of the protons on the substituted aromatic rings. In comparison to the initial polymer (see FIG. 27), the NMR spectra show that a mixture of different degrees of sulfonation is present in relation to a single repeating unit.

Therefore, an average degree of sulphonation is determined by means of elemental analysis, the results of which are shown in the table below.

TABLE 3
Composition of two sulphonation
products determined by means of elemental analysis.

| Membrane/ | | | | degree of |
|---|---|---|---|---|
| Polymer | C in % | H in % | S in % | sulphonation |
| 3a PTp-PF-Sulf 1 | 36.12 | 3.77 | 7.94 | 1.8 |
| 3b PTp-PF-Sulf 2 | 37.30 | 2.55 | 10.30 | 2.1 |

Membranes can be produced from the polymers described above using a doctor blade. For this purpose, solutions of the polymers are prepared in NMP, DMAc or DMSO with a mass fraction of the polymer between 1% and 30%. The conductivities and thicknesses of three membranes produced in this way are shown in the table below.

TABLE 4
Conductivities of membranes made of copolymers and
sulfonated-P-terphenyl and perfluoroacetophenone

| [symbol] /Polymer | [symbol] (μm) | [symbol] (mS*cm⁻¹) |
|---|---|---|
| 3a PTp-PF-Sulf 1 | 31 | 12.60 ± 1.10 |
| 3b PTp-PF-Sulf 2 | 25 | 22.30 ± 2.81 |
| 3c PTp-PF-Sulf 3 | 30 | 62.52 ± 10.79 |

[symbol]

indicates data missing or illegible when filed

The membranes described above can potentially be used in various electrochemical applications such as fuel cells and electrolysis. Initial preliminary tests have shown that the sulfonated polymer is suitable in principle for use in fuel cells.

### EMBODIMENT 14

Ionically cross-linked cation exchanger acid-base blend membrane 11 made from a sulfonated terphenyl polymer of perfluoroacetophenone and terphenyl:

In the first step, a PHA polymer is prepared by reacting perfluoroacetophenone (second starting material) with p-terphenyl(first starting material), see FIG. 2. If the sulfonation of this polymer is carried out with the strong sulfonating agent oleum (H₂ SO₄ with 60-65 wt % dissolved SO₃), all 3 aromatic compounds of the repeating unit of the polymer can be sulfonated. A polymer with an ion exchange capacity of 4.19 meq SO₃ H/g polymer is obtained. In the second step, a polymer of p-terphenyl with 1-(1H-benzo[d]imidazol-2-yl)ethan-1-one (see FIG. 6) is synthesized. The structures of both polymers are shown in FIG. 28 together with their molecular formulae and the molecular masses of their repeating units.

Dissolve 2 g of the sulphonated terphenyl polymer in 18 g dimethyl sulphoxide (DMSO). After dissolution, the sulfonated polymer is neutralized with 0.682 ml n-propylamine. Furthermore, a 10% by weight solution of the benzimidazole terphenyl polymer is prepared in DMSO and 12.8 g of this is added to the DMSO solution of the sulfonated terphenyl polymer. Stir until homogenized and then draw a membrane on a glass plate using the foil drawing apparatus. The glass plate with the drawn membrane is then placed in a convection oven and the solvent is evaporated at a temperature of 140° C. for a period of 2 hours. The glass plate is then removed and placed in a water bath, whereupon the membrane detaches from the glass plate. The membrane is treated as follows:
48 hours at 90° C. in 10% HCl
48 hours at 60° C. in demineralized water

The membrane can then be characterized. Its ion exchange capacity (IEC) is 1.5 meq SO₃ H/g membrane. The polymer can then be covalently crosslinked (see FIG. 3) by immersing a membrane of the polymer in the sulfonic acid salt form (SO₃ R with R=any ammonium group N (R) 24+ (R₂═H, alkyl) or alkali metal cation such as Li⁺, Na⁺, K⁺, Rb⁺, Cs⁺) in an ethanolic solution (e.g. 10% by weight) of an alkanedithiol (example: hexane-1,6-dithiol) or a dithiophenol (example: [1,1′-biphenyl]-4,4′-dithiol) that has been neutralized with equimolar amounts of a base, for example n-propylamine, for 24 hours at 90° C., for example. The membrane is then rinsed with ethanol until no more free dithiophenols or alkanedithiols are present in the membrane. The membrane is then placed in 10% HCl at 90° C. for 48 hours and then in deionized water at 60° C. for 48 hours to re-establish the acidic form of the membrane. The advantage of this cross-linking is that no sulphonic acid groups have to be “sacrificed” for the cross-linking.

### EMBODIMENT 15

Multiple-Phosphonated Poly-p-Terphenyl-Co Perfluoroacetophenone from the Analogous of Polymer 2:

The polymer prepared by PHA in embodiment 13 is heated with 5 to 25 equivalents (preferably 10 to 15 equivalents) of tris (trimethylsilyl)phosphite at temperatures between 170° C. and 200° C. for 6 to 18 hours. The resulting mixture is diluted with THF and the polymer is precipitated in heptane. The resulting polymer is heated to reflux in water and then stirred in warm 1 M hydrochloric acid. Surprisingly, the¹⁹ F-NMR shows a substitution of the fluorine atoms on the pentafluorophenyl ring in the para position and one of the two ortho positions (FIG. 29), so that two phosphonic acid groups could be introduced, which has not yet been observed for any phosphonation on polymers containing the pentafluorophenyl group.

The substances produced in this way can be used either as pure membranes or as blend membranes, for example with a basic polymer as a blend component. A covalent crosslinking of membranes made from this phosphonated polymer with alkanedithiols or aromatic dithiophenols is also possible, see also FIG. 3.

### EMBODIMENT 16

FIG. 30 first shows the synthesis of a polymer by means of polyhydroxyalkylation. A first starting material, in the present case a phenyl derivative, in particular m-terphenyl or p-terphenyl, and/or a biphenyl, is provided and an aromatic trifluoroketone, in particular 1,1,1-trifluoro-3-(pyridin) 4-yl propan-2-one, is provided as a second starting material.

The phenyl derivative such as m-terphenyl, p-terphenyl and/or biphenyl and an aromatic trifluoroketone such as 1,1,1-trifluoro-3-(pyridin-4-yl) propan-2-one are suspended in a halogenated solvent such as dichloroethane, preferably with an excess of the ketone of between 1.00 and 2.00 equivalents and particularly preferably with an excess of between 1.10 and 1.40 equivalents of the ketone. The trifluoromethanesulfonic acid is then added and the reaction mixture is stirred between 0° C. and 80° C. The trifluoromethanesulfonic acid is preferably used in a molar excess in relation to the ketone of 5-20 equivalents, with 8-13 equivalents being particularly preferred. After a preferred reaction time of between 168 h and 504 h, the reaction is terminated by pouring the reaction mixture into water. FIG. 31 shows the¹ H NMR spectrum of the polymer produced in this way. Depending on the reaction time and the molar excess of the ketone, gel permeation chromatography (GPC) shows molecular weights (Mₙ) between 10,000 g/mol and 300,000 g/mol and dispersities (Ð) of 1.40-2.00. An exemplary molar mass distribution is shown in FIG. 32.

### EMBODIMENT 17

FIG. 33 shows reaction schemes for the production of blend membranes from a sulfonated PHA polymer and a PHA polymer with haloalkyl side chains. In principle, both polymers can be produced by the method according to the invention. The two polymers can be mixed in practically any ratio between 95:5 and 5:95. In this way, cation exchanger-anion exchanger-acid-base blend membranes can be produced. The blend membranes can be treated with a tertiary amine such as tetramethylimidazole.

Specifically, the terphenyl-PHA polymer is first sulphonated with oleum. After sulfonation, it is converted to the sodium form by neutralization with NaOH. The neutralized polymer is dried and dissolved in a dipolar-aprotic solvent such as DMSO or DMAc to form a 5 to 20% solution. The biphenyl-bromine side-chain PHA polymer is then also dissolved in DMSO or similar to form a 5 to 20% solution. The two polymer solutions are then mixed in the desired ratio and homogenized. Tetramethylimidazole (TMIm) is now added to the homogenized polymer solution in a 5 mol % excess with respect to the bromine content of the biphenyl polymer. Surprisingly, it was found that the TMIm reacts with the bromoalkyl groups at room temperature only within a period of several hours, so that the membrane can be prepared without the risk of cross-linking during the mixing method of the two polymer solutions. The TMIm is allowed to dissolve and the polymer solution is then drawn onto a support such as a glass plate using a squeegee. The solvent is then evaporated in a convection or vacuum drying oven at temperatures of 90 to 140° C. During this time, the quaternization reaction takes place. The membrane is then removed from the support under water and treated with a 5 to 20% aqueous mineral acid at elevated temperatures in order to carry out the ion exchange and generate the acid-base cross-linking between the sulphonate and tetramethylimidazolium ions. The membrane must then be rinsed with deionized water until the excess mineral acid is removed from the membrane. With an imidazole that is even more sterically hindered than TMIm, such as 1-butyl-2-mesityl-4,5-dimethyl-1H-imidazole, the quaternization reaction takes place even more slowly. If more reactive amines such as quinuclidine, trimethylamine, N-methylpiperidine or similar are used instead of TMIm. which already react at room temperature with the bromine atoms of the side chain under quaternization, the blend membrane must be prepared by the following procedure: 1) mixing the acidic terphenyl-PHA polymer (can be in the SO₃ H or in the sulfonate salt form) and the bromoalkyl-biphenyl-PHA polymer as a solution in a dipolar-aprotic solvent (DMSO preferred, as it is N-free); 2) evaporating the solvent; 3) Placing the membrane in the desired tertiary amine (if liquid) or in an ethanolic solution of the tertiary amine (if solid), if necessary at elevated temperature to accelerate the quaternization reaction; 4) rinsing the membrane with deionized water until all excess amine and ethanol is removed from the membrane; 5) post-treating the membrane with a 5 to 20% aqueous mineral acid at elevated temperatures to perform the ion exchange and generate the acid-base cross-linking between the sulfonate and the tetramethylimidazolium ions; 6) rinsing the membrane with deionized water until the excess mineral acid is removed from the membrane.

In this embodiment, the sulfonated PHA polymer shown here can be replaced by any other sulfonated PHA polymers according to the invention. The same applies to the halomethylated blend component.

### EMBODIMENT 18

FIG. 34 shows a reaction scheme for the preparation of blend membranes from a benzimidazole-PHA polymer and a polymer with bromoalkyl side chains. In other words, the synthesized polymer prepared according to the method of the invention may be a benzimidazole polymer. The further polymer may be a PHA polymer, i.e. synthesized by polyhydroxyalkylation. In the embodiment example of FIG. 34, a covalently crosslinked anion exchange polymer blend is formed by the alkylation of the imidazole units of the benzimidazole PHA polymer.

Specifically, both polymers are mixed in a dipolar-aprotic solvent (preferably DMSO, as it is N-free) in the desired mixing ratio. The solvent is then evaporated at elevated temperatures in a circulating air or vacuum drying oven. The resulting membrane is then removed under deionized water. If necessary, the membrane can be post-treated with any tertiary amine in order to quaternize any bromoalkyl groups still present in the membrane by placing the membrane in the amine (if liquid) or in an ethanolic solution of the amine (if solid). A sterically hindered amine such as quinuclidine or N-methylpiperidine, or a sterically hindered diamine such as DABCO, is preferred here. The membrane is then rinsed with deionized water until all residual solvent and residual amines still present in the membrane have been removed. The membrane can then be brought into the OH form by immersion in KOH, followed by washing with deionized water that has previously been boiled in nitrogen. The membrane must then be stored under inert gas so that it does not attract CO₂ from the air.

Covalently crosslinked anion-exchange blend membranes of this type can also be produced by reacting other imidazole group-containing PHA polymers with other bromine side-chain PHA polymers of the invention, for example by reacting poly(2-(1-([1,1′-biphenyl]-4-yl)ethyl)-4,5-dimethyl-1H-imidazole) with poly(4-(8-bromooctan-2-yl)-1,1′-biphenyl). These two polymers are shown in FIG. 35.

### EMBODIMENT 19

FIG. 36 shows a reaction scheme for preparing a polymer blend from a phosphonated terphenyl polymer, which was synthesized from p-terphenyl and perfluoroacetophenone, and a halomethylated polymer (e.g. polyvinylbenzyl chloride) or the polymer of FIG. 23. Subsequently, a quaternization of the polymer blend with a tertiary amine, e.g. triethylamine, quinuclidine, tetrametylimidazole or the like takes place, whereby an acid-base blend membrane is formed from the phosphonated polymer and the resulting anion exchange polymer.

Specifically, both polymers are mixed in a dipolar-aprotic solvent (preferably DMSO, as it is N-free) in the desired mixing ratio, whereby an excess of the phosphonated blend component is preferred. The solvent is then evaporated at elevated temperatures in a circulating air or vacuum drying oven. The resulting membrane is then removed under deionized water. The membrane is then placed in quinuclidine (quinuclidine) or an alcoholic solution of quinuclidine, if necessary at an elevated temperature, in order to achieve quaternization of the quinuclidine. The membrane is then washed in deionized water until all residues of excess quinuclidine or solvent are washed out of the membrane.

Instead of the phosphonated PHA polymer according to the invention, a sulfonated PHA polymer according to the invention can also be selected as the acidic blend component. The same applies to the halomethylated PHA polymer and to the choice of tertiary N-base, where any tertiary N-base can be used for quaternization or mixtures of tertiary monoamines and diamines, whereby additional covalent crosslinking sites can be generated in the anion exchange diaphragm by using a diamine.

### EMBODIMENT 20

FIG. 37 shows a further example of a subsequent reaction by which an acid-acid blend membrane is produced from a sulfonated partially fluorinated PHA polymer and a phosphonated partially fluorinated PHA polymer. In addition, covalent crosslinking takes place by nucleophilic aromatic substitution of fluorine atoms by an alkanedithiol, which limits water uptake.

Specifically, both polymers are mixed in a dipolar-aprotic solvent (preferably DMSO, as it is N-free) in the desired mixing ratio. The solvent is evaporated. The membrane is then placed in an ethanolic solution containing 1-10% octanedithiol and 2 times the molar amount of DBU relative to the molar proportion of dithiol in order to completely deprotonate the thiol groups and thus increase the nucleophilicity of the thiol. Alternatively, the membrane can also be placed in the pure dithiol, which has been completely neutralized with DBU. Allow the dithiol to act on the membrane for 15-60 minutes. The reaction can be seen by a discoloration of the membrane. The membrane is then removed from the dithiol bath and rinsed with deionized water until all dithiol and DBU residues have been removed from the membrane. It is then placed in a 5-20% aqueous solution of a mineral acid (e.g. HCl, H₂ SO₄, HNO₃ or similar) to regenerate the acid form of the membrane.

Of course, dithiols of other chain lengths can also be used as covalent crosslinkers, whereby HS-(CH)₂ₓ-SH x can assume values between 2 and 20. Another base can also be used instead of DBU, e.g. triethylamine or trimethylamine, which are easier to wash out of the membrane than DBU due to their smaller molecular mass.

### EMBODIMENT 21

FIG. 38 shows a possible subsequent reaction of a method according to the invention. Here, sulphonation of the basic polymer 12 of FIG. 23 with oleum takes place. In this way, an acid-base polymer is produced in which an additional ionic crosslinking between acidic and basic groups is created. In this way, a limitation of water absorption or swelling can be achieved.

Specifically, the biphenyl-pyridine-PHA polymer is suspended in oleum (sulphuric acid with 60% dissolved free SO₃) and allowed to sulphonate for 24-48 hours at room temperature. The polymer is then carefully precipitated by carefully dropping it over crushed ice, if necessary by cooling in a cold bath. After all the polymer has dripped in, the strongly acidic solution is neutralized to pH 7 by adding 10% aqueous NaOH solution drop by drop and cooling in a cold bath. The water is removed from the solution by rotating it off. The dried polymer is then dissolved in a dipolar-aprotic solvent (preferably DMSO, sulfolane or diphenylsulfone, as it is N-free) to form a 5 to 20% solution. The polymer solution is squeegeed onto a support, for example a glass plate, and the solvent is removed in a vacuum or convection oven at an elevated temperature. The membrane is then removed from the support and placed in the diluted solution of a mineral acid in deionized water in order to protonate the membrane and create the ionic cross-linking sites. The membrane is then washed in deionized water to remove excess acid.

In principle, another basic polymer synthesized by polyhydroxyalkylation can also be used, for example the polymer shown in FIG. 39.

### EMBODIMENT 22

FIG. 40 shows a possible subsequent reaction of the disphosphonated polymer of FIG. 29 with an aminothiol. Specifically, this can be 3-(dimethylamino) propan-1-thiol. In this way, an acid-base polymer can be produced which is characterized by low swelling/water absorption due to the corresponding ionic crosslinking sites.

Specifically, the diphosphonated polymer is dissolved in a dipolar-aprotic solvent (preferably DMSO, as it is N-free). In the second step, a membrane is doctored from the polymer solution. The solvent is evaporated at elevated temperature. The membrane is then placed in a 10% solution of 3-(dimethylamino)-propane-1-thiol in ethanol. The same molar amount of the base DBU is added to the solution. The membrane is left in this solution for 15 min to 4 hours at room temperature. If the color of the membrane does not change any further, the reaction is complete and the membrane is removed from the solution. Rinse the residual reagents from the membrane by rinsing it with deionized water, if necessary at an elevated temperature of up to 90° C. The membrane is then placed in the aqueous solution of a mineral acid such as HCl, H₂ SO₄ or HNO₃ to generate the acid-base cross-linking sites and bring the membrane into the acid form. The membrane is then rinsed again with deionized water until all excess acid has been washed out of it.

Instead of the diphosphonated PHA polymer of p-terphenyl and perfluoroacetophenone, a disulfonated PHA polymer can also be reacted with the aminothiol, see FIG. 41.

The disulfonated polymer shown in FIG. 41 can be synthesized by reacting the unmodified PHA polymer of p-terphenyl with NaSH in a dipolar-aprotic solvent such as DMSO or DMAc and subsequent oxidation with H O₂₂ in acetic acid/sulfuric acid or trifluoroacetic acid.

### EMBODIMENT 23

FIG. 42 shows a reaction scheme for synthesizing a polymer from two starting materials, specifically from 1-phenylnaphthalene (first starting material) and 7-bromo-1,1,1-trifluoroheptanone (second starting material) by means of polyhydroxyalkylation. In other words, FIG. 42 shows the method step of synthesizing a polymer from the starting materials by means of polyhydroxyalkylation.

Surprisingly, it is possible to carry out the polymerization described above and obtain soluble polymers with a sufficiently high molar mass. For this purpose, the monomers 1-phenylnaphthalene- and 7-bromo-1,1,1-trifluoroheptan-2-one are -dissolved in DCM in a ratio of 1/1.02 and then mixed with an elevenfold excess of trifluoromethanesulfonic acid at 0° C. and stirred for 16 hours. After the polymer was precipitated from THF in methanol, the polymer can be used for further reactions (as shown below).

### EMBODIMENT 24

FIG. 43 shows a possible subsequent reaction of the synthesized polymer shown in FIG. 42. Specifically, sulfonation takes place by means of electrophilic aromatic substitution.

The starting polymer shown in FIG. 43 can surprisingly be sulphonated by means of electrophilic aromatic substitution by suspending/dissolving the starting material in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 25

FIG. 44 shows an alternative subsequent reaction on the synthesized polymer of FIG. 42, which involves sulfonation by means of nucleophilic substitutions.

According to FIG. 44, the terminal bromine atom is replaced by a thioacetate group by means of a nuclophilic substitution reaction, which is converted into a sulfonic acid by oxidation in a subsequent step.

To prepare the target structure, 1 equivalent of the starting polymer is added and dissolved in dimethylacetamide. To the solution, 1.12 equivalents of potassium thioacetate per equivalent of halogen are added and stirred at an elevated temperature between 4° and 100° C. for 16 to 24 hours. The polymer is then precipitated from the cooled solution in methanol, filtered off and dried.

The resulting polymer is then redissolved in dimethylacetamide and the solution is cooled to 0° C. Subsequently, 6 equivalents of meta-chloroperbenzoic acid (MCPBA) are added in portions over 10 min. The mixture is then stirred further at room temperature. The polymer is then precipitated in 1 M saline solution, washed with water and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 26

FIG. 45 shows a reaction scheme for increasing the degree of sulfonation of the polymer sulfonated according to embodiment example 25 (FIG. 44). Specifically, this is done by means of electrophilic aromatic substitution.

In the embodiment shown, the ionically conductive polymer shown in FIG. 44 is further sulfonated by means of electrophilic aromatic substitution in accordance with the invention in order to increase the ion exchange capacity and consequently the conductivity.

For this purpose, the starting material shown in FIG. 45 is suspended/dissolved in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 27

FIG. 46 shows a possible subsequent reaction. This is a simple phosphonation of a copolymer of 1-phenylnaphthalene and 1,1,1-trifluoro-7-(perfluorophenyl) heptan-2-one using a Michaelis-Arbuzov reaction.

Specifically, this is a single phosphonation of the pentafluorophenyl radicals on the copolymer shown in FIG. 46. The preparation is carried out as follows:

The polymer is suspended in an excess of tristrimethylsilyl phosphite and heated to 190° C. for several hours. The cooled polymer solution is then precipitated in heptane. The resulting polymer is dried and then refluxed in water for 24 hours and dried. The polymer is then stirred in 1 M HCl for 24 h, filtered off, washed with neutral water and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 28

FIG. 47 shows a possible subsequent reaction, specifically the double phosphonation of a copolymer of 1-phenylnaphthalene and 1,1,1-trifluoro-7-(perfluorophenyl) heptan-2-one by means of a Michaelis-Arbuzov reaction.

Specifically, this is a double phosphonation of the pentafluorophenyl residues on the copolymer shown in FIG. 47. The preparation is carried out as follows:

The polymer is suspended in an excess of tristrimethylsilyl phosphite and heated to 190° C. for several hours. The cooled polymer solution is then precipitated in heptane. The resulting polymer is dried and then refluxed in water for 24 hours and dried. The polymer is then stirred in 1 M HCl for 24 h, filtered off, washed with neutral water and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 29

FIG. 48 shows a reaction scheme for synthesizing a polymer from trifluoroacetophenone and a 2,7-diphenylfluorene modified with 9,9-dihaloalkyl side chains by means of polyhydroxyalkylation.

FIG. 48 shows the production of a polymer according to the invention. Specifically, the polymerization of a copolymer of trifluoroacetophenone and a 2,7-diphenylfluorene modified with 9,9-dihaloalkyl side chains by means of polyhydroxyalkylation is shown here.

To prepare this polymer, 1 equivalent of fluorene is placed in dry dichloromethane and mixed with 1.05 to 1.5 equivalents of trifluoroacetophenone and cooled to 0° C. Add 5 to 20 equivalents of trifluoromethanesulfonic acid to the resulting mixture and continue stirring the reaction mixture at 0° C. for 8 to 72 hours. After the reaction time has elapsed, the highly viscous solution is carefully added to methanol and the polymer is precipitated. The precipitated solid is filtered off and dried in a vacuum.

### EMBODIMENT 30

Another reaction scheme for synthesizing a polymer is shown in FIG. 49. Specifically, this involves the production of a copolymer of perfluoroacotephenone and a 2,7-diphenylfluorene modified with 9,9-dihaloalkyl side chains by means of polyhydroxyalkylation.

Specifically, FIG. 49 shows the polymerization of a copolymer of trifluoroacetophenone and a 2,7-diphenylfluorene modified with 9,9-dihaloalkyl side chains by means of polyhydroxyalkylation.

To prepare this polymer, 1 equivalent of the fluorene is placed in dry dichloromethane and mixed with 1.05 to 1.5 equivalents of perfluoroacetophenone and cooled to 0° C. Add 5 to 20 equivalents of trifluoromethanesulfonic acid to the resulting mixture and continue stirring the reaction mixture at 0° C. for 8 to 72 hours. After the reaction time has elapsed, the highly viscous solution is carefully transferred to methanol and the polymer is precipitated. The precipitated solid is filtered off and dried in a vacuum.

### EMBODIMENT 31

FIG. 50 shows the synthesis of a copolymer of trifluoroacetophenone (first starting material) and phenyl/phenylalkyl side chain-modified 2,7-diphenyl fluorene (second starting material) by means of polyhydroxyalkylation.

To prepare this polymer, 1 equivalent of fluorene is placed in dry dichloromethane and mixed with 1.05 to 1.5 equivalents of trifluoroacetophenone and cooled to 0° C. Add 5 to 20 equivalents of trifluoromethanesulfonic acid to the resulting mixture and continue stirring the reaction mixture at 0° C. for 8 to 72 hours. After the reaction time has elapsed, the highly viscous solution is carefully transferred to methanol and the polymer is precipitated. The precipitated solid is filtered off and dried in a vacuum.

### EMBODIMENT 32

FIG. 51 shows a reaction scheme of the method step of the synthesis of a copolymer of perfluoroacetophenone and phenyl/phenylalkyl side chain-modified 2,7-diphenylfluorene by means of polyhydroxyalkylation.

To prepare this polymer, 1 equivalent of the fluorene is placed in dry dichloromethane and mixed with 1.05 to 1.5 equivalents of perfluoroacetophenone and cooled to 0° C. Add 5 to 20 equivalents of trifluoromethanesulfonic acid to the resulting mixture and continue stirring the reaction mixture at 0° C. for 8 to 72 hours. After the reaction time has elapsed, the highly viscous solution is carefully transferred to methanol and the polymer is precipitated. The precipitated solid is filtered off and dried in a vacuum.

### EMBODIMENT 33

FIG. 52 shows the method step of synthesizing a polymer from trifluoroacetophenone (first starting material) and pentafluorophenyl/pentafluorophenylalkyl side chain-modified 2,7-diphenylfluorene (second starting material) by means of polyhydroxyalkylation.

To prepare this polymer, 1 equivalent of fluorene is placed in dry dichloromethane and mixed with 1.05 to 1.5 equivalents of trifluoroacetophenone and cooled to 0° C. Add 5 to 20 equivalents of trifluoromethanesulfonic acid to the resulting mixture and continue stirring the reaction mixture at 0° C. for 8 to 72 hours. After the reaction time has elapsed, the highly viscous solution is carefully transferred to methanol and the polymer is precipitated. The precipitated solid is filtered off and dried in a vacuum.

### EMBODIMENT 34

FIG. 53 shows the method step of synthesizing a polymer from perfluoroazetofenone (first starting material) and pentafluorophenyl/pentafluorophenylalkyl side chain-modified 2,7-diphenylfluorene (second starting material) by means of polyhydroxyalkylation.

To prepare this polymer, 1 equivalent of fluorene is placed in dry dichloromethane and mixed with 1.05 to 1.5 equivalents of perfluoroacetophenone and cooled to 0° C. Add 5 to 20 equivalents of trifluoromethanesulfonic acid to the resulting mixture and continue stirring the reaction mixture at 0° C. for 8 to 72 hours. After the reaction time has elapsed, the highly viscous solution is carefully added to methanol and the polymer is precipitated. The precipitated solid is filtered off and dried in a vacuum.

### EMBODIMENT 35

FIG. 54 shows a reaction scheme of the method step of synthesizing a polymer from 1,2-diphenylperfluoroalkane (first starting material) and trifluoroacetophenone (second starting material) by polyhydroxyalkylation.

To prepare this polymer, 1 equivalent of 1,2-diphenylperfluoroalkane is placed in dry dichloromethane and mixed with 1.05 to 1.5 equivalents of trifluoroacetophenone and cooled to 0° C. Add 5 to 20 equivalents of trifluoromethanesulfonic acid to the resulting mixture and continue stirring the reaction mixture at 0° C. for 8 to 72 hours.

After the reaction time has elapsed, the highly viscous solution is carefully added to methanol and the polymer is precipitated. The precipitated solid is filtered off and dried in a vacuum.

### EMBODIMENT 36

FIG. 55 shows a reaction diagram of the method step for synthesizing a polymer by means of polyhydroxyalkylation.

Specifically, the polymerization of a copolymer of trifluoroacetophenone and a 1,2-diphenylalkane by means of polyhydroxyalkylation is shown here.

To prepare this polymer, 1 equivalent of the 1,2-diphenylalkane is placed in dry dichloromethane and mixed with 1.05 to 1.5 equivalents of trifluoroacetophenone and cooled to 0° C. Add 5 to 20 equivalents of trifluoromethanesulfonic acid to the resulting mixture and continue stirring the reaction mixture at 0° C. for 8 to 72 hours. After the reaction time has elapsed, the highly viscous solution is carefully transferred to methanol and the polymer is precipitated. The precipitated solid is filtered off and dried in a vacuum.

### EMBODIMENT 37

FIG. 56 shows a reaction scheme of the method step of synthesizing a polymer by means of polyhydroxyalkylation.

Specifically, the polymerization of a copolymer of perfluoroacetophenone and a 1,2-diphenylperfluoroalkane by means of polyhydroxyalkylation is shown here.

To prepare this polymer, 1 equivalent of 1,2-diphenylperfluoroalkane is placed in dry dichloromethane and mixed with 1.05 to 1.5 equivalents of perfluoroacetophenone and cooled to 0° C. Add 5 to 20 equivalents of trifluoromethanesulfonic acid to the resulting mixture and continue stirring the reaction mixture at 0° C. for 8 to 72 hours. After the reaction time has elapsed, the highly viscous solution is carefully transferred to methanol and the polymer is precipitated. The precipitated solid is filtered off and dried in a vacuum.

### EMBODIMENT 38

FIG. 57 shows a further reaction scheme of the method step of synthesizing a polymer by means of polyhydroxyalkylation.

Specifically, the polymerization of a copolymer of perfluoroacetophenone and a 1,2-diphenylalkane by means of polyhydroxyalkylation is shown here.

To prepare this polymer, 1 equivalent of 1,2-diphenylalkane is placed in dry dichloromethane and mixed with 1.05 to 1.5 equivalents of perfluoroacetophenone and cooled to 0° C. Add 5 to 20 equivalents of trifluoromethanesulfonic acid to the resulting mixture and continue stirring the reaction mixture at 0° C. for 8 to 72 hours. After the reaction time has elapsed, the highly viscous solution is carefully transferred to methanol and the polymer is precipitated. The precipitated solid is filtered off and dried in a vacuum.

### EMBODIMENT 39

FIG. 58 shows a reaction scheme of a modification of a synthesized polymer in a subsequent reaction. Specifically, the sulfonation of the side chains of the copolymer, which was synthesized according to the reaction scheme in FIG. 48, takes place in two steps by means of nucleophilic substitution.

According to FIG. 58, the terminal halogen atoms of the aliphatic side chain, which may have halogenoalkyl chains of the same length or of different lengths, are replaced by a thioacetate group by means of a nuclophilic substitution reaction, which is converted into a sulfonic acid by oxidation in a subsequent step.

To prepare the target structure, 1 equivalent of the starting polymer is added and dissolved in dimethylacetamide. To the solution, 1.12 equivalents of potassium thioacetate per equivalent of halogen are added and stirred at an elevated temperature between 4° and 100° C. for 16 to 24 hours. The polymer is then precipitated from the cooled solution in methanol, filtered off and dried.

The resulting polymer is then redissolved in dimethylacetamide and the solution is cooled to 0° C. Subsequently, 6 equivalents of MCPBA are added in portions over 10 min. The mixture is then stirred further at room temperature. The polymer is then precipitated in 1 M saline solution, washed with water and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 40

FIG. 59 shows a reaction scheme of a modification of a synthesized polymer, in this case the synthesized polymer according to FIG. 49. Specifically, sulfonation of the side chains takes place in a manner similar to that described in connection with FIG. 58.

In the embodiment shown, the terminal halogen atoms of the aliphatic side chain, which can have both halogenoalkyl chains of the same length and halogenoalkyl chains of different lengths, are replaced by a thioacetate group by means of a nuclophilic substitution reaction, which is converted into a sulfonic acid by oxidation in a subsequent step.

To prepare the target structure, 1 equivalent of the starting polymer is added and dissolved in dimethylacetamide. To the solution, 1.12 equivalents of potassium thioacetate per equivalent of halogen are added and stirred at an elevated temperature between 4° and 100° C. for 16 to 24 hours. The polymer is then precipitated from the cooled solution in methanol, filtered off and dried.

The resulting polymer is then redissolved in dimethylacetamide and the solution is cooled to 0° C. Subsequently, 6 equivalents of MCPBA are added in portions over 10 min. The mixture is then stirred further at room temperature. The polymer is then precipitated in 1 M saline solution, washed with water and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 41

FIG. 60 shows a possible subsequent reaction for modifying a synthesized polymer. Specifically, this is the polymer that was synthesized according to the reaction scheme in FIG. 54.

In the embodiment shown, the polymer shown in FIG. 54 is further sulfonated according to the invention by means of electrophilic aromatic substitution in order to introduce ionically conductive groups into the polymer.

For this purpose, the starting material shown in FIG. 60 is suspended/dissolved in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 42

FIG. 61 shows a reaction scheme of a possible modification of a synthesized polymer (from FIG. 55) in a subsequent reaction. Specifically, this is a sulfonation by means of electrophilic aromatic substitution.

In the embodiment shown, the polymer shown in FIG. 55 is further sulfonated according to the invention by means of electrophilic aromatic substitution in order to introduce ionically conductive groups into the polymer.

For this purpose, the starting material shown in FIG. 61 is suspended/dissolved in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 43

FIG. 62 shows a reaction scheme of a subsequent reaction for modifying the synthesized polymer from FIG. 56. Specifically, sulfonation takes place by means of electrophilic aromatic substitution.

In the embodiment shown, the polymer shown in FIG. 56 is further sulfonated according to the invention by means of electrophilic aromatic substitution in order to introduce ionically conductive groups into the polymer.

For this purpose, the starting material shown in FIG. 62 is suspended/dissolved in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 44

FIG. 63 shows the reaction scheme of a possible subsequent reaction for modifying the synthesized polymer of FIG. 57.

In the embodiment shown, the polymer shown in FIG. 57 is further sulfonated according to the invention by means of electrophilic aromatic substitution in order to introduce ionically conductive groups into the polymer.

For this purpose, the starting material shown in FIG. 63 is suspended/dissolved in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 45

FIG. 64 shows possible subsequent reactions on the synthesized polymer of FIG. 56 (embodiment example 37). Specifically, this involves a single or double phosphonation by means of a Michaelis-Arbuzov reaction on the pentafluorophenyl radical. The preparation of the mono- and di-substituted material is carried out as follows:

The polymer is suspended in an excess of tristrimethylsilyl phosphite or

tris (trimethylsilyl)phosphite and heated to 190° C. for several hours. The cooled polymer solution is then precipitated in heptane. The resulting polymer is dried and then refluxed in water for 24 hours and dried. The polymer is then stirred in 1 M HCl for 24 h, filtered off, washed with neutral water and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 46

FIG. 65 shows a possible subsequent reaction for modifying a synthesized polymer, in this case the synthesized polymer from FIG. 57. This is also a single or double phosphonation of the pentafluorophenyl radicals by means of a Michaelis-Arbuzov reaction.

The polymer is suspended in an excess of tristrimethylsilyl phosphite and heated to 190° C. for several hours. The cooled polymer solution is then precipitated in heptane. The resulting polymer is dried and then refluxed in water for 24 hours and dried. The polymer is then stirred in 1 M HCl for 24 h, filtered off, washed with neutral water and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 47

FIG. 66 shows a sulfonation of the polymer synthesized according to the reaction scheme of FIG. 56 by means of nucleophilic aromatic substitution.

Specifically, this involves a nucleophilic substitution of the fluorine atom in the para position of the pentafluorophenyl residue by a thiol and the subsequent oxidation of the thiol to sulfonic acid. The corresponding material is produced as follows:

1 equivalent of the starting polymer is dissolved in degassed dimethylacetamide. In a separate flask, 1.2 equivalents of sodium hydrogen sulphide hydrate are dissolved in dimethylacetamide at elevated temperature. The previously prepared polymer solution is added to the prepared sulphide solution at elevated temperature. Once the polymer solution has been added, the mixture is stirred overnight at room temperature. The resulting solution of the crude product is dialyzed against water to remove the organic solvent.

After dialysis, a mixture of glacial acetic acid and hydrogen peroxide is added to the aqueous polymer solution to oxidize the free thiol to sulfonic acid. The resulting mixture is heated at 50° C. for 24 hours. The mixture is then heated to reflux so that the excess peroxide is destroyed. After the polymer solution has cooled, the polymer is precipitated in methanol and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 48

FIG. 67 shows a sulfonation of the polymer, which was synthesized according to the reaction scheme of FIG. 57, by means of nucleophilic aromatic substitution.

Specifically, this involves a nucleophilic substitution of the fluorine atom in the para position of the pentafluorophenyl residue by a thiol and the subsequent oxidation of the thiol to sulfonic acid. The corresponding material is produced as follows:

1 equivalent of the starting polymer is dissolved in degassed dimethylacetamide. In a separate flask, 1.2 equivalents of sodium hydrogen sulphide hydrate are dissolved in dimethylacetamide at elevated temperature. The previously prepared polymer solution is added to the prepared sulphide solution at elevated temperature. Once the polymer solution has been added, the mixture is stirred overnight at room temperature. The resulting solution of the crude product is dialyzed against water to remove the organic solvent.

After dialysis, a mixture of glacial acetic acid and hydrogen peroxide is added to the aqueous polymer solution to oxidize the free thiol to sulfonic acid. The resulting mixture is heated at 50° C. for 24 hours. The mixture is then heated to reflux so that the excess peroxide is destroyed. After the polymer solution has cooled, the polymer is precipitated in methanol and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 49

FIG. 68 shows two successive subsequent reactions for modifying the synthesized polymer from FIG. 56, involving phosphonation and subsequent sulfonation.

Specifically, this is a single phosphonation of the pentafluorophenyl residues on the copolymer shown in FIG. 68. In a subsequent step, the phenyl rings of the main chain are electrophilically sulfonated. The material is prepared as follows:

The polymer is suspended in an excess of tristrimethylsilyl phosphite and heated to 190° C. for several hours. The cooled polymer solution is then precipitated in heptane. The resulting polymer is dried and then refluxed in water for 24 hours and dried. The polymer is then stirred in 1 M HCl for 24 h, filtered off, washed with neutral water and dried.

For this purpose, the previously obtained phosphonated intermediate is suspended/dissolved in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer, which is modified with both sulfonic acid groups and phosphonic acid groups, can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 50

FIG. 69 shows two consecutive subsequent reactions for modifying the synthesized polymer of FIG. 57, with phosphonation taking place first and then sulfonation.

Specifically, this is a single phosphonation of the pentafluorophenyl residues on the copolymer shown in FIG. 69. In a subsequent step, the phenyl rings of the main chain are electrophilically sulfonated. The material is prepared as follows:

The polymer is suspended in an excess of tristrimethylsilyl phosphite and heated to 190° C. for several hours. The cooled polymer solution is then precipitated in heptane. The resulting polymer is dried and then refluxed in water for 24 hours and dried. The polymer is then stirred in 1 M HCl for 24 h, filtered off, washed with neutral water and dried.

For this purpose, the previously obtained phosphonated intermediate is suspended/dissolved in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer, which is modified with both sulfonic acid groups and phosphonic acid groups, can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 51

FIG. 70 shows a possible subsequent reaction of a synthesized polymer for modification. First a double phosphonation and then a sulfonation of the polymer, which was synthesized according to the reaction scheme of FIG. 56, takes place.

Specifically, this is a single phosphonation of the pentafluorophenyl residues on the copolymer shown in FIG. 70. In a subsequent step, the phenyl rings of the main chain are electrophilically sulfonated. The material is prepared as follows:

The polymer is suspended in an excess of tristrimethylsilyl phosphite and heated to 190° C. for several hours. The cooled polymer solution is then precipitated in heptane. The resulting polymer is dried and then refluxed in water for 24 hours and dried. The polymer is then stirred in 1 M HCl for 24 h, filtered off, washed with neutral water and dried.

For this purpose, the previously obtained phosphonated intermediate is suspended/dissolved in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer, which is modified with both sulfonic acid groups and phosphonic acid groups, can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 52

FIG. 71 shows a reaction scheme for modifying the synthesized polymer in subsequent reactions. The previously synthesized polymer is the polymer of FIG. 57. The subsequent reaction initially comprises a double phosphonation and a subsequent sulfonation.

Specifically, this is a single phosphonation of the pentafluorophenyl residues on the copolymer shown in FIG. 71. In a subsequent step, the phenyl rings of the main chain are electrophilically sulfonated. The material is prepared as follows:

The polymer is suspended in an excess of tristrimethylsilyl phosphite and heated to 190° C. for several hours. The cooled polymer solution is then precipitated in heptane. The resulting polymer is dried and then refluxed in water for 24 hours and dried. The polymer is then stirred in 1 M HCl for 24 h, filtered off, washed with neutral water and dried.

For this purpose, the previously obtained phosphonated intermediate is suspended/dissolved in conc. sulphuric acid or chlorosulphonic acid or fuming sulphuric acid for several hours. The resulting suspension/solution is placed on ice so that the polymer precipitates. The resulting solid is filtered off and washed with water until the wash water has a neutral pH value.

The resulting ionically conductive polymer, which is modified with both sulfonic acid groups and phosphonic acid groups, can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 53

FIG. 72 shows a reaction scheme for modifying the synthesized polymer in a subsequent reaction. The polymer is a copolymer of 1-phenylnaphthalene and 1,1,1-trifluoro-7-(perfluorophenyl) heptan-2-one. Sulfonation takes place by means of nucleophilic aromatic substitution.

Specifically, this involves a nucleophilic substitution of the fluorine atom in the para position of the alkylpentafluorophenyl radical by a thiol and the subsequent oxidation of the thiol to sulfonic acid. The corresponding material is produced as follows:

1 equivalent of the starting polymer is dissolved in degassed dimethylacetamide. In a separate flask, 1.2 equivalents of sodium hydrogen sulphide hydrate are dissolved in dimethylacetamide at elevated temperature. The previously prepared polymer solution is added to the prepared sulphide solution at elevated temperature. Once the polymer solution has been added, the mixture is stirred overnight at room temperature. The resulting solution of the crude product is dialyzed against water to remove the organic solvent.

After dialysis, a mixture of glacial acetic acid and hydrogen peroxide is added to the aqueous polymer solution to oxidize the free thiol to sulfonic acid. The resulting mixture is heated at 50° C. for 24 hours. The mixture is then heated to reflux so that the excess peroxide is destroyed. After the polymer solution has cooled, the polymer is precipitated in methanol and dried.

The resulting ionically conductive polymer can be used to produce both a pure membrane and a blend membrane. To produce a pure membrane, the sulfonated polymer obtained is dissolved in DMSO, or DMAc or NMP. The resulting polymer solution is applied to a glass plate in a defined layer thickness using a doctor blade and the solvent is removed at an elevated temperature. To produce an acid-base blend membrane, the acidic polymer obtained is dissolved in DMSO, DMAc or NMP and neutralized using a base, e.g. triethylamine or triethanolamine, and then mixed with a dissolved polybase such as OPBI and, analogous to the pure membrane, squeegeed and evaporated.

### EMBODIMENT 54

FIGS. 73 and 74 show the reaction steps of the modification of a synthesized polymer, in this case a basic polymer, to an alkali-stable dication. In a first step (FIG. 73), a polymer, in the present case poly(2-([1,1′,4,1″-terphenyl]-4-yl)ethyl) 1H-benzo[d]imidazole)), is functionalized with 1,6-dibromohexane before, in a preferred embodiment, the bromine site is functionalized with a compound in a further reaction step, which contains in particular a tertiary amino group and a quaternary ammonium ion, such as 1,1-dimethyl-4-(3-(1-methylpiperidin-4-yl) propyl) piperidin-1-ium in the present case in FIG. 74, to form a dication.

Surprisingly, it is possible to functionalize the basic polymer shown above with 1,6-dibromohexane without crosslinking taking place. The conversions are greater than 90%. For this purpose, the starting polymer is dissolved in DMAc, whereby less concentrated solutions must be used (approx. 2-3 wt %) to avoid crosslinking. An excess of K₂ CO₃ (9 equiv.) is then added and stirred at 80° C. for 2 h to deprotonate the benzimidazole unit. After adding a 32-fold excess of 1,6-dibromohexane, the reaction is stirred at 80° C. for 48 hours. After precipitation in methanol, the precursor polymer for further functionalization reactions is obtained.

In the next step, the bromine site is converted to a dication with a monocation such as the 1,1-dimethyl-4-(3-(1-methylpiperidin-4-yl) propyl) piperidin-1-ium shown in FIG. 74, which leads to anion exchange polymers with high ion exchange capacities (2.70 mmol/g). Surprisingly, these polymers are not soluble in water, which is why they can be used to produce membranes with high conductivities.

1-22. (canceled)

23. Method for producing a material for a membrane, comprising the following steps:
providing at least one starting material, wherein at least one starting material comprises or consists of at least one monomer;
synthesizing a polymer material(s) by means of polyhydroxyalkylation (PHA);
modification of the synthesized polymer in a subsequent reaction and/or modification of at least one starting material in a preliminary reaction before the polymer is synthesized.

24. The method according to claim 23, wherein at least one starting material contains at least one type of diaryl monomer.

25. The method according to claim 23, wherein at least one starting material contains at least one ketone group and/or carbonyl group, in particular several different ketone groups and/or several different carbonyl groups.

26. The method according to claim 23, wherein at least one starting material comprises or consists of one or more of the following ketones and/or aldehydes:
4-methylpiperazin-2-one, 1-(1-methylpiperidin-4-yl)ethan-1-one,
1,4-dimethylpiperazin-2-one, piperazin-2-one,
1,3-dimethyltetrahydropyrimidin-2 (1H)-one,
1-(1-methyl-1H-benzo[d]imidazole-2-yl)ethan-1-one,
2,2,2-trifluoro-1-(1-methyl-1H-benzo[d]imidazole-2-yl)ethan-1-one,
1-(5,6-dimethyl-1H-benzo[d]imidazole-2-yl)ethan-1-one,
1-(5-methylpyridin-3-yl)ethan-1-one, 1-(5-methylpyridin-2-yl)ethan-1-one, 2,2,2-trifluoro-1-(4-mercaptophenyl)ethan-1-one, acetylferrocene,
(2,2,2-trifluoroacetyl) ferrocene, 1-(4-(5-bromopentyl)phenyl)ethan-1-one,
1-(4-ethylpiperazin-2-yl)ethan-1-one,
1-(1-methyl-1H-pyrazol-4-yl)ethan-1-one, pyrrolidine-3-carbaldehyde,
1-(1H-pyrazol-3-yl)ethan-1-one, 1-(1H-benzo[d]imidazole-6-yl)ethan-1-one,
1-(7-methyl-1H-benzo[d]imidazole-2-yl)ethan-1-one,
1-(1H-benzo[d]imidazole-2-yl)ethan-1-one,
1-(4-methylpyridin-3-yl)ethan-1-one, 1-(4-mercaptophenyl)ethan-1-one,
(4-acetylphenyl)phosphonic acid, 1-(3-methylpyridin-2-yl)ethan-1-one,
1-(1-methyl-1H-pyrazol-3-yl)ethan-1-one,
1-(1,2,4-dimethyl-1H-imidazol-5-yl)ethan-1-one,
1-(1,2,4-trimethyl-1H-imidazol-5-yl)ethan-1-one,
1-(1H-benzo[d]imidazol-7-yl)ethan-1-one,
1-(1H-benzo[d]imidazol-2-yl)propn-1-one,
1-(1H-benzo[d]imidazol-2-yl)propan-2-one,
1-(1,4,5-trimethyl-1H-imidazol-2-yl)ethan-1-one,
2,2,2-trifluoro-1-(1-methyl-1H-imidazol-2-yl)ethan-one,
1-(1-methyl-1H-imidazol-2-yl)ethan-1-one, 1-(1H-imidazol-5-yl)ethan-1-one,
1-(1H-imidazo-2-yl)ethan-1-one,
1-(2-methylpyridin-4-yl)ethan-1-one, 4-acetylbenzenesufonic acid, 1-(4-methylpyridin-2-yl)ethan-1-one,
1-(pyridine-4-yl)ethan-1-one, 1-(pyridine-3-yl)ethan-1-one,
1-(pyridine-2-yl)ethan-1-one, 2,2,2-trifluoro-1-(pyridine-2-yl)ethan-1-one,
2,2,2-trifluoro-1-(pyridine-4-yl)ethan-1-one,
2,2,2-trifluoro-1-(pyridine-3-yl)ethan-1-one,
2,2,2-trifluoro-1-(piperidin-4-yl)ethan-1-one, 1-(quinolin-8-yl)ethan-1-one,
1-(quinolin-5-yl)ethan-1-one, 2,2,2-trifluoror-1-(1H-imidazol-2-yl)ethan-1-one,
1-(quinolin-4-yl)ethan-1-one, 1-(3-methylpyridin-4-yl)ethan-1-one,
1-(2,3,5,6-tetrafluoro-4-mercaptophenal)ethan-1-one,
1-(cyclopenta-2,4-dien-1-yl)ethan-1-one, 1-(4-hexylphenyl)ethan-1-one,
1-(cyclopenta-2,4-dien-1-yl)-2,2,2, -trifluoroethan-1-one,
1-(4-(5-chloropentyl)phenyl)ethan-1-one, 1-(4-bromophenyl)ethan-1-one,
1-(4-chlorophenyl)ethan-1-one, 1-(4-fluorophenyl)ethan-1-one,
1-(4-iodophenal)ethan-1-one, 1-(6-methylpyridin-2-yl)ethan-1-one,
1-(6-methylpyridin-3-yl)ethan-1-one, 3-acetylbenzenesulfonic acid,
4-acetyl-2,3,5,6-tetrafluorobenzenesulfonic acid,
1-(2-methylpyridin-3-yl)ethan-1-one, 1-(quinolin-7-yl)ethan-1-one,
1-(quinolin-6-yl)ethan-1-one, di (pyridine-2-yl) methanone,
1-(2-(dimethylamino)phenyl)ethan-1-one,
2,2,2-trifluoro-1-(quinolin-3-yl)ethan-1-one,
1-(3-(dimethylamino)phenyl)ethan-1-one,
1-(4-(dimethylamino)phenyl)ethan1-one, 1-(quinolin-2-yl)ethan-1-one,
1-(4-(dimethylamino)phenyl)-2,2,2-trifluoroethan-1-one,
1-(3-(dimethylamino)phenyl)-2,2,2-trifluoroethan-1-one,
1-(3-chlorophenyl) 2,2,2-trifluoroethan-1-one,
1-(3-bromophenyl)-2,2,2-trifluoroethan-1-one,
2,2,2-trifluoro-1-(3-iodophenyl)ethan-1-one,
2,2,2-trifluoro-1-(3-fluorophenyl)ethan-1-one,
1-(2-bromophenyl)-2,2,2-trifluoroethan-1-one,
1-(2-chlorophenyl)-2,2,2-trifluoroethan-1-one,
1-(2-iodophenyl)-2,2,2-trifluoroethan-1-one,
1-(2-fluorophenyl)-2,2,2-trifluoroethan-1-one,
1-(2-bromophenyl)-2,2,2-trifluoroethan-1-one, 1-(2-chlorophenyl)ethan-1-one,
1-(2-iodoophenyl)ethan-1-one, 1-(2-bromophenyl)ethan-1-one,
1-(2-fluorophenyl)ethan-1-one, 1-(3-chlorophenyl)ethan-1-one,
1-(3-bromophenyl)ethan-1-one, 1-(3-iodoophenyl)ethan-1-one,
1-(3-fluorophenyl)ethan-1-one, 2,2,2-trifluoro-1-(4-fluorophenyl)ethan-1-one,
2,2,2-trifluoro-1-(4-iodophenyl)ethan-1-one,
1-(4-chlorophenyl)-2,2,2-trifluoroethan-1-one, 1-(4-bromophenyl)-2,2,2-trifluoroethan-1-one,
2,2,2-trifluoro-1-(perfluorophenyl)ethan-1-one,
8-bromo-1,1,1-trifluorooctan-2-one, 1-(isoquinolin-4-yl)ethan-1-one,
1-(quinolin-3-yl)ethan-1-one, 1-(1,8-naphthyridin-4-yl)-ethan-1-one,
1-(perfluorophenyl)ethan-1-one, 1-(isoquinolin-1-yl)ethan-1-one,
2,2,2-trifluoro-1-(4-nitrophenyl)ethan-1-one,
2,2,2-trifluoro-1-(3-nitrophenyl)ethan-1-one, ferrocenecarboxaldehydes, formylcobaltocenes, formlynickelocenes

27. The method according to claim 23, wherein at least one starting material comprises or consists of one or more of the following aryls:
1,2′-binaphthalene, 1,1′-binaphthalene 2,2′-binaphthalene, 1,1′-biphenyl, 1,1′0.4,1″-terphenyl, 10-methyl-9,10-dihydroacridine, 9,10-diphenylanthracenes, 1,4-diphenylnaphthalenes, 1,1′: 4′,1″0.4″,1″-quaterphenyl,
1,1′: 3′,1″0.3″, 1″-quaterphenyl, 1,1′: 3′, 1″-terphenyl,
9,9,10-trimenthyl-9,10-dihydroacridine, 2,4,6-triphenyl-1,3,5-triazine,
2,3-diphenylnaphthalene,
2′,2″,3′,3″,5′,5″,6′, 6″-octofluoro-1,1′: 4′, 1″0.4″, 1′-quaterphenyl,
2′,3′,5′, 6′-tetrafluoro-1,1′,4′, 1″-terphenyl, 2′,4′, 5′, 6′-tetrafluroro-1, 1′: 3′, 1″-terphenyl,
2′,2″,4′,4″,5″,5″,6′,6″-octafluoro-1,1′: 3′, 1″0.3″, 1′″-quaterphenyl,
9,10-dihydroacridine, 2,4,6-triphenylpyridine,
5′-iodo-1,1′: 3′, 1″-terphenyl, 5′-bromo-1,1′: 3′1″-terphenyl, 5′-chloro-1,1′: 3′, 1″-terphenyl,
2′-bromo-1,1′: 3′1″-terphenyl,
2′-iodo-1,1′: 3′, 1″-terphenyl,4′-bromo-1,1′: 2′, 1″-terphenyl,
9,9-dimenthyl-9,10-dihydroacridines, 2,3,6, 7-tetraphenylnaphtalenes,
2,6-diphenlypyridines, 2,6-diphenylpyrazines, 4,6-diphenylpyrimidines,
3,5-diphenylpyridines, 2,5-diphenlypyridines, 2,5-diphenylpyrimidines,
1,3-diphenylcyclohexanes, 5-methyl-5,10-dihydrophenazines,
5,10-dihydrophenazines, 5′-phenyl-1,1′: 3′,1″-terphenyl,
N-N-dimethyl-[1,1′: 3′,1″-terphenyl]-5′-amines,
N-N-dimethyl-[1,1′: 3′,1″-terphenyl]-2′-amines, 6,6′-diphenyl-2,2′-bipyridines,
2,4-diphenyl-1,3,5-triazines, 1,4-diphenylcyclohexanes,
1,2-diphenylcyclohexanes, 5,10-dimethyl-5, 10-dihydrophenazines,
5′-methyl-1,1′: 3′, 1″-terphenyl, 2′-methyl-1,1′: 3′, 1″-terphenyl,
4-methyl-2,6-diphenylpyridines, 2′,3′-dimethyl-1,1′: 4′, 1″-terphenyl,
2′,3′,5′,6′-tetramethyl-1,1′: 4′,1″-terphenyl, 2,3,5,6-tetraphenylpyrazines.

28. The method according to claim 23, wherein at least one starting material comprises or consists of a monomer with an organic radical, the organic radical comprising or being in particular 1,4-arylene or 1,3-arylene or 1,2-arylene or alkyl or 1,4-perfluoroarylene or 1,3-perfluoroarylene or 1,2-perfluoroarylene or perfluoroalkyl or bromoarylene or chloroarylene or iodoarylene or pyridyl or pyracinyl or pyrimidyl or triacinyl or 9H-fluorenyl or 9-dialkyl-9H-fluorenyl or 9,9-bis(haloalkyl)-9H-fluorenyl or 1,4-cyclohexyl or 1,3-cyclohexyl or 1,2-cyclohexyl or 1-methylpiperidyl or 1,4-dimethylpiperazinyl or 1,3-dimethylhexahydropyrimidinyl.

29. The method according to claim 23, wherein the polyhydroxyalkylation takes place under the influence of trifluoromethanesulfonic acid (TFSA).

30. The method according to claim 23, wherein the polyhydroxyalkylation (PHA) takes place under the influence of a solvent, in particular a chlorinated solvent.

31. The method according to claim 23, wherein the modification of the synthesized polymer in a subsequent reaction and/or the modification of the starting material in a preliminary reaction comprises a nucleophilic aromatic substitution reaction and/or an electrophilic aromatic substitution reaction and/or a polymer-analogous reaction and/or an alkylation of basic nitrogen atoms to form tertiary or quaternary N-basic compounds and/or proceeds in a microwave-supported manner.

32. The method according claim 23, wherein it comprises blending the synthesized polymer with a further polymer to form a blended polymer mixture, wherein, preferably crosslinking, in particular ionic and/or covalent crosslinking, occurs between the polymers during blending.

33. The method according to claim 32, wherein doping of the blended polymer mixture takes place, wherein, preferably the doping of the blended polymer mixture with mineral acids, in particular with sulphuric acid or phosphoric acid or a phosphonic acid, takes place and/or comprises the introduction of further ion exchanger groups, in particular acidic sulphonic acid and/or acidic phosphonic acid groups.

34. The method according to claim 32, wherein anion exchange groups are generated on the blended polymer mixture.

35. The method according to claim 34, wherein the generation of anion exchange groups is carried out by the alkylation (quaternization) of any tertiary N-basic groups contained in the blended polymer mixture and/or by the reaction of halomethyl groups of the form CH₂ Hal with Hal=Cl, Br, I contained in the blended polymer mixture with tertiary N-basic groups.

36. Substance prepared by a method according to claim 23.

37. The membrane comprising or consisting of a material according to claim 36, wherein, in particular the thickness is less than 100 μm, in particular less than 75 μm, preferably less than 50 μm.

38. Use of a membrane according to claim 37 in a fuel cell, in particular in a low-temperature fuel cell and/or in a direct alcohol fuel cell, or in a battery, in particular in a redox flow battery, or in an electrochemical process, in particular in an electrolysis process or in an electrosynthesis process, preferably in a water electrolysis process, and/or as a proton exchange membrane.
